(19) United States
(12) Patent Application Publication
(10) Pub. No.: US 2026/0140968 A1
(43) Pub. Date: May 21, 2026

(54) Correlation Analysis System, Integrated System, Correlation Analysis Method, and Correlation Analysis Program

(71) Applicant: Hitachi, Ltd., Tokyo (JP)

(72) Inventors: Kunihiko TOUMURA, Tokyo (JP); Shoji YUNOKI, Tokyo (JP)

(21) Appl. No.: 19/209,982

(22) Filed: May 16, 2025

(30) Foreign Application Priority Data
Nov. 21, 2024 (JP) 2024-203298

(51) Int. Cl. G06F 16/28

(52) U.S. Cl. CPC G06F 16/288

(57) ABSTRACT

Automation of generation of information representing mutual relations between matters and the like which are present at a site is realized with relatively simple processing. A correlation event sensing section senses a correlation event on the basis of each piece of device data. A correlation event processing section updates correlation information for managing a correlation strength which is the strength of a correlation between devices on the basis of the correlation event, and determines the appearance or disappearance of a derivation from the correlation to a device-group relation or an inter-group relation on the basis of the correlation strength. A derivation appearance/disappearance event processing section updates device-group relation information for managing whether or not there is the device-group relation on the basis of the appearance or disappearance of a derivation, and updates inter-group relation information for managing whether or not there is the inter-group relation.

### BACKGROUND OF THE INVENTION

### 1. Field of the Invention

The present disclosure relates to a technology to grasp the situation and the like of a site where there are a plurality of devices which are sensors or the like by use of the plurality of devices.

### 2. Description of the Related Art

Conventionally, “digitization of sites” has been under consideration. For example, consideration has been given to installing a plurality of devices which are sensors or the like at various sites which are sites where products are produced, sites where products are inspected, and the like, and then grasping the situations and the like of the sites, on the basis of information obtained from the devices. In addition, consideration has been given also to giving instructions for controlling sites, taking into account the situations and the like of the sites, to devices and pieces of equipment at the sites.

For example, there is JP-2020-202554-A as a prior art document related to grasping the situation and the like of a site.

JP-2020-202554-A discloses a technology to detect changes in a manufacturing site system including a plurality of manufacturing machines and a plurality of programmable logic controllers (PLCs). According to JP-2020-202554-A, a behavior monitor acquires behavior data from the manufacturing site system. The behavior monitor stores processing results on a repository. A rearrangement detecting section detects the rearrangement or the like of manufacturing machines in the manufacturing site system by comparing data acquired from the repository and data acquired from an arrangement pattern repository. Upon the detection of rearrangement or the like, the rearrangement detecting section transmits a rearrangement notification to an asset manager. Upon the reception of the rearrangement notification, the asset manager updates information retained in the asset repository. The information retained in the asset repository represents a hierarchical relation among a plurality of manufacturing machines and a plurality of PLCs in the manufacturing site system.

### SUMMARY OF THE INVENTION

Examples of matters that form the situation of a site include pieces of equipment being present at the site, processes performed at the site, workers engaged in work at the site, and devices (e.g., sensors) that collect information regarding equipment/processes/workers.

There can be a case where the number of pieces of equipment/processes/workers/devices at a site is large, a case where pieces of equipment/processes/workers/devices are added or deleted, and a case where mutual relations between pieces of equipment/processes/workers/devices change. For example, if the scale of a site is large, the number of processes to be handled at the site is large, the contents of processes are complicated, and so on, the number of pieces of equipment/processes/workers/devices at the site increases. If a site is changed to flexibly cope with a change in the external environment of the site or a change in the internal environment of the site, pieces of equipment/processes/workers/devices are added to or deleted from the site, mutual relations between pieces of equipment/processes/workers/devices change, and so on.

In cases like those described above, it can require a lot of effort to manually grasp mutual relations between pieces of equipment/processes/workers/devices at a site or to prepare information representing the grasped relations in order to realize “digitization of the site.”

For example, if it is assumed that a site is changed to flexibly cope with a change in the external environment of the site or a change in the internal environment of the site, there is a fear that inconveniences like the ones below appear if a lot of effort remains necessary for preparation of information representing mutual relations between pieces of equipment/processes/workers/devices at the site.

First, if the realization of a change in a site is prioritized, and the preparation of information representing mutual relations between pieces of equipment/processes/workers/devices at the site is delayed, a period during which “digitization of the site” cannot be coped with appears at the site after the change.

Second, if a change in a site is realized after the preparation of information representing mutual relations between pieces of equipment/processes/workers/devices at the site after the change is completed, the change in the site coping with a change in the external environment of the site or a change in the internal environment of the site is not realized promptly.

As have been mentioned already, in the prior art disclosed in JP-2020-202554-A, a change in the manufacturing site system is detected, and the information retained in the asset repository and representing the hierarchical structure of a plurality of manufacturing machines and a plurality of PLCs which are present in the manufacturing site system is kept in the latest state.

However, it is inferred that, in the prior art disclosed in JP-2020-202554-A, in order to prepare the behavior data, information regarding relations between a plurality of manufacturing machines and a plurality of PLCs is organized in the manufacturing site system. That is, it is inferred that processes on the side of the manufacturing site system are complicated.

In addition, in the prior art disclosed in JP-2020-202554-A, it is not clear as to how addition or deletion of manufacturing machines and the like in the manufacturing site system is coped with.

Further, the prior art disclosed in JP-2020-202554-A is substantially for managing mutual relations between manufacturing machines and PLCs in the manufacturing site system, and it is difficult to say that it is assumed, in the prior art disclosed in JP-2020-202554-A, that various types of device, workers, and the like are managed.

Moreover, in the prior art disclosed in JP-2020-202554-A, the data acquired from the repository and the data acquired from the arrangement pattern repository are compared, and then, in a case where results of the comparison represent that the data does not match, the information retained in the asset repository is updated. Accordingly, the processing load for keeping the information retained in the asset repository at the latest state is significant.

On the basis of what has been described above, one of objects of the present disclosure may be to realize, with relatively simple processing, automation of generation of information representing mutual relations between matters and the like which are present at a site where there are a plurality of devices, and to realize generation of the information flexibly coping with changes of the site, when the information is prepared in order to grasp the situation and the like of the site, by use of the plurality of devices.

In order to achieve at least one of the objects described above, features that the present disclosure can include are as follows, for example.

One of the features of the present disclosure is a correlation analysis system. A correlation analysis system includes a correlation event sensing section, a correlation event processing section, and a derivation appearance/disappearance event processing section. The correlation event sensing section is configured to sense a high correlation event which is an event that leads to a presumption that a correlation between devices exists or a low correlation event which is an event that leads to a presumption that the correlation between the devices does not exist, on the basis of each piece of device data obtained from each of the devices. The correlation event processing section is configured to update correlation information for managing a correlation strength which is a strength of the correlation between the devices on the basis of the sensed high correlation event or low correlation event. The correlation event processing section is configured to determine appearance or disappearance of a derivation from the correlation between the devices to a relation on the basis of the correlation strength between the devices. Here, the relation is a device-group relation between each of groups and each of the devices or an inter-group relation between the groups. The derivation appearance/disappearance event processing section is configured to update device-group relation information for managing whether or not there is the device-group relation, on the basis of the determined appearance or disappearance of a derivation. The derivation appearance/disappearance event processing section is configured to update inter-group relation information for managing whether or not there is the inter-group relation, on the basis of the determined appearance or disappearance of a derivation.

As described above, according to the present disclosure, correlation strengths which are the strengths of correlations between devices are managed on the basis of each piece of device data obtained from each of the devices. Then, according to the present disclosure, the appearance or disappearance of a derivation of a device-group relation which is a relation between each of groups and each of the devices or an inter-group relation between groups is determined on the basis of the correlation strengths between the devices.

That is, according to the present disclosure, information representing correlations, device-group relations, and inter-group relations included in mutual relations between matters and the like which are present at a site can be generated by relatively simple processing on the basis of device data.

In addition, even if a device is installed at or a device is removed from a site, according to the present disclosure, information representing correlations, device-group relations, and inter-group relations can be updated at any time on the basis of device data output from the installation-target or removal-target device.

Further, in a case where there is a change in mutual relations between matters and the like which are present at the site, according to the present disclosure, the mutual relations between matters and the like which are present at the site after the change can be tracked on the basis of an update of the information representing correlations, device-group relations, and inter-group relations based on device data at the site after the change.

On the basis of what has been described above, according to the present disclosure, automation of the generation of information representing mutual relations between matters and the like which are present at a site where there are a plurality of devices can be realized with relatively simple processing, and the generation of the information can be realized flexibly coping with changes of the site, when the information is prepared in order to grasp the situation and the like of the site, by use of the plurality of devices.

A correlation analysis method and a correlation analysis program that realize techniques similar to processes realized by the correlation analysis system described above also can attain effects and advantages similar to those of the correlation analysis system described above. In addition, an integrated system including the correlation analysis system also can attain effects and advantages similar to those of the correlation analysis system described above. If a mode of a program is adopted, expenses are reduced in many cases. In the case of the program, design changes of processes also are easy to make.

Features that the present disclosure can have other than those described above, and effects and advantages corresponding to the features are disclosed in this specification, claims, or figures.

### BRIEF DESCRIPTION OF THE DRAWINGS

FIG. 1 depicts a basic functional configuration according to an embodiment of the present disclosure;

FIG. 2 depicts an example of correlations and relations;

FIG. 3 depicts an overall configuration;

FIG. 4 depicts a functional configuration involved at a time of device installation;

FIG. 5 depicts a functional configuration involved in detection or management of correlations/relations;

FIG. 6 depicts a functional configuration involved in construction/revision of an application;

FIG. 7 depicts a functional configuration related to application execution;

FIG. 8 depicts a device management information table;

FIG. 9 depicts a group management information table;

FIG. 10 depicts a motion detection information table;

FIG. 11 depicts a motion time information table;

FIG. 12 depicts a correlation information table;

FIG. 13 depicts a correlation information table;

FIG. 14 depicts a device-group relation information table;

FIG. 15 depicts an inter-group relation information table;

FIG. 16 depicts a derivation prohibition information table;

FIG. 17 depicts a device-group relation prohibition information table;

FIG. 18 depicts an inter-group relation prohibition information table;

FIG. 19 depicts a process performed by a correlation event sensing section;

FIG. 20 depicts a process performed by a high correlation event processing section;

FIG. 21 depicts a process performed by a derivation appearance event processing section;

FIG. 22 depicts a process performed by a device-group relation information derivation appearance instance updating section;

FIG. 23 depicts a process performed by an inter-group relation information derivation appearance instance updating section;

FIG. 24 depicts a process performed by a low correlation event processing section;

FIG. 25 depicts a process performed by a derivation disappearance event processing section;

FIG. 26 depicts a process performed by a device-group relation information derivation disappearance instance updating section;

FIG. 27 depicts a process performed by an inter-group relation information derivation disappearance instance updating section;

FIG. 28 depicts a fixed settings screen;

FIG. 29 depicts a parameter settings screen;

FIG. 30 depicts a low-code development environment screen;

FIG. 31 depicts a device search screen;

FIG. 32 depicts a process performed by a simple device-group relation information derivation appearance instance updating section;

FIG. 33 depicts a process performed by a simple inter-group relation information derivation appearance instance updating section;

FIG. 34 depicts a process performed by a simple derivation disappearance event processing section;

FIG. 35 depicts a modification example of a functional configuration involved in construction/revision of an application; and

FIG. 36 depicts a computer architecture.

### DESCRIPTION OF THE PREFERRED EMBODIMENT

Hereinbelow, an embodiment of the present disclosure is explained in detail with reference to the figures. Note that the embodiment explained below does not limit the disclosure according to claims, and all of elements and combinations thereof explained in the embodiment are not necessarily essential for means for solving the problems of the present disclosure. The present disclosure can be implemented in various other modes also.

Each of systems (e.g., a correlation analysis system and an integrated system), apparatuses, or functional sections of the present disclosure may be integrated into one, in terms of hardware, or may be one that includes a plurality of separate portions, and plays a role by causing the portions to work together. Several systems, apparatuses, or functional sections may be integrated into one in terms of hardware.

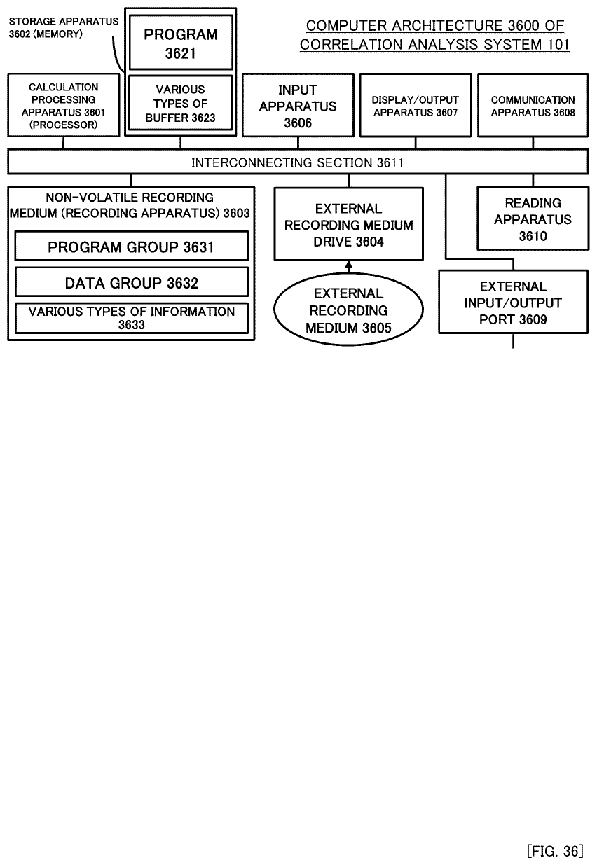

Each of systems, apparatuses, or functional sections may be realized by causing a computer to execute software (a program (e.g., a correlation analysis program)) (as in FIG. 36). Some of functions of systems, apparatuses, or functional sections may be realized by hardware (e.g., hardwired logic or a field programmable gate array (FPGA)), and the remaining functions may be realized by execution of software (a program). All of functions of each of systems, apparatuses, or functional sections may be realized in terms of hardware. Some or all of steps depicted in flowcharts and the like explained in the present disclosure may be realized in terms of hardware.

One or more of systems, apparatuses, or functional sections of the present disclosure may be realized by one or more hardware resources. In order to do so, each of systems, apparatuses, or functional sections of the present disclosure may be realized virtually. For example, a technique of a virtual computer or a virtual container may be used.

The program is not limited to a particular type or mode of program. In addition, the program may initially be recorded in a compressed format.

In a case where systems, apparatuses, functional sections, or some of functions of functional sections are realized by causing a computer to execute software (a program), the systems, the apparatuses, the functional sections, or some of the functions of the functional sections to be realized need not be kept being realized constantly. That is, it is sufficient if the systems, the apparatuses, the functional sections, or some of the functions of the functional sections are being realized at timings when processes provided by the systems, the apparatuses, the functional sections, or some of the functions of the functional sections are necessary.

Ones for which the same reference numerals are used throughout a plurality of figures are similar to each other. In figures depicting flowcharts, rectangular boxes represent steps of processes, and hexagonal boxes represent steps of conditional branches. In figures depicting flowcharts, “Steps” are abbreviated to “S.” Displays or outputs depicted in figures are merely examples. Modes of displays or outputs may be any modes within such a scope that objects of the present disclosure can be achieved.

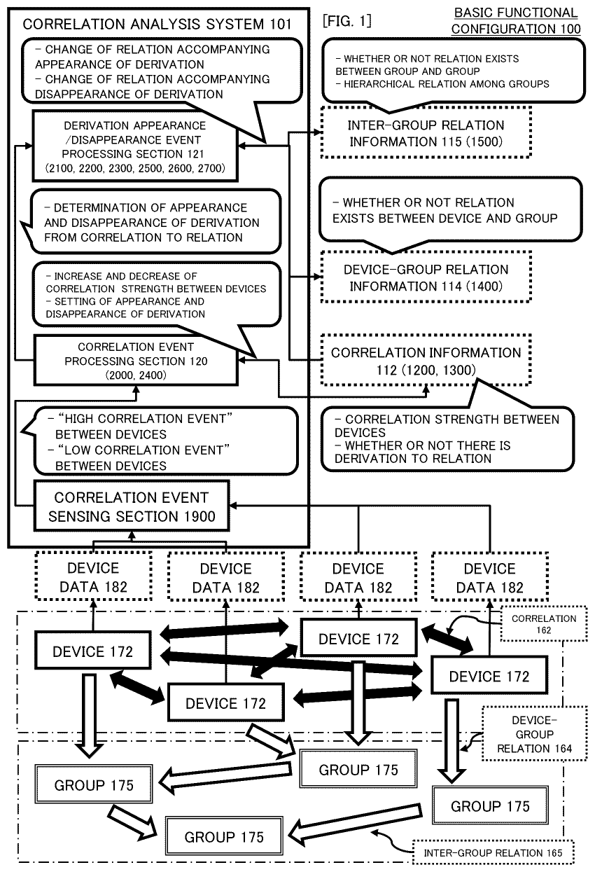

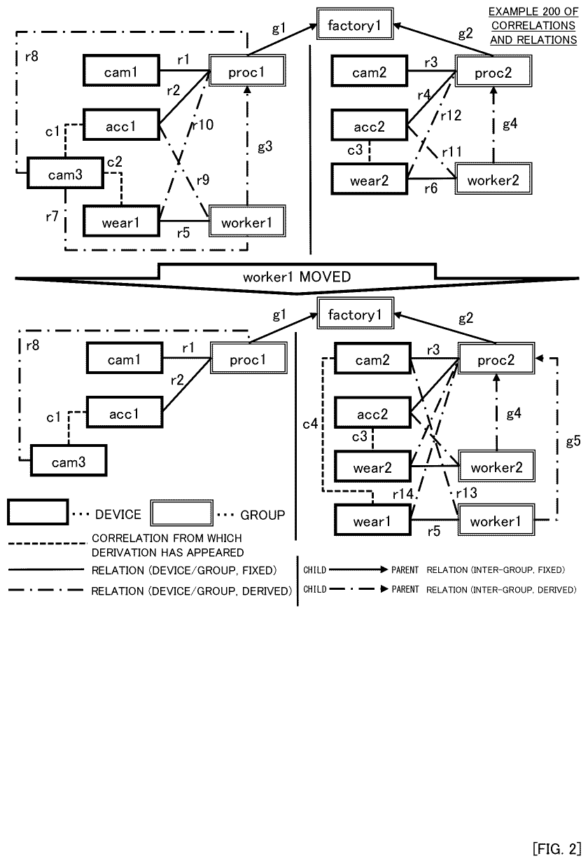

### 1. Basic Functional Configuration (FIG. 1 and FIG. 2)

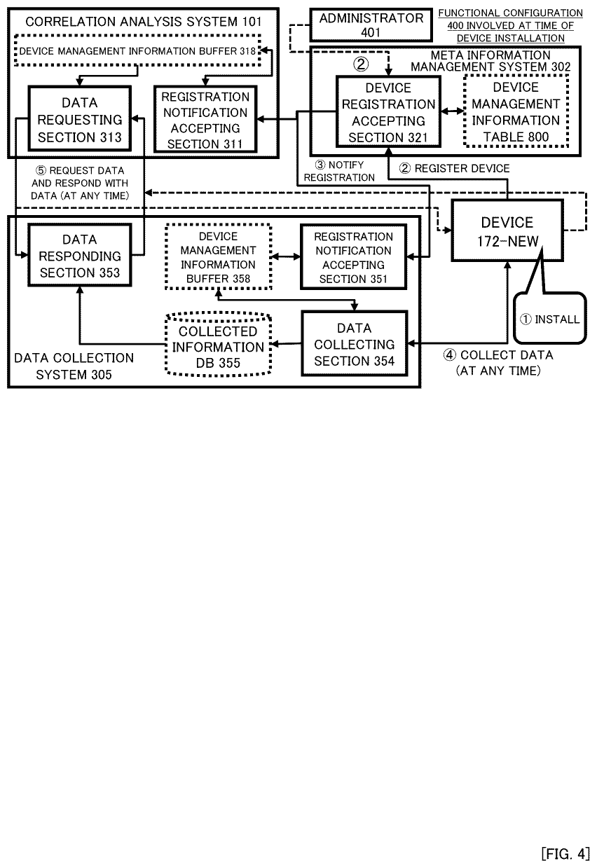

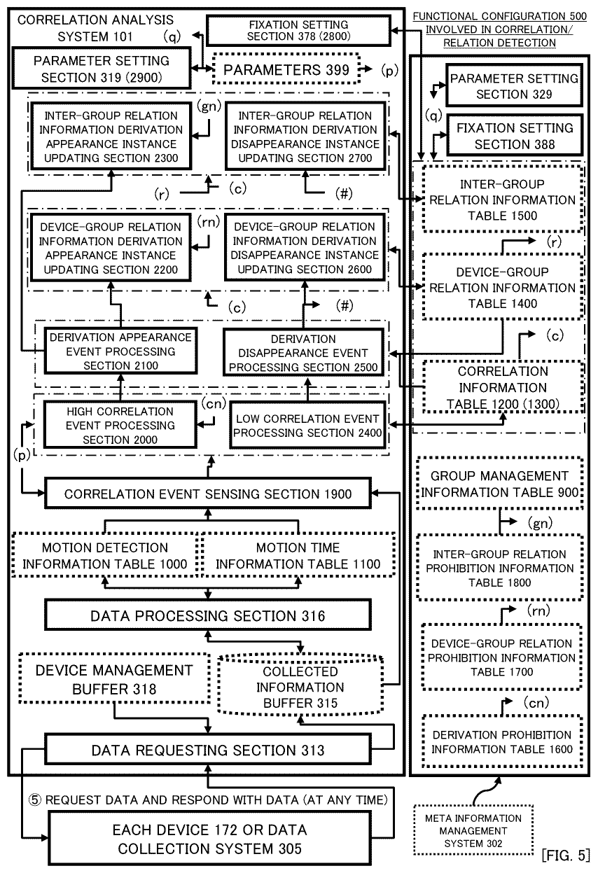

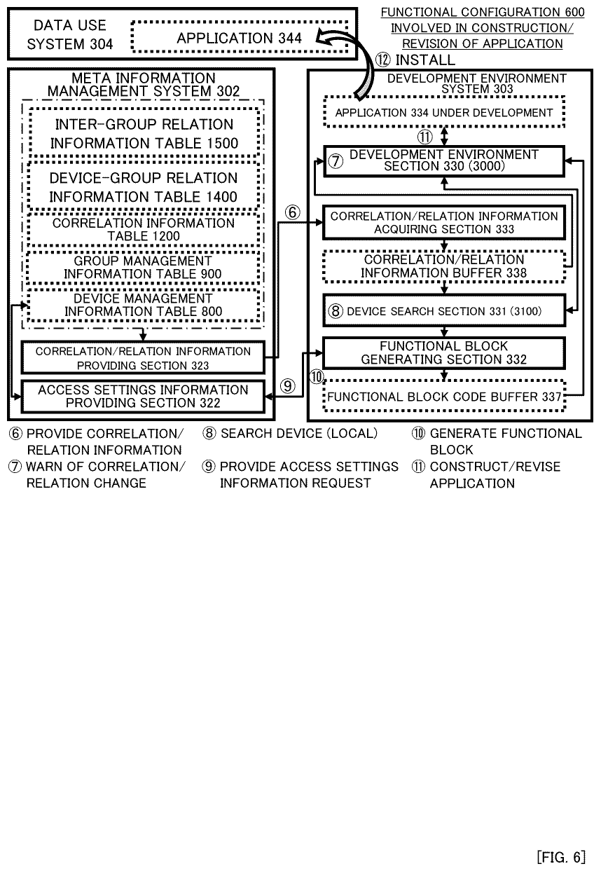

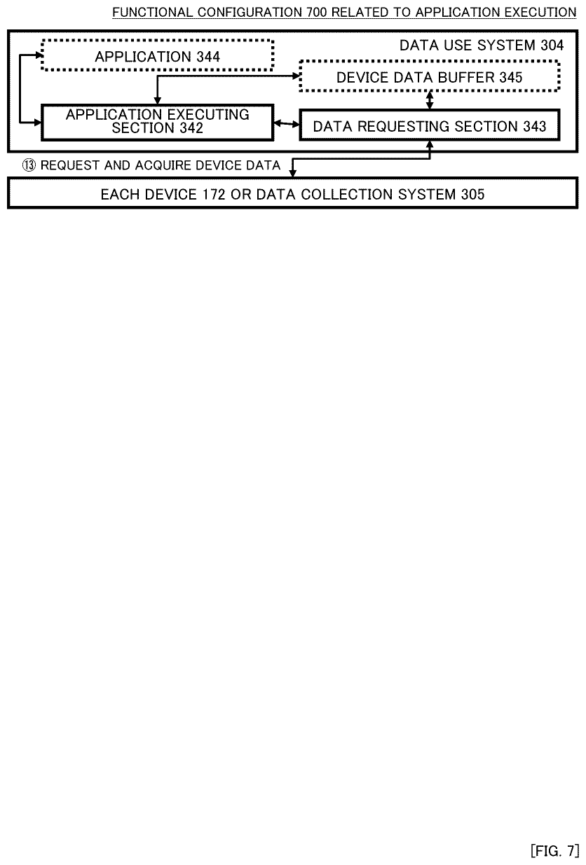

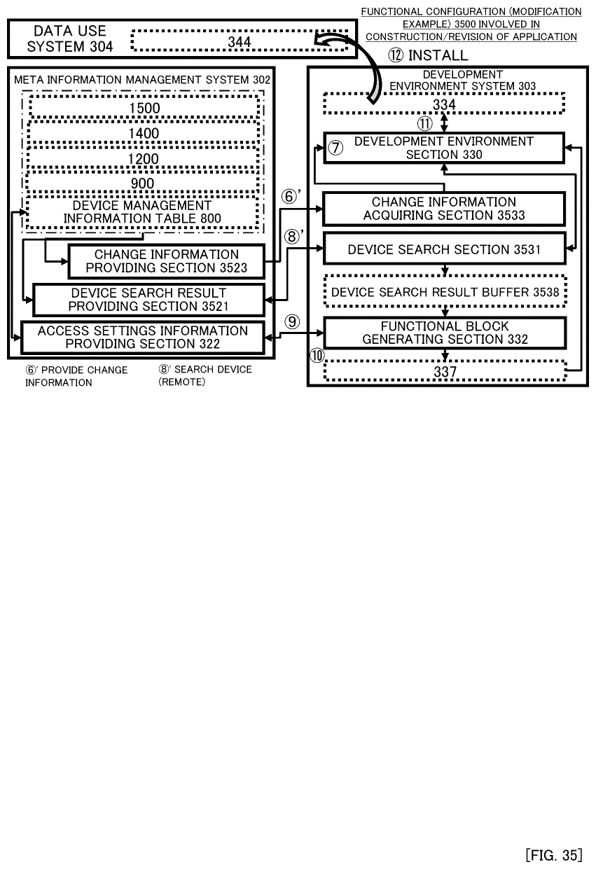

FIG. 1 depicts a basic functional configuration 100 of (and information to be handled by) a correlation analysis system 101 according to the embodiment of the present disclosure. Note that the entire functional configuration depicted in FIG. 1 is not essential. In addition, the existence of a functional configuration other than the functional configuration depicted in FIG. 1 is not precluded. Ones represented by solid-line rectangles and given “section” in their names in FIG. 1 (FIG. 4, FIG. 5, FIG. 6, FIG. 7, and FIG. 35) represent functional sections, and ones represented by dotted-line rectangles represent information (data) to be handled.

### 1-1. Devices/Groups/Correlations/Relations Handled by Correlation Analysis System

The correlation analysis system 101 according to the embodiment of the present disclosure is configured to determine information representing relations between devices 172 and groups 175 which are matters and the like at a site.

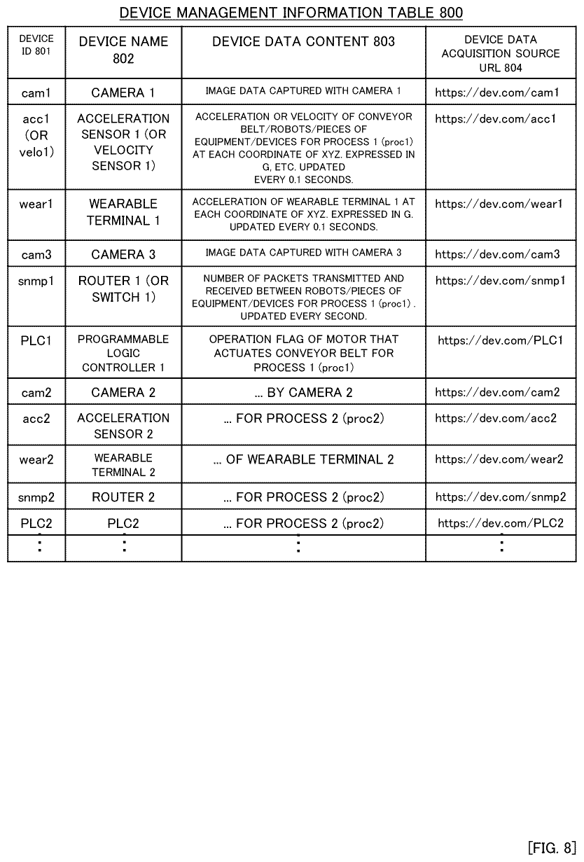

The devices 172 in the lower section in FIG. 1 may be configured to collect information representing the situation of the site and output the information as device data 182. For example, each of cameras, acceleration sensors, velocity sensors, wearable terminals, routers, or programmable logic controllers (PLCs) as depicted in a device management information table 800 in FIG. 8 may be a device 172 depicted in FIG. 1.

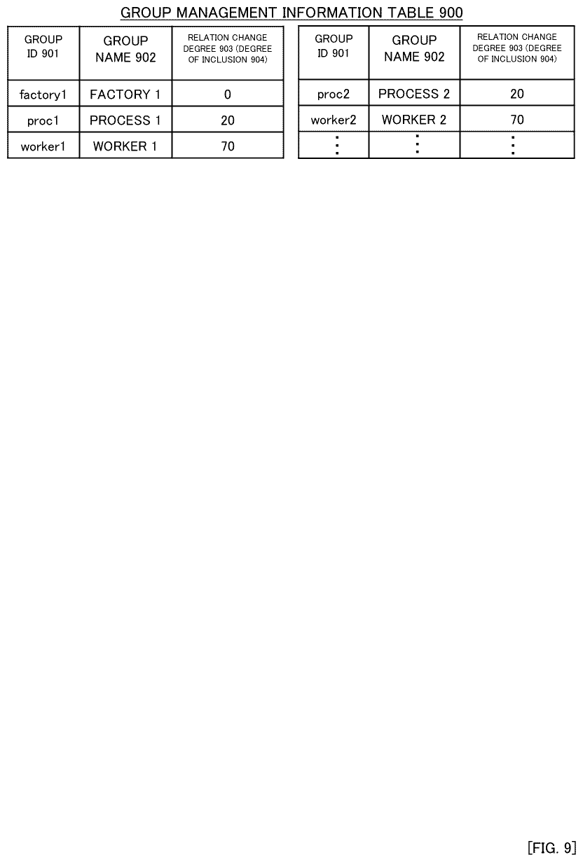

The groups 175 in the lower section in FIG. 1 are matters and the like which are present at the site and may be ones whose situations are observed by the devices 172 or may be ones between which some mutual hierarchical relations can be present. For example, each of factories, processes, or workers as depicted in a group management information table 900 in FIG. 9 may be a group 175 depicted in FIG. 1.

Correlations 162 represented by bold-line double-headed arrows in the lower section in FIG. 1 may have different strengths (correlation strengths) depending on combinations of devices 172. For example, there can be a case where two devices 172 acquire information regarding the same target object at the site, target objects that are close to each other at the site, or target objects that are related to each other at the site. In such a case, it can be expected that device data 182 output by each of the two devices 172 has an increased correlation (the correlation strength increases).

Examples of relations represented by outline single-headed arrows in the lower section in FIG. 1 can include a device-group relation 164 between a device 172 and a group 175, and an inter-group relation 165 between groups 175.

For example, in a case where a certain device 172 is a camera and a certain group 175 is workers, there can be a situation where the camera captures an image of the workers to collect information regarding the workers. In such a situation, a device-group relation 164 may exist between the certain device 172, which is the camera, and the group 175, which is the workers.

In addition, in a case where, for example, a certain group 175 is workers, and a second certain group 175 is a process (e.g., one of a production process (or a production line) and an inspection process (or an inspection line) of products at the site), there can be a situation where the workers are engaged in work of the process. In such a situation, an inter-group relation 165 may exist between the certain group 175, which is the workers, and the second certain group 175, which is the process. In this case, a hierarchical relation (a parent-child relation, an inclusion relation) may be set for two groups 175 associated by one inter-group relation 165. For example, if a plurality of workers can be engaged in one process, the process may be set as a relatively superior group (a parent in a parent-child relation, an including side in an inclusion relation) in an inter-group relation 165.

FIG. 2 depicts a more specific example of devices 172, groups 175, (the appearance of derivations from) correlations 162 between devices, device-group relations 164, and inter-group relations 165 depicted in the lower section in FIG. 1. The upper section in FIG. 2 depicts a situation where a worker 1 (worker1) is engaged in a process 1 (process1 (proc1)) and a worker 2 (worker2) is engaged in a process 2 (process2 (proc2)). The lower section in FIG. 2 depicts a situation where, after the worker 1 (worker1) has moved, the worker 1 (worker1) and the worker 2 (worker2) are engaged in the process 2 (proc2) together.

In FIG. 2, a camera 1 (cam1), a camera 3 (cam3), an acceleration sensor 1 (acc1), a wearable terminal 1 (wear1), a camera 2 (cam2), an acceleration sensor 2 (acc2), and a wearable terminal 2 (wear2) are depicted as examples of devices 172. In addition, a factory 1 (factory1), the process 1 (proc1), the worker 1 (worker1), the process 2 (proc2), and the worker 2 (worker2) are depicted as examples of groups 17 in FIG. 2.

In FIG. 2, only correlations 162 from which derivations to device-group relations 164 or inter-group relations 165 have appeared (for reasons such as relatively high correlation strengths, which are the strengths of the correlations 162) in correlations 162 between devices 172 are represented by dotted lines.

For example, at the upper section in FIG. 2, a correlation 162 between the camera 3 (cam3) and the acceleration sensor 1 (acc1), a correlation 162 between the camera 3 (cam3) and the wearable terminal 1 (wear1), and a correlation 162 between the acceleration sensor 2 (acc2) and the wearable terminal 2 (wear2) are represented by dotted lines. Derivations to device-group relations 164 or inter-group relations 165 have appeared from the correlations 162.

In addition, in the lower section in FIG. 2 depicting the situation after the worker 1 (worker1) has moved, a correlation 162 between the camera 3 (cam3) and the acceleration sensor 1 (acc1), a correlation 162 between the acceleration sensor 2 (acc2) and the wearable terminal 2 (wear2), and a correlation 162 between the camera 2 (cam2) and the wearable terminal 1 (wear1) are represented by dotted lines. Derivations to device-group relations 164 or inter-group relations 165 have appeared from these correlations 162.

In FIG. 2, device-group relations 164 that are set fixedly independently of correlations 162 (or device-group relations 164 that have been set fixedly by a fixation setting section 378 or a fixation setting section 388 mentioned later; referred to as “fixed-type device-group relations” below in some cases) in the existing device-group relations 164 are represented by non-directional solid-line line segments.

For example, in FIG. 2, fixed-type device-group relations are set between the process 1 (proc1) and the camera 1 (cam1), between the process 1 (proc1) and the acceleration sensor 1 (acc1), between the worker 1 (worker1) and the wearable terminal 1 (wear1), between the process 2 (proc2) and the camera 2 (cam2), between the process 2 (proc2) and the acceleration sensor 2 (acc2), and between the worker 2 (worker2) and the wearable terminal 2 (wear2). Note that which ones in the existing device-group relations 164 are set as fixed-type device-group relations may be set as desired.

In FIG. 2, device-group relations 164 that are established due to the appearance of derivations from any correlations 162 (hereinbelow, referred to as “derivation-type device-group relations” in some cases) in the existing device-group relations 164 are represented by non-directional dash-dotted-line line segments.

For example, in the upper section in FIG. 2, derivation-type device-group relations exist between the process 1 (proc1) and the camera 3 (cam3), between the process 1 (proc1) and the wearable terminal (wear1), between the worker 1 (worker1) and the acceleration sensor 1 (acc1), between the worker 1 (worker1) and the camera 3 (cam3), between the process 2 (proc2) and the wearable terminal 2 (wear2), and between the worker 2 (worker2) and the acceleration sensor 2 (acc2).

In addition, in the lower section in FIG. 2 depicting the situation after the worker 1 (worker1) has moved, derivation-type device-group relations exist between the process 1 (proc1) and the camera 3 (cam3), between the process 2 (proc2) and the wearable terminal 2 (wear2), between the worker 2 (worker2) and the acceleration sensor 2 (acc2), between the process 2 (proc2) and the wearable terminal 1 (wear1), and between the worker 1 (worker1) and the camera 2 (cam2).

In FIG. 2, inter-group relations 165 that are set fixedly independently of correlations 162 (or inter-group relations 165 that have been set fixedly by the fixation setting section 378 or the fixation setting section 388 mentioned later; referred to as “fixed-type inter-group relations” below in some cases) in the existing inter-group relations 165 are represented by unidirectional solid-line line segments.

For example, in FIG. 2, fixed-type inter-group relations exist between the (relatively superior) factory 1 (factory1) and the (relatively subordinate) process 1 (proc1), and between the (relatively superior) factory 1 (factory1) and the (relatively subordinate) process 2 (proc2). Note that which ones in the existing inter-group relations 165 are set as fixed-type inter-group relations may be set as desired.

In FIG. 2, inter-group relations 165 that are established due to the appearance of derivations from any correlations 162 (hereinbelow, referred to as “derivation-type inter-group relations” in some cases) in the existing inter-group relations 165 are represented by unidirectional dash-dotted-line line segments.

For example, in the upper section in FIG. 2, derivation-type inter-group relations 165 exist between the (relatively superior) process 1 (proc1) and the (relatively subordinate) worker 1 (worker1), and between the (relatively superior) process 2 (proc2) and the (relatively subordinate) worker 2 (worker2).

In addition, in the lower section in FIG. 2 depicting the situation after the worker 1 (worker1) has moved, derivation-type inter-group relations 165 exist between the (relatively superior) process 2 (proc2) and the (relatively subordinate) worker 2 (worker2), and between the (relatively superior) process 2 (proc2) and the (relatively subordinate) worker 1 (worker1).

### 1-2. Basic Functional Configuration of Correlation Analysis System and Basic Content of Information to be Handled

In order to control the appearance or disappearance of derivations from correlations 162, and the existence or inexistence of device-group relations 164 or inter-group relations 165 accompanying the appearance or disappearance of the derivations illustrated in FIG. 2, the correlation analysis system 101 has a functional configuration depicted in the upper section in FIG. 1, and handles information depicted in the upper section in FIG. 1.

As depicted in FIG. 1, the correlation analysis system 101 may have a correlation event sensing section 1900, a correlation event processing section 120, and a derivation appearance/disappearance event processing section 121.

### 1-2-1. Correlation Event Sensing Section, High Correlation Events, and Low Correlation Events

The correlation event sensing section 1900 senses a high correlation event or a low correlation event on the basis of each piece of device data 182 obtained from each of devices 172. A high correlation event is an event that leads to a presumption that a correlation 162 between devices 172 exists. A low correlation event is an event that leads to a presumption that a correlation 162 between devices 172 does not exist.

For example, it is assumed that a certain device 172 and a second certain device 172 acquire information regarding the same target matter which is present at the site, target matters that are close to each other at the site, or target matters that are related to each other at the site, and output the acquired information as device data 182. In such a case, an event that leads to a presumption that some correlation 162 exists often appears between the device data 182 output from the certain device 172 and the device data 182 output from the second certain device 172. For example, it can be expected that, in a case where both the certain device 172 and the second certain device 172 are configured to sense motions of target matters, times or time periods of detection of motions represented by the device data 182 output from the certain device 172 and the device data 182 output from the second certain device 172 are similar.

In addition, for example, it is assumed that a certain device 172 and a second certain device 172 acquire information regarding target matters which are present at the site and are not related to each other at all, and output the acquired information as device data 182. In such a case, an event that leads to a presumption that a correlation 162 does not exist often appears between the device data 182 output from the certain device 172 and the device data 182 output from the second certain device 172. For example, it can be expected that, in a case where both the certain device 172 and the second certain device 172 are configured to sense motions of target matters, times or time periods of detection of motions represented by the device data 182 output from the certain device 172 and the device data 182 output from the second certain device 172 are almost dissimilar.

When the correlation event sensing section 1900 has sensed a high correlation event or a low correlation event in each of combinations of devices 172, the correlation event sensing section 1900 gives a notification to that effect to the correlation event processing section 120.

### 1-2-2. Correlation Event Processing Section, Correlation Strengths, Derivation Appearance, and Derivation Disappearance

The correlation event processing section 120 updates correlation information 112 for managing correlation strengths which are the strengths of correlations 162 between devices 172 on the basis of a high correlation event or a low correlation event sensed by the correlation event sensing section 1900.

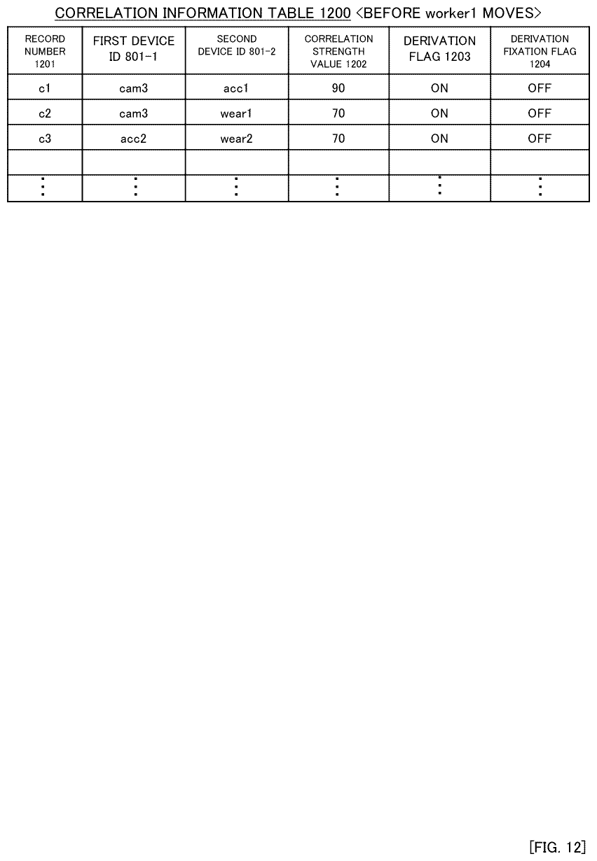

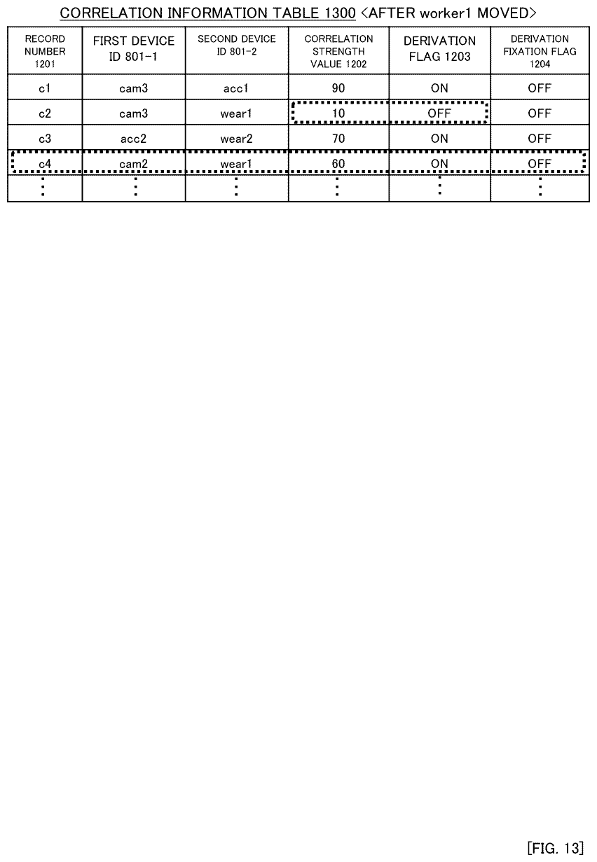

For example, as depicted in FIG. 12 and FIG. 13, in the correlation information 112, a correlation strength value 1202 of each combination of devices 172 may be managed. Then, when a high correlation event of a particular combination of devices 172 is sensed, the correlation event processing section 120 may update the correlation strength value 1202 of the particular combination of the devices 172 such that the correlation strength value 1202 represents a high correlation 162. Conversely, when a low correlation event of a particular combination of devices 172 is sensed, the correlation event processing section 120 may update the correlation strength value 1202 of the particular combination of the devices 172 such that the correlation strength value 1202 represents a low correlation 162.

In addition, for example, as depicted in FIG. 12 and FIG. 13, the correlation information 112 may be managed using a correlation information table 1200 (or 1300). A correlation strength (correlation strength value 1202) for a combination of devices 172 may be managed using each of correlation information records which are records in the correlation information table 1200 (or 1300).

The correlation event processing section 120 determines the appearance or disappearance of a derivation from a correlation 162 between devices 172 to a relation, on the basis of a correlation strength (correlation strength value 1202) between the devices 172. Here, the relation may be a device-group relation 164 between a group 175 and a device 172 or an inter-group relation 165 between groups 175.

For example, as depicted in FIG. 12 and FIG. 13, in the correlation information 112, a derivation flag 1203 which is information representing the appearance or disappearance of a derivation from a correlation 162 of each combination of devices 172 to a relation (a device-group relation 164 or an inter-group relation 165) may be managed. (Alternatively, derivation flags 1203 may not be provided in the correlation information 112, the correlation event processing section 120 may only inform the derivation appearance/disappearance event processing section 121 of the appearance or disappearance of a derivation.)

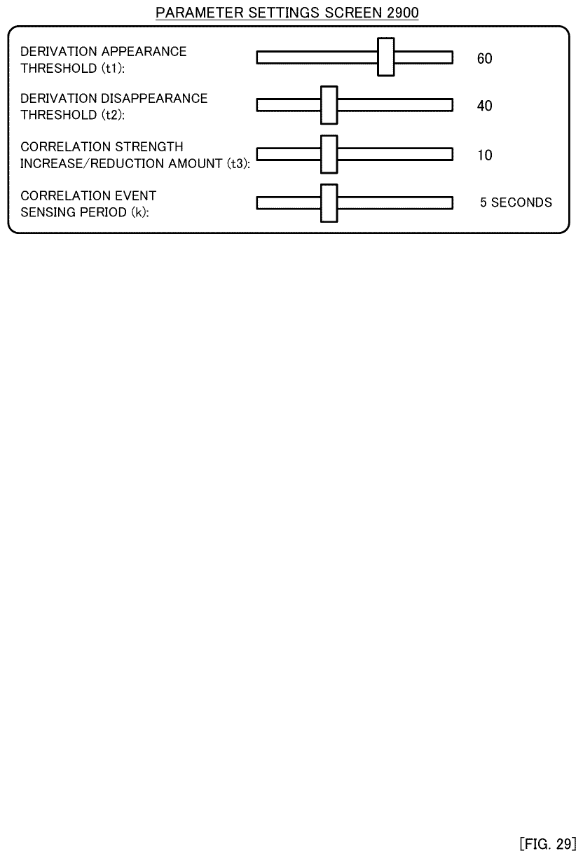

For example, in a case where a correlation strength (correlation strength value 1202) between devices 172 starts representing that the correlation 162 is high to some extent when the correlation strength satisfies a certain condition (e.g., a condition that the correlation strength is equal to or greater than a derivation appearance threshold (t1) depicted in FIG. 29, or a condition that the correlation strength is greater than the derivation appearance threshold (t1)), the correlation event processing section 120 may determine that a derivation from the correlation 162 to a relation (a device-group relation 164 or an inter-group relation 165) appears.

In contrast, in a case where a correlation strength (correlation strength value 1202) between devices 172 starts representing that the correlation 162 is low to some extent when the correlation strength satisfies another certain condition (e.g., a condition that the correlation strength is equal to or lower than a derivation disappearance threshold (t2) depicted in FIG. 29, or a condition that the correlation strength is lower than the derivation disappearance threshold (t2)), the correlation event processing section 120 may determine that a derivation from the correlation 162 to a relation (a device-group relation 164 or an inter-group relation 165) disappears.

When the correlation event processing section 120 has determined the appearance of a derivation or the disappearance of a derivation, the correlation event processing section 120 gives a notification to that effect to the derivation appearance/disappearance event processing section 121. Alternatively, the derivation appearance/disappearance event processing section 121 may sense determination of the appearance of a derivation or the disappearance of a derivation by the correlation event processing section 120 by sensing a change of the value of a derivation flag 1203 included in the correlation information 112.

Note that the correlation event processing section 120 in FIG. 1 corresponds to a high correlation event processing section 2000 and a low correlation event processing section 2400 in a detailed functional configuration in FIG. 5.

### 1-2-3. Derivation Appearance/Disappearance Event Processing Section and Changes of Existence or Inexistence of Relations

The derivation appearance/disappearance event processing section 121 updates device-group relation information 114 for managing whether or not there is a device-group relation 164, on the basis of the appearance or disappearance of a derivation determined by the correlation event processing section 120. In addition, the derivation appearance/disappearance event processing section 121 updates inter-group relation information 115 for managing whether or not there is an inter-group relation 165, on the basis of the appearance or disappearance of a derivation determined by the correlation event processing section 120.

In a case where a derivation from a correlation 162 of a particular combination of devices 172 to a relation (a device-group relation 164 or an inter-group relation 165) has appeared, the device-group relation 164 or the inter-group relation 165 that had not existed until then can newly appear.

For example, in a case where the situation depicted in the upper section in FIG. 2 has changed to the situation depicted in the lower section in FIG. 2, a derivation from a correlation 162 between the camera 2 (cam2) and the wearable terminal 1 (wear1) to a relation (a device-group relation 164 or an inter-group relation 165) appears due to the increased correlation strength value 1202 of the correlation 162. Along with the appearance of the derivation, in the lower section in FIG. 2, device-group relations 164 newly appear between the process 2 (proc2) and the wearable terminal (wear1), and between the worker 1 (worker1) and the camera 2 (cam2). In addition, along with the appearance of the derivation, in the lower section in FIG. 2, an inter-group relation 165 appears between the process 2 (proc2) and the worker 1 (worker1).

In addition, in a case where a derivation from a correlation 162 of a particular combination of devices 172 to a relation (a device-group relation 164 or an inter-group relation 165) has disappeared, the device-group relation 164 or the inter-group relation 165 having existed until then can disappear.

For example, in a case where the situation depicted in the upper section in FIG. 2 has changed to the situation depicted in the lower section in FIG. 2, a derivation from a correlation 162 between the camera 3 (cam3) and the wearable terminal 1 (wear1) to a relation (a device-group relation 164 or an inter-group relation 165) disappears due to the decreased correlation strength value 1202 of the correlation 162. Along with the disappearance of the derivation, in the lower section in FIG. 2, the device-group relations 164 having existed between the process 1 (proc1) and the wearable terminal (wear1), between the worker 1 (worker1) and the acceleration sensor 1 (acc1), and between the worker 1 (worker1) and the camera 3 (cam3) disappear. In addition, along with the disappearance of the derivation, in the lower section in FIG. 2, the inter-group relation 165 having existed between the process 1 (proc1) and the worker 1 (worker1) disappears.

The derivation appearance/disappearance event processing section 121 determines changes of the existence or inexistence device-group relations 164 or the existence or inexistence of inter-group relations 165 like the ones described above, and causes the device-group relation information 114 and the inter-group relation information 115 to reflect results of the determination.

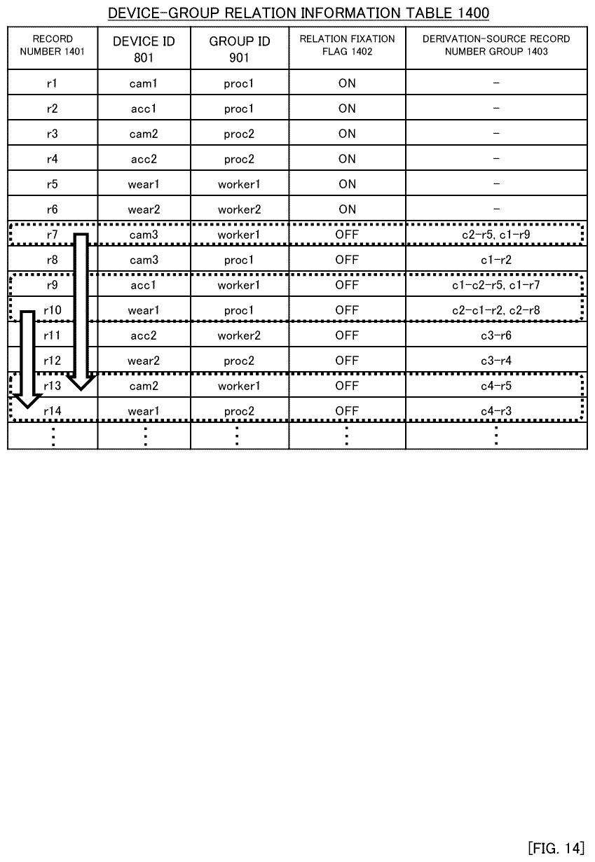

As depicted in FIG. 14, the device-group relation information 114 may be managed using a device-group relation information table 1400. In each of device-group relation information records which are records in the device-group relation information table 1400, information identifying a correlation 162 or another device-group relation 164 which is a basis of the existence of a device-group relation 164 (or information identifying a derivation-source correlation 162 that has triggered the appearance of the device-group relation 164) may be managed for a combination of a device 172 and a group 175.

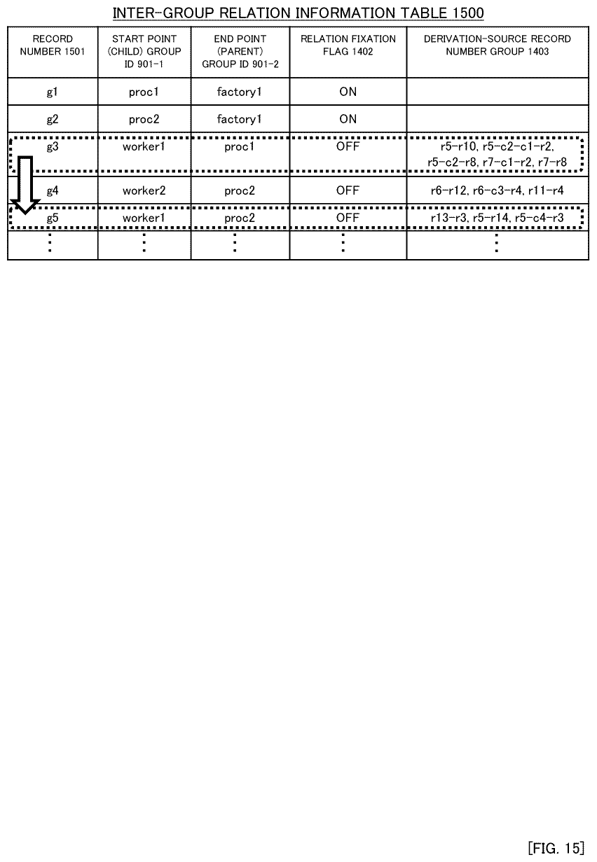

In addition, as depicted in FIG. 15, the inter-group relation information 115 may be managed using an inter-group relation information table 1500. In each of inter-group relation information records which are records in the inter-group relation information table 1500, information identifying a correlation 162, a device-group relation 164, or another inter-group relation 165 which is a basis of the existence of an inter-group relation 165 (or information identifying a derivation-source correlation 162 that has triggered the appearance of the inter-group relation 165) may be managed for a combination of groups 175.

Note that the derivation appearance/disappearance event processing section 121 in FIG. 1 corresponds to a derivation appearance event processing section 2100, a device-group relation information derivation appearance instance updating section 2200, an inter-group relation information derivation appearance instance updating section 2300, a derivation disappearance event processing section 2500, a device-group relation information derivation disappearance instance updating section 2600, and an inter-group relation information derivation disappearance instance updating section 2700 in the detailed functional configuration in FIG. 5.

Since the correlation analysis system 101 in the embodiment of the present disclosure has a functional configuration like the one described above, the correlation analysis system 101 can achieve advantages depicted in SUMMARY OF THE INVENTION mentioned above (advantages depicted in paragraphs [0009] to [0011]).

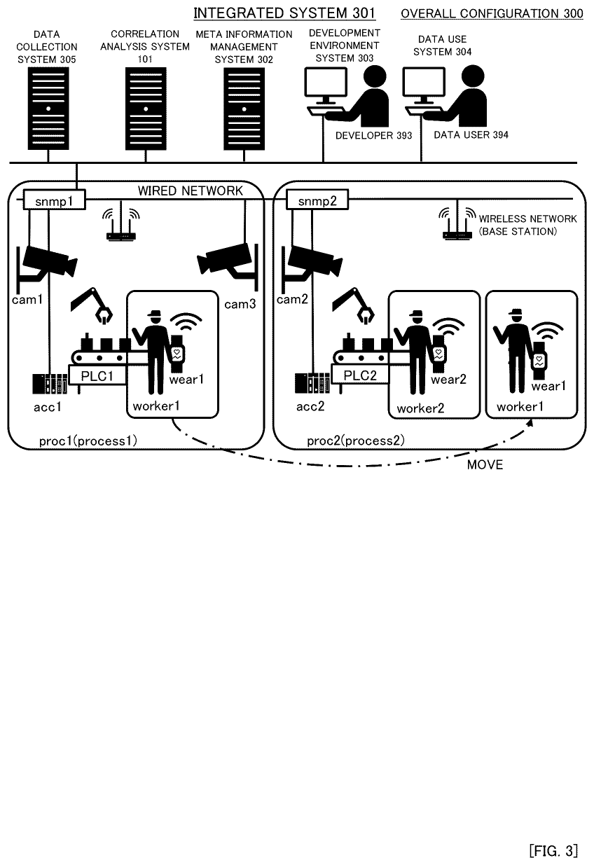

### 2. Overall Configuration Including Correlation Analysis System 101 (FIG. 3)

FIG. 3 depicts an overall configuration 300 including the correlation analysis system 101 according to the embodiment of the present disclosure. Note that not the entire functional configuration depicted in FIG. 3 is essential. In addition, the existence of a functional configuration other than the functional configuration depicted in FIG. 3 is not precluded.

2-1. Site where Devices are Installed and Groups are Set

As has already been explained with reference to FIG. 1 and FIG. 2, the correlation analysis system 101 handles a plurality of devices 172 and a plurality of groups 175. The plurality of devices 172 and the plurality of groups 175 here may be ones related to a site like the one depicted in the lower section in FIG. 3. The lower section in FIG. 3 depicts a case example of a site generally in line with an example 200 of correlations and relations depicted in FIG. 2.

In the lower section in FIG. 3, a work field of the process 1 (process1 (proc1)) at the site (e.g., the factory 1 (factory1)) is depicted in the lower left section, and a work field of the process 2 (process2 (proc2)) is depicted in the lower right section. In either work field, there may be robots, pieces of equipment, and devices. In either work field, mutual communication between robots, pieces of equipment, and devices may be performed via a wired network, may be performed via a wireless network using a base station, or may be performed using both a wireless network and a wired network.

In the work field of the process 1 (proc1) depicted in the lower left section in FIG. 3, there are a robot and the worker 1 (worker1) near a conveyor belt for moving products produced or inspected in the process 1 (proc1). The process 1 (proc1) may be a production line or an inspection line.

Here, the process 1 (proc1) and the worker 1 (worker1) are handled as groups 175. As depicted in the group management information table 900 in FIG. 9, a relation change degree 903 (or a degree of inclusion 904) is set for each of groups 175. The lower the numerical value of a relation change degree 903 (or a degree of inclusion 904) is, the higher the group 175 is positioned in a hierarchical relation among groups 175.

In the work field of the process 1 (proc1), there is a programmable logic controller 1 (PLC1) for controlling a motor that actuates the conveyor belt used in the process 1 (proc1). As depicted in the device management information table 800 in FIG. 8, the programmable logic controller 1 (PLC1) is configured to control an operation mode of the motor that actuates the conveyor belt used in the process 1 (proc1), and may be configured to output, as device data 182, an operation flag representing the operation mode. For example, the operation mode may be a mode in which the conveyor belt is transporting products or the like or a mode in which the conveyor belt is deactivated. Alternatively, the operation mode may be determined depending on the degree of the magnitude of the transportation velocity of the conveyor belt.

The worker 1 (worker1) may carry the wearable terminal 1 (wear1). As depicted in the device management information table 800 in FIG. 8, the wearable terminal 1 (wear1) may be capable of measuring the acceleration of itself. Then, the wearable terminal 1 (wear1) may output, as device data 182, a component value of each of three-dimensional coordinates (X,Y,Z) in the measured acceleration. Alternatively, the wearable terminal 1 (wear1) may be configured to be capable of determining only whether or not the magnitude of the acceleration of itself is equal to or greater than a predetermined threshold or is greater than the predetermined threshold. In that case, the wearable terminal 1 (wear1) may output, as device data 182, information regarding a flag representing the magnitude relation between the magnitude of the acceleration of itself and the predetermined threshold.

In the work field of the process 1 (proc1), the acceleration sensor (acc1) or a velocity sensor 1 (velo1) (although not illustrated in the lower left section in FIG. 3) may be installed. As depicted in the device management information table 800 in FIG. 8, the acceleration sensor (acc1) or the velocity sensor 1 (velo1) may be configured to measure the acceleration or velocity of the conveyor belt, a robot, equipment, or a device in the work field of the process 1 (proc1). Then, the acceleration sensor (acc1) or the velocity sensor 1 (velo1) may output, as device data 182, a component value of each of three-dimensional coordinates (X,Y,Z) in the measured acceleration or velocity. Note that the acceleration sensor (acc1) or the velocity sensor 1 (velo1) may measure the acceleration or velocity in one-dimensional direction which is a direction in which the conveyor belt transports products or the like as the acceleration or velocity of the conveyor belt, and then output the acceleration or the velocity as device data 182.

In the work field of the process 1 (proc1), a router 1 or a switch 1 (snmp1) may be set. As depicted in the device management information table 800 in FIG. 8, the router 1 or the switch 1 (snmp1) may be configured to count the packet count of communication packets (or measure the amount of communication) transmitted and received via a wired network or a wireless network between various types of robot, various types of equipment, or various types of device 172 in the process 1 (proc1), on the basis of a Simple Network Management Protocol (SNMP). The router 1 or the switch 1 (snmp1) may output, as device data 182, information regarding the measured packet count (or amount of communication).

In the work field of the process 1 (proc1), the camera 1 (cam1) and the camera 3 (cam3) may be installed. As depicted in the device management information table 800 in FIG. 8, the camera 1 (cam1) and the camera 3 (cam3) may be configured to acquire image data. In the example depicted in the lower left section in FIG. 3, the camera 1 (cam1) and the camera 3 (cam3) capture images of the state of the work field of the process 1 (proc1). The camera 1 (cam1) and the camera 3 (cam3) may output acquired image data as device data 182.

The lower right section in FIG. 3 depict that, in the work field of the process 2 (proc2), there are a conveyor belt for moving products produced or inspected in the process 2 (proc2), a robot, the worker 2 (worker2), a programmable logic controller 2 (PLC2), the wearable terminal 2 (wear2), the acceleration sensor 2 (acc2), a router 2 or a switch 2 (snmp2), and the camera 2 (cam2). The process 2 (proc2) may be a production line or an inspection line.

The process 2 (proc2) and the worker 2 (worker2) are handled as groups 175 similarly to the process 1 (proc1) and the worker 1 (worker1).

In addition, the functions of the robot, the equipment, and the devices described above that are in the work field of the process 2 (proc2) may also be similar to the functions of the robot, the equipment, and the devices explained already about the work field of the process 1 (proc1).

FIG. 3 depicts also a state where the worker 1 (worker1) moves from the work field of the process 1 (proc1) to the work field of the process 2 (proc2). FIG. 3 depicts also that the worker 1 (worker1) moves while carrying the wearable terminal 1 (wear1).

As has already been depicted, the lower section in FIG. 3 can be a site including a production line or an inspection line of products or the like. In such a case, the embodiment of the present disclosure assists in grasping the situation at the site including the production line or the inspection line and in grasping changes of the situation. Further, the embodiment of the present disclosure assists also in controlling the site including the production line or the inspection line.

2-2. Various Types of System Using Device Data Obtained from Site

As depicted in the upper section in FIG. 3, there may be various types of system other than the correlation analysis system 101 whose outline has been explained using FIG. 1 and FIG. 2.

For mutual transmission and reception of information among the correlation analysis system 101, the various types of system, and the site depicted in the lower section in FIG. 3, any type of network such as a wired network, a wireless network, a local area network (LAN), or a wide area network (WAN) may be used, and a network with any network topology may be used.

The various types of system depicted in the upper section in FIG. 3 and the correlation analysis system 101 may be collectively called an integrated system 301, and what is called the integrated system 301 may further include also the site depicted in the lower section in FIG. 3.

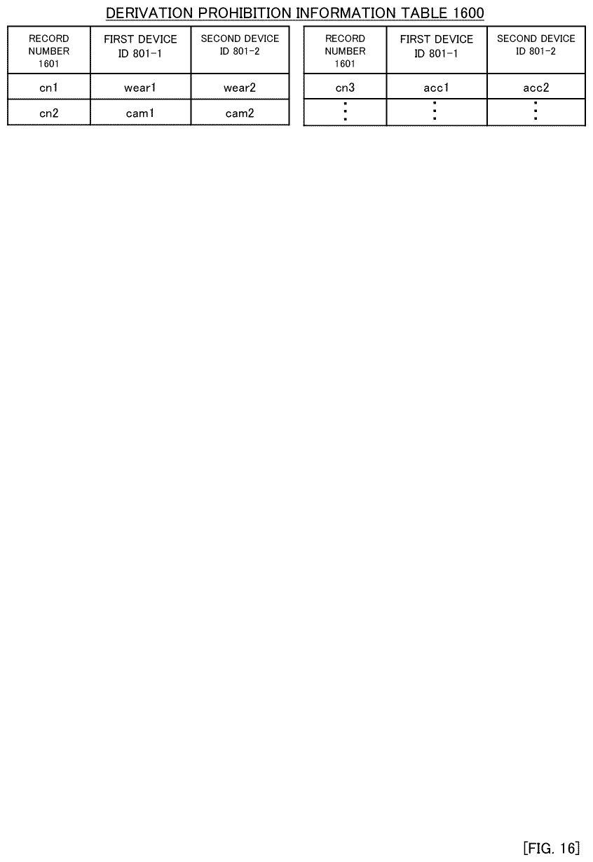

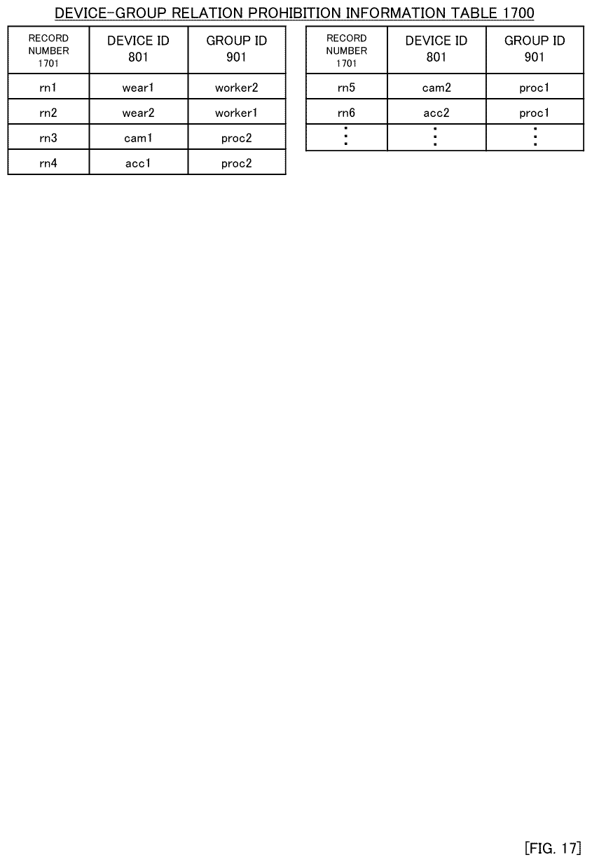

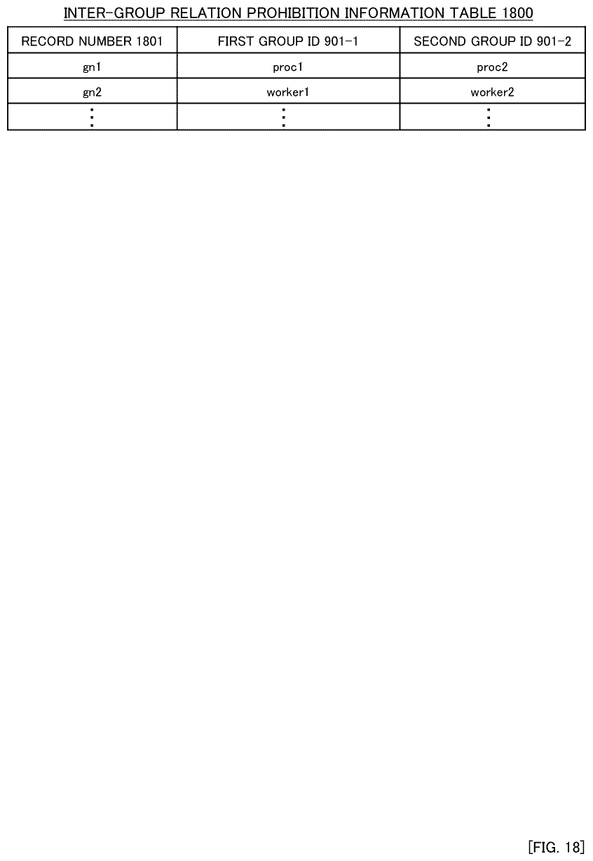

The upper section in FIG. 3 depicts a meta information management system 302 as one of the various types of system. The meta information management system 302 manages meta information regarding devices 172 which are present at the site and groups 175 which are set at the site. The meta information is information representing characteristics and attributes of the devices 172 or the groups 175. In addition, the meta information can also include information representing mutual relations between the devices 172 and the groups 175, that is, information such as the correlation information 112, the device-group relation information 114, and the inter-group relation information 115 explained with reference to FIG. 1, and information related to them. For example, the information retained by the meta information management system 302 may be the device management information table 800 in FIG. 8, the group management information table 900 in FIG. 9, the correlation information table 1200 (or the correlation information table 1300) in FIG. 12 or FIG. 13, the device-group relation information table 1400 in FIG. 14, the inter-group relation information table 1500 in FIG. 15, a derivation prohibition information table 1600 in FIG. 16, a device-group relation prohibition information table 1700 in FIG. 17, and an inter-group relation prohibition information table 1800 in FIG. 18. Note that device data 182 itself output by devices 172 or information obtained by processing the device data 182 is mainly handled in the correlation analysis system 101, a data use system 304 mentioned later, and a data collection system 305 mentioned later.

There can be various uses for which the correlation information 112 (correlation information table 1200 or correlation information table 1300), the device-group relation information 114 (device-group relation information table 1400), and the inter-group relation information 115 (inter-group relation information table 1500) that are generated by the correlation analysis system 101 and retained in the meta information management system 302 are used.

In one of such uses, the various types of information described above are used in the work of constructing and revising an application using device data 182 obtained from the site depicted in the lower section in FIG. 3. The upper section in FIG. 3 depicts a development environment system 303 as one of the various types of system. When a developer 393 performs the work of constructing or revising an application using the development environment system 303, the development environment system 303 acquires, from the meta information management system 302, information identifying an information-source device 172, the information serving as an information source of information to be acquired when the application is executed. The development environment system 303 can present the information identifying the device 172 to the developer 393.

The application constructed or revised by the developer 393 using the development environment system 303 is executed by the data use system 304 depicted in the upper section in FIG. 3. An execution result of the application is provided to a data user 394. The data use system 304 that executes the application in response to input information input from the data user 394 to the data use system 304 may control the robots, the pieces of equipment, and the devices which are present at the site and depicted in the lower section in FIG. 3.

Note that, in a case where various types of information retained in the meta information management system 302 are used for a use other than accumulation or development of an application, the development environment system 303 or the data use system 304 depicted in the upper section in FIG. 3 may not be required.

The correlation analysis system 101 may directly acquire device data 182 from devices 172. In that case, the data collection system 305 depicted in the upper section in FIG. 3 may not be required.

Alternatively, the data collection system 305 depicted in the upper section in FIG. 3 may be provided, and then the data collection system 305 may directly collect device data 182 from devices 172. In that case, the data collection system 305 may accumulate the device data 182 in the collected information database 355 (collected information DB) depicted in FIG. 4. Then, the correlation analysis system 101 may acquire the device data 182 from the data collection system 305.

The upper section in FIG. 3 depicts each of the correlation analysis system 101, the meta information management system 302, the development environment system 303, the data use system 304, and the data collection system 305 as a discrete system.

Some or all of the systems depicted in the description above may be combined into one integrated system. For example, functional sections and information that the correlation analysis system 101 has and functional sections and information that the meta information management system 302 has may be integrated into one system. In addition, for example, functional sections and information that the development environment system 303 has and functional sections and information that the data use system 304 has may be integrated into one system.

### 3. Computer Architecture for Realizing Embodiment of Present Disclosure (FIG. 36)

FIG. 36 depicts a computer architecture 3600 for realizing the correlation analysis system 101 according to the embodiment of the present disclosure. The computer architecture 3600 depicted in FIG. 36 may be called an information processing apparatus or an information processing system. (In addition, the computer architecture 3600, which is an information processing apparatus or an information processing system, may be understood to be configured to execute a correlation analysis method.) Note that various types of system included in the integrated system 301 depicted in FIG. 3 also may be realized by a computer architecture similar to the computer architecture 3600 depicted in FIG. 36.

In order to realize the correlation analysis system 101, some or all of a calculation processing apparatus 3601, a storage apparatus 3602, a non-volatile recording medium (recording apparatus) 3603, an external recording medium drive 3604, an input apparatus 3606, a display/output apparatus 3607, a communication apparatus 3608, an external input/output port 3609, and a reading apparatus 3610 may be interconnected by an interconnecting section 3611. (Note that part or the whole of the interconnecting section 3611 may be a network. In that case, the correlation analysis system 101 is realized by a plurality of apparatuses connected via the network.)

For example, the calculation processing apparatus 3601 may be a processor. Examples of the processor include a central processing unit (CPU), a micro processor unit (MPU), and a graphics processing unit (GPU). Alternatively, the processor mentioned here may be another semiconductor device as long as the semiconductor device is a subject that executes predetermined processes. In addition, the calculation processing apparatus 3601 may be one or more (micro)processors.

For example, the storage apparatus 3602 may be a memory. For example, the non-volatile recording medium (recording apparatus) 3603 may be a non-volatile memory (e.g., a flash memory) or a non-volatile disk apparatus. For example, the external recording medium drive 3604 may be a disk drive. For example, the input apparatus 3606 may be a mouse, a keyboard, an image-capturing apparatus, a sensor, a touch panel, or a pointing device. For example, the display/output apparatus 3607 may be a display, a printer, or a speaker. For example, the communication apparatus 3608 may be a communication apparatus for wired communication or a communication apparatus for wireless communication. The communication apparatus 3608 may be a network interface apparatus (NIC) that controls communication with another system, apparatus, terminal, or server according to a predetermined protocol. For example, the interconnecting section 3611 may be a bus or a crossbar switch. (As mentioned above, part or the whole of the interconnecting section 3611 may be a network.)

Various types of program included in a program group 3631 (e.g., programs for realizing the functional configuration according to the present disclosure; for example, various types of program for implementing each of the functional sections realized by the correlation analysis system 101; the whole may be called a correlation analysis program), various types of data group included in a data group 3632, or information included in various types of information 3633 may be recorded on the non-volatile recording medium (recording apparatus) 3603.

The program group 3631 may include each of various types of program for realizing one of the functional sections expressed as “sections” in the functional configuration diagrams depicted in FIG. 1, FIG. 4, and FIG. 5. (Functional sections in FIG. 6, FIG. 7, and FIG. 35 also may be realized by program execution in a similar mode.) Note that some of the programs described above may be integrated into one program. In addition, any of the programs described above may be divided into a plurality of programs.

The data group 3632 may include information (data, etc.) handled by the functional sections described above. For example, the data group 3632 may include information included in each of information groups or data groups represented by dotted-line frames in the functional configuration diagrams in FIG. 1, FIG. 4, and FIG. 5. (Note that part or the whole of the information included in the information groups or the data groups may be stored on the storage apparatus 3602 (memory).) (Information groups or data groups in FIG. 6, FIG. 7, and FIG. 35 also may be retained in a similar mode.)

Instead of what has been described above, part or the whole of the various types of program included in the program group 3631, the various types of information group or data group included in the data group 3632, or the information included in the various types of information 3633 that are described above may be acquired from the outside of the configuration depicted in FIG. 36, in another possible mode.

The external recording medium drive 3604 can be connected with an external recording medium 3605. For example, the external recording medium 3605 may be a portable recording disk (digital versatile disc (DVD), etc.), an integrated circuit (IC) card, a secure digital (SD) card, a non-volatile memory (e.g., a flash memory), or a portable hard disk. Note that information similar to the various types of program included in the program group 3631, the various types of information group or data group included in the data group 3632, or the information included in the various types of information 3633 is transferred from the external recording medium 3605 to the non-volatile recording medium (recording apparatus) 3603 or the storage apparatus 3602, and stored thereon, in another possible mode. The external recording medium 3605 may be used for recording programs or data handled in the correlation analysis system 101. The external recording medium drive 3604 and the external recording medium 3605 are connected to the correlation analysis system 101 illustrated in FIG. 36 via a network, in another possible mode.

The various types of program included in the program group 3631, the various types of information group or data group included in the data group 3632, or the information included in the various types of information 3633 may be brought through the communication apparatus 3608, the external input/output port 3609, the input apparatus 3606, and the reading apparatus 3610, and recorded or stored on the non-volatile recording medium (recording apparatus) 3603 or the storage apparatus 3602.

In order for the architecture depicted in FIG. 36 to function as the correlation analysis system 101, each functional section in the correlation analysis system 101, or a portion of each functional section (to execute one process (step) or a series of processes (steps)), the various types of program included in the program group 3631 may be loaded (e.g., from the non-volatile recording medium (recording apparatus) 3603) to the storage apparatus 3602. The programs after being loaded are denoted with 3621 in FIG. 36. Then, the calculation processing apparatus 3601 may execute the programs 3621 (using also the various types of information group or data group included in the data group 3632 or the information included in the various types of information 3633 in the non-volatile recording medium (recording apparatus) 3603 or the like, as necessary). Execution of the programs 3621 realizes functions of the correlation analysis system 101, each functional section in the correlation analysis system 101, or a portion of each functional section (results in execution of one process (step) or a series of processes (steps)). At this time, various types of buffer 3623 formed temporarily in the storage apparatus 3602 also may be used as appropriate.

### 4. Functional Configuration, Processes, and Information According to Embodiment

Hereinbelow, with focus on the correlation analysis system 101, the functional configuration, processes, and information of the integrated system 301 including the correlation analysis system 101 are explained.

Broadly speaking, the following explains a case where a device 172 is installed at the site and a case where correlations and relations are detected or managed. Moreover, the following explains a case where an application is constructed or revised or the like as a case example of a use of information regarding correlations and relations related to devices 172 and groups 175.

### 4-1. Functional Configuration, Processes, and Information

Involved at Time of Device Installation (FIG. 4) This section explains a functional configuration, processes, and information involved at the time of installation of a device 172 in the integrated system 301.

With functional configuration, processes, and information explained below, when a device 172 is installed at the site, the device 172 can be recognized by the meta information management system 302 and the correlation analysis system 101. Then, it becomes possible for the correlation analysis system 101 to acquire device data 182 output from the device 172, and detect correlations and relations using the device data 182. In addition, it becomes possible for the meta information management system 302 to manage information regarding the correlations and the relations detected on the basis of the device data 182 output from the recognized device 172.

FIG. 4 depicts a functional configuration involved, and information handled at the time of installation of a device 172 in the integrated system 301. Note that not the entire functional configuration and information depicted in FIG. 4 are essential. In addition, the existence of a functional configuration and information other than the functional configuration depicted in FIG. 4 is not precluded.

### 4-1-1. Functional Configuration, Processes, and Information Involved at Time When Device Is Installed

In FIG. 4, a device 172 to be newly installed at the site is denoted as a device 172-NEW. Note that illustrations of devices 172 that have already been installed at the site are omitted in FIG. 4.

Accompanying the installation of the device 172-NEW at the site, information (device registration request) for device registration is input to a device registration accepting section 321, which is a functional section that the meta information management system 302 has. This input of information for device registration may be performed on the device registration accepting section 321 from the device 172-NEW itself. An administrator 401 or the like of the meta information management system 302 may input information (device registration request) for device registration to the device registration accepting section 321 through a user interface provided by the meta information management system 302.

For example, the information (device registration request) for device registration input to the device registration accepting section 321 may be part or the whole of information that should be retained in a device management information record which is one record (for the device 172-NEW to be newly installed) in the device management information table 800 depicted in FIG. 8.

FIG. 8 depicts the device management information table 800 that the meta information management system 302 has.

For each device 172 installed at the site, the device management information table 800 has a device management information record which is a record in the device management information table 800. The device management information record may have some or all of fields of a device identifier (ID) 801, a device name 802, device data content 803, and a device data acquisition source uniform resource locator (URL) 804.

It is assumed, in the example depicted in FIG. 8, that, when the correlation analysis system 101 or the data use system 304 acquires device data 182, the correlation analysis system 101 or the data use system 304 accesses a URL set for each device 172. In a case where the correlation analysis system 101 or the data use system 304 directly accesses a device 172 when the correlation analysis system 101 or the data use system 304 acquires device data 182, the access to a URL represented by the device data acquisition source URL 804 is direct access to the device 172. Meanwhile, in a case where the correlation analysis system 101 or the data use system 304 accesses the collected information database 355 (collected information database (DB)) in the data collection system 305 when the correlation analysis system 101 or the data use system 304 acquires device data 182, the access to a URL represented by the device data acquisition source URL 804 is access to the data collection system 305.

If a technique different from URL-designated access is adopted as a technique to acquire device data 182, the device management information records may have the fields of access settings information conforming to the adopted technique to acquire device data 182 instead of the fields of device data acquisition source URLs 804.

In FIG. 8, a device 172 whose device name 802 is “camera 1” is given “cam1” as its device ID 801. In addition, the content of device data 182 output from the device 172 whose device name 802 is “camera 1” is “image data captured with the camera 1.”

In FIG. 8, a device 172 whose device name 802 is “acceleration sensor 1 (or velocity sensor 1)” is given “acc1 (or velo1)” as its device ID 801. The content of device data 182 output from the device 172 whose device name 802 is “acceleration sensor 1 (or velocity sensor 1)” is “acceleration or velocity of conveyor belt/robots/pieces of equipment/devices for process 1 (proc1) at each coordinate of XYZ; expressed in G, etc.; updated every 0.1 seconds.”

In FIG. 8, a device 172 whose device name 802 is “wearable terminal 1” is given “wear1” as its device ID 801. In addition, the content of device data 182 output from the device 172 whose device name 802 is “wearable terminal 1” is “acceleration of wearable terminal 1 at each coordinate of XYZ; expressed in G; updated every 0.1 seconds.” Alternatively, the content of device data 182 output from the device 172 whose device name 802 is “wearable terminal 1” may be “information representing whether or not magnitude of acceleration of wearable terminal 1 is equal to or greater than predetermined threshold or greater than predetermined threshold.”

In FIG. 8, a device 172 whose device name 802 is “router 1 (or switch 1)” is given “snmp1” as its device ID 801. In addition, the content of device data 182 output from the device 172 whose device name 802 is “router 1 (or switch 1)” is “number of packets transmitted and received between robots/pieces of equipment/devices for process 1 (proc1); updated every second.”

In FIG. 8, a device 172 whose device name 802 is “programmable logic controller 1” is given “PLC1” as its device ID 801. In addition, the content of device data 182 output from the device 172 whose device name 802 is “programmable logic controller 1” is “operation flag of motor that actuates conveyor belt for process 1 (proc1).”

FIG. 8 depicts also device management information records whose device names 802 are “camera 3,” “camera 2,” “acceleration sensor 2,” “wearable terminal 2,” “router 2,” and “programmable logic controller 2 (PLC2),” and these are also similar to the device management information records having already been explained.

In addition, those other than the devices 172 of the types depicted in FIG. 8 also may be used. For example, an infrared sensor for sensing the existence and motions of humans may be used as a device 172.

Note that, if the administrator 401, the developer 393, or the data user 394 does not directly refer to “device names 802” or “device data content 803,” “device names 802” or “device data content 803” do not have to be included in the device management information records.

The explanation returns to FIG. 4. Upon the acceptance of the device registration request for registering the device 172-NEW, the device registration accepting section 321 registers, in the device management information table 800 retained by the meta information management system 302, information included in the device registration request. More specifically, the device registration accepting section 321 creates a device management information record for the device 172-NEW, and registers the device management information record in the device management information table 800.

The device registration accepting section 321 issues a registration notification (device registration notification) for notifying the correlation analysis system 101 that the device 172-NEW has been newly registered. This registration notification may include information which is part or the whole of information included in the device management information record for the device 172-NEW. The registration notification is accepted by a registration notification accepting section 311, which is a functional section of the correlation analysis system 101.

Note that, in a case where there is the data collection system 305, the device registration accepting section 321 may issue a registration notification for notifying also the data collection system 305 that the device 172-NEW has been registered. In this case, the registration notification is accepted by a registration notification accepting section 351, which is a functional section of the data collection system 305.

The registration notification accepting section 311 may register, in a device management information buffer 318 retained by the correlation analysis system 101, information included in the accepted registration notification. The device management information buffer 318 may be configured to retain information which is included in information that the device management information table 800 has, and is used at least when a data requesting section 313, which is a functional section of the correlation analysis system 101, performs a process of acquiring device data 182. For example, the device management information buffer 318 may be configured to retain “device ID 801” and “device data acquisition source URL 804 (or other type of access settings information)” in FIG. 8 in information that the device management information record for the registration-notification-target device 172 has.

As mentioned above, in a case where there is the data collection system 305, the registration notification accepting section 351 may register, in a device management information buffer 358 retained by the data collection system 305, information included in the accepted registration notification. The device management information buffer 358 may be configured to retain information which is included in information that the device management information table 800 has, and is used at least when a data collecting section 354, which is a functional section of the data collection system 305, performs a process of collecting device data 182 from a device 172, and storing the device data 182 in the collected information database 355 (collected information DB). In addition, the device management information buffer 358 may be configured to retain information which is included in information that the device management information table 800 has, and is used at least when a data responding section 353, which is a functional section of the data collection system 305, performs a process of taking out device data 182 from the collected information database 355 (collected information DB) in response to a data request from the data requesting section 313, and responding to the data requesting section 313 with the device data 182.

4-1-2. Acquisition of Device Data by Correlation Analysis System after Device Installation

After the device 172 is installed, the correlation analysis system 101 acquires device data 182 output by the device 172 at any time. As has already been explained, for the acquisition of device data 182 by the correlation analysis system 101, there can be a technique using the data collection system 305 and a technique not using the data collection system 305. The following explains the respective techniques. Note that which of the two techniques described above is adopted may be selected for each of devices 172. (If device data 182 is acquired from all devices 172 by the technique not using the data collection system 305, the data collection system 305 may no longer be required.)

### 4-1-2-1. Acquisition of Device Data Using Data Collection System

In a case where device data 182 is acquired using the data collection system 305, a device 172 and the data collecting section 354, which is a functional section of the data collection system 305, work together to store device data 182 output from the device 172 at any time on the collected information database 355 (collected information DB) retained by the data collection system 305. At this time, the data collecting section 354 may perform control using information retained in the device management information buffer 358.

Any technique may be used as a technique to collect device data 182 in the collected information database 355 (collected information DB). For example, a technique in which device data 182 output from a device 172 by a push scheme is received by the data collecting section 354, and the data collecting section 354 stores the device data 182 in the collected information database 355 (collected information DB) may be adopted. Alternatively, a technique in which the data collecting section 354 requests device data 182 from a device 172, device data 182 output from the device 172 by a pull scheme is received by the data collecting section 354, and the data collecting section 354 stores the device data 182 in the collected information database 355 (collected information DB) may be adopted.

The data requesting section 313, which is a functional section of the correlation analysis system 101, requests device data 182 from the data collection system 305 at any time. At this time, the data requesting section 313 may perform control using information retained in the device management information buffer 318.

A request for device data 182 from the data requesting section 313 is received by the data responding section 353, which is a functional section of the data collection system 305. The data responding section 353 takes out the requested device data 182 from the collected information database 355 (collected information DB), and responds to (the data requesting section 313 of) the correlation analysis system 101 with the device data 182. At this time, the data responding section 353 may perform control using information retained in the device management information buffer 358.

In a case where a technique to acquire device data 182 using the data collection system 305 like the one above is used, device data 182 output from a device 172 is tentatively accumulated in the collected information database 355 (collected information DB), and then the accumulated device data 182 is provided to the correlation analysis system 101 (or the data use system 304). Accordingly, it can be expected that the instability in the acquisition of device data 182 depending on the types of devices 172 is reduced and that stable acquisition of device data 182 is realized.

### 4-1-2-2. Direct Acquisition of Device Data Not Using Data Collection System

In a case where device data 182 is acquired not using the data collection system 305, a device 172 and the data requesting section 313, which is a functional section of the correlation analysis system 101, work together to directly transfer device data 182 output from the device 172 to the correlation analysis system 101 at any time. At this time, the data requesting section 313 may perform control using information retained in the device management information buffer 318.

Any technique may be used as a technique to acquire (a technique to transfer) device data 182. For example, a technique in which device data 182 output from a device 172 by a push scheme is received by the data requesting section 313 may be adopted. Alternatively, a technique in which the data requesting section 313 requests device data 182 from a device 172, and device data 182 output from the device 172 by a pull scheme is received by the data requesting section 313 may be adopted.

In a case where a technique to acquire device data 182 not using the data collection system 305 like the one above is used, the data collection system 305 is not used when the correlation analysis system 101 (or the data use system 304) acquires device data 182. Accordingly, simplification of the overall process of acquisition of device data 182 can be expected. In addition, in a case where the data collection system 305 is not provided, reduction of the costs of hardware and the like also can be expected.

### 4-2. Functional Configuration, Processes, and Information Involved in Detection or Management of Correlations and Relations (FIG. 5)

This section explains a functional configuration, processes, and information involved when the correlation analysis system 101 detects and manages a correlation 162, a device-group relation 164, or an inter-group relation 165.

With the functional configuration, processes, and information explained below, a correlation 162, a device-group relation 164, or an inter-group relation 165 can be detected or managed using each piece of device data 182 output from each of devices 172. In addition, it becomes possible to grasp a correlation 162, a device-group relation 164, or an inter-group relation 165 appropriately reflecting installation/activation or removal/deactivation of a device 172 at the site, or a situational change at the site (e.g., a worker has moved from a work field of a certain process to a work field of another process). Accordingly, information that makes it possible to appropriately grasp a situational change in the site is provided.

FIG. 5 depicts a functional configuration involved and information to be handled when a correlation 162, a device-group relation 164, or an inter-group relation 165 is detected and managed. Note that not the entire functional configuration and information depicted in FIG. 5 are essential. In addition, the existence of a functional configuration and information other than the functional configuration depicted in FIG. 5 is not precluded. Note that, in expressions of flows of information in FIG. 5, portions with the symbol (c) are connected with each other, portions with the symbol (r) are connected with each other, portions with the symbol (cn) are connected with each other, portions with the symbol (rn) are connected with each other, portions with the symbol (gn) are connected with each other, portions with the symbol (q) are connected with each other, portions with the symbol (p) are connected with each other, and portions with the symbol (#) are connected with each other.

### 4-2-1. Summaries of Functional Configuration Involved in Detection or Management of Correlations and Relations

Before details of processes performed by individual functional sections included in the correlation analysis system 101 are explained in “4-2-3. Processes Involved in Detection or Management of Correlations and Relations,” here, a summary of the individual functional sections included in the correlation analysis system 101 is given.

### 4-2-1-1. Summary of Data Requesting Section

The correlation analysis system 101 has the data requesting section 313 as a functional section. Most of the functions of the data requesting section 313 have already been explained with reference to FIG. 4. The data requesting section 313 stores, in a collected information buffer 315 retained by the correlation analysis system 101, device data 182 acquired from a device 172 or the data collection system 305.

### 4-2-1-2. Summary of Data Processing Section

The correlation analysis system 101 may have a data processing section 316 as a functional section. The data processing section 316 may generate information (data) in a format which can easily be handled by the correlation event sensing section 1900 by processing device data 182 retained in the collected information buffer 315.

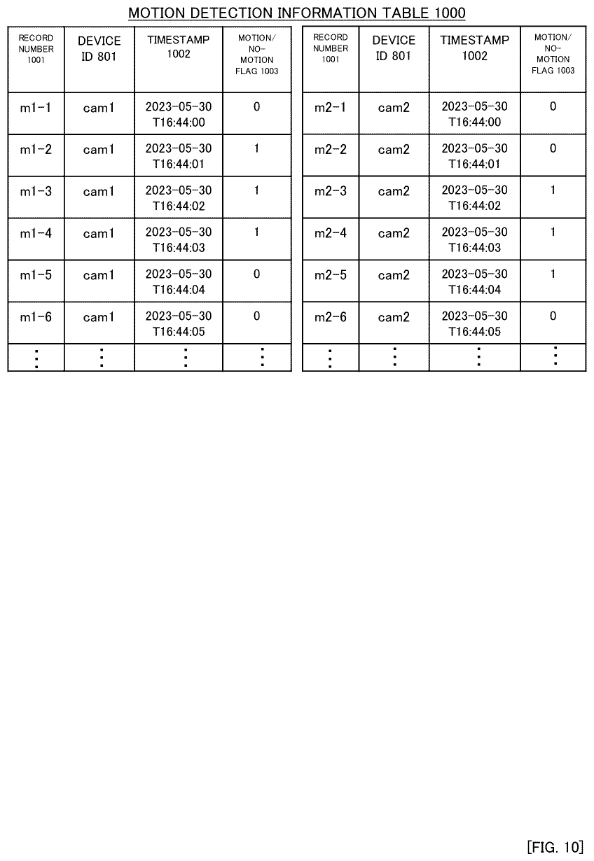

For example, device data 182 acquired by cameras such as the camera 1 (cam1), the camera 2 (cam2), and the camera (cam3) depicted in FIG. 8 in device data 182 retained in the collected information buffer 315 is image data (or moving image data) itself. Here, there can be a case where image data (or moving image data) is hard to be handled by the correlation event sensing section 1900 if the image data (or the moving image data) remains unchanged in the form thereof. In such a case, the data processing section 316 may detect, in image data (or moving image data) which is device data 182 and on a screen, a time (or a time period) when a motion with magnitude which is equal to or greater than a certain threshold (or is greater than the certain threshold) is detected or a time (or a time period) when a motion with magnitude which is equal to or greater than a certain threshold (or is greater than the certain threshold) is not detected, and generate a motion/no-motion flag 1003 of each time (or each time period). The motion/no-motion flags 1003 may be stored in a motion detection information table 1000 in FIG. 10.

The data processing section 316 may generate information (data) in a format which can be easily handled by the correlation event sensing section 1900 by processing also device data 182 output from devices 172 other than cameras.

For example, in a case where device data 182 output from devices 172 such as the acceleration sensor 1 (acc1), the velocity sensor 1 (velo1), the wearable terminal 1 (wear1), the acceleration sensor 2 (acc2), and the wearable terminal 2 (wear2) depicted in FIG. 8 is time series information with values of components of accelerations or velocities at three-dimensional coordinates (X,Y,Z), the data processing section 316 may generate a motion/no-motion flag 1003 representing whether or not the magnitude of an acceleration or the magnitude of a velocity at each time (or in each time period) is equal to or greater than a certain threshold (or is greater than the certain threshold). The motion/no-motion flags 1003 may be stored in a table similar to the motion detection information table 1000.

For example, in a case where device data 182 output from devices 172 such as the programmable logic controller 1 (PLC1) and the programmable logic controller 2 (PLC2) depicted in FIG. 8 is time series information representing operation modes of the conveyor belt, the data processing section 316 may generate a motion/no-motion flag 1003 representing whether or not the conveyor belt is moving at each time (or in each time period) on the basis of an operation mode. The motion/no-motion flags 1003 may be stored in a table similar to the motion detection information table 1000.

For example, in a case where device data 182 output from the router 1 (or the switch 1) (snmp1) and the router 2 (snmp2) depicted in FIG. 8 is time series information representing the number of packets or the amount of communication transmitted and received between robots/pieces of equipment/devices for corresponding processes, the data processing section 316 may generate a motion/no-motion flag 1003 representing whether or not the number of packets or the amount of communication at each time (or in each time period) is equal to or greater than a certain threshold (or is greater than the certain threshold). The motion/no-motion flags 1003 may be stored in a table similar to the motion detection information table 1000.

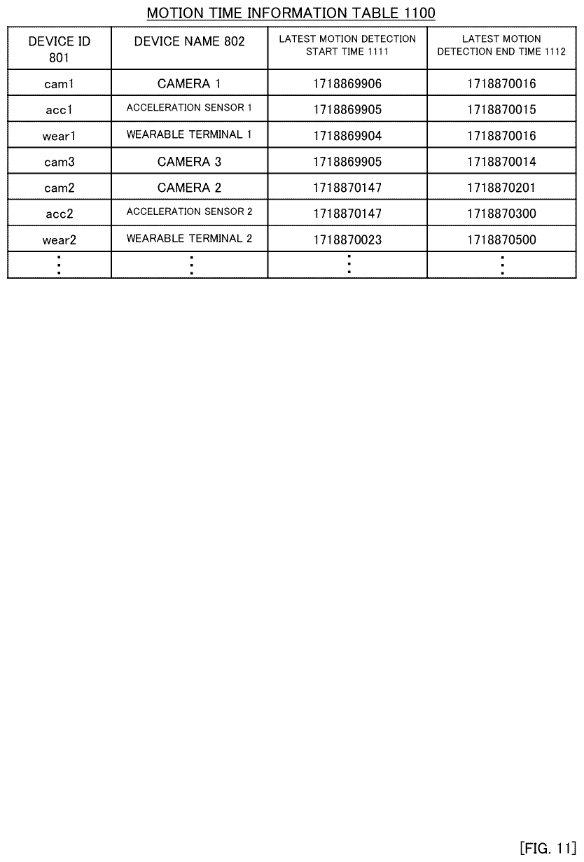

The data processing section 316 may further identify, for each of devices 172, the start time (latest motion detection start time 1111) and end time (latest motion detection end time 1112) of the latest time period in which a state where there is a motion has been detected, on the basis of a motion/no-motion flag 1003 of each time (or each time period) (time series information of motion/no-motion flags 1003). Then, the data processing section 316 may store, in a motion time information table 1100 depicted in FIG. 11, the identified latest motion detection start time 1111 and latest motion detection end time 1112.

The techniques of data processing by the data processing section 316 explained in the description above are merely examples. The data processing section 316 may use any processing techniques other than the processing techniques explained in the description above.

Since the correlation analysis system 101 includes the data processing section 316, it becomes possible for the correlation analysis system 101 to handle device data 182 output from devices 172 even if there is a certain range of data formats of the device data 182.

### 4-2-1-3. Summary of Correlation Event Sensing Section

A summary of the correlation event sensing section 1900, which is a functional section of the correlation analysis system 101, has already been explained with reference to FIG. 1. Note that information that the correlation event sensing section 1900 refers to for sensing a high correlation event or a low correlation event between devices 172 may be some or all of device data 182 itself stored in the collected information buffer 315, information obtained by the data processing section 316 processing device data 182, information stored in the motion detection information table 1000, and information stored in the motion time information table 1100.

As explained later specifically, the correlation event sensing section 1900 may be controlled on the basis of a “correlation event sensing period (k)” depicted in FIG. 29 in parameters 399.

When a high correlation event of a particular combination of devices 172 is sensed by the correlation event sensing section 1900, the sensing is recognized by the high correlation event processing section 2000. Note that, as has already been depicted, a high correlation event is an event that leads to a presumption that a correlation 162 between devices 172 exists. Any technique (e.g., interrupt, memory mediation, etc.) may be adopted as a technique by which the correlation event sensing section 1900 informs the high correlation event processing section 2000 of the sensing of a high correlation event.

When a low correlation event of a particular combination of devices 172 is sensed by the correlation event sensing section 1900, the sensing is recognized by the low correlation event processing section 2400. Note that, as has already been depicted, a low correlation event is an event that leads to a presumption that a correlation 162 between devices 172 does not exist. Any technique (e.g., interrupt, memory mediation, etc.) may be adopted as a technique by which the correlation event sensing section 1900 informs the low correlation event processing section 2400 of the sensing of a low correlation event.

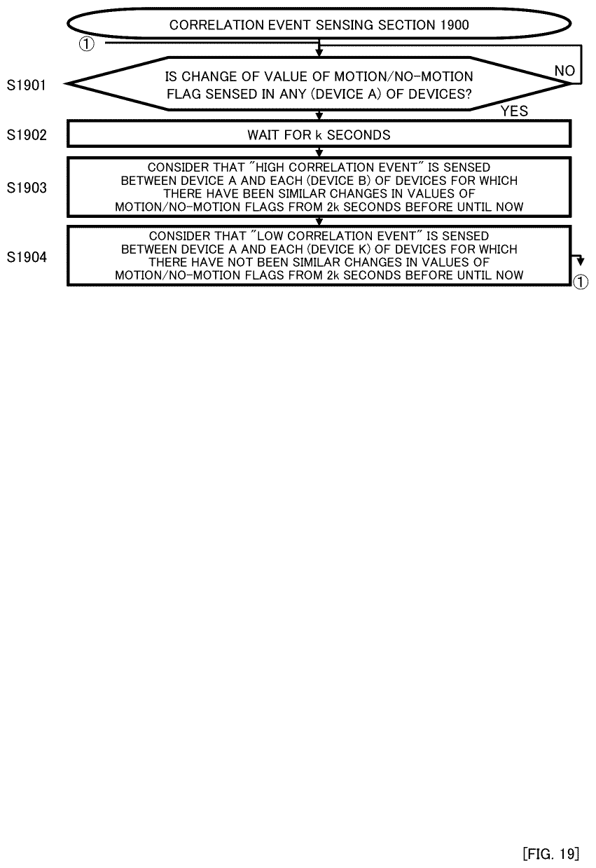

Details of a process performed by the correlation event sensing section 1900 are explained later with reference to FIG. 19.

### 4-2-1-4. Summary of High Correlation Event Processing Section

The high correlation event processing section 2000, which is a functional section of the correlation analysis system 101, is configured to realize some functions of the correlation event processing section 120 depicted in FIG. 1.

When a high correlation event between devices 172 is sensed by the correlation event sensing section 1900, the high correlation event processing section 2000 adjusts a correlation strength value 1202 which represents the strength of the correlation 162 between the devices 172. In this adjustment, the correlation strength value 1202 is often adjusted in a direction to increase the strength of the correlation 162. The high correlation event processing section 2000 causes the adjusted correlation strength value 1202 to be reflected in a correlation information record which is a record in the correlation information table 1200, and is for the combination of the devices 172 between which the high correlation event is sensed.

In addition, the high correlation event processing section 2000 determines whether a derivation from the correlation 162 between the devices 172 to a relation (a device-group relation 164 or an inter-group relation 165) newly appears as a result of the adjustment of the correlation strength value 1202 of the correlation between the devices 172. When the high correlation event processing section 2000 determines that a derivation newly appears, the high correlation event processing section 2000 may cause information (e.g., a derivation flag 1203 which is turned on (ON)) representing that a derivation has appeared to be reflected in the correlation information record which is a record in the correlation information table 1200, and is for the combination of the devices 172 between which the high correlation event is sensed. When the high correlation event processing section 2000 determines that a derivation newly appears, the high correlation event processing section 2000 may directly inform the derivation appearance event processing section 2100 of the appearance of a derivation.

As explained later specifically, the high correlation event processing section 2000 may be controlled on the basis of a “correlation strength increase/reduction amount (t3)” and a “derivation appearance threshold (t1)” depicted in FIG. 29 in the parameters 399. In addition, as explained later specifically, the high correlation event processing section 2000 may perform processes while referring to the derivation prohibition information table 1600.

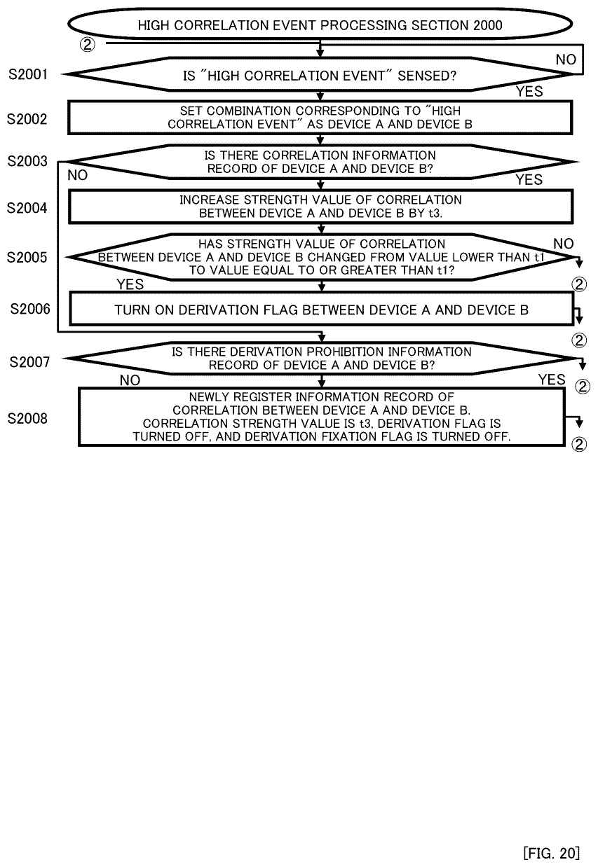

Details of a process performed by the high correlation event processing section 2000 are explained later with reference to FIG. 20.

### 4-2-1-5. Summary of Derivation Appearance Event Processing Section

The derivation appearance event processing section 2100, which is a functional section of the correlation analysis system 101, is configured to realize some functions of the derivation appearance/disappearance event processing section 121 depicted in FIG. 1.

When it is determined by the high correlation event processing section 2000 that a derivation has newly appeared, the derivation appearance event processing section 2100 identifies a device-group relation 164 (relation settings candidate) and an inter-group relation 165 (relation settings candidate) that may newly appear, accompanying the derivation that has newly appeared. The derivation appearance event processing section 2100 identifies a combination of a device 172 and a group 175 corresponding to a device-group relation 164 that may newly appear, and a combination of groups 175 corresponding to an inter-group relation 165 that may newly appear.

In order to perform the identification described above, the derivation appearance event processing section 2100 may refer to the correlation information table 1200 and the device-group relation information table 1400 as appropriate.

The derivation appearance event processing section 2100 may inform the device-group relation information derivation appearance instance updating section 2200 of information identifying the combination (relation settings candidate) of a device 172 and a group 175 corresponding to the device-group relation 164 that may newly appear, and then request the device-group relation information derivation appearance instance updating section 2200 to perform a process of updating information regarding the existence or inexistence or the like of the device-group relation 164. In addition, the derivation appearance event processing section 2100 may inform the inter-group relation information derivation appearance instance updating section 2300 of information identifying the combination of groups 175 corresponding to the inter-group relation 165 (relation settings candidate) that may newly appear, and then request the inter-group relation information derivation appearance instance updating section 2300 to perform a process of updating information regarding the existence or inexistence or the like of the inter-group relation 165.

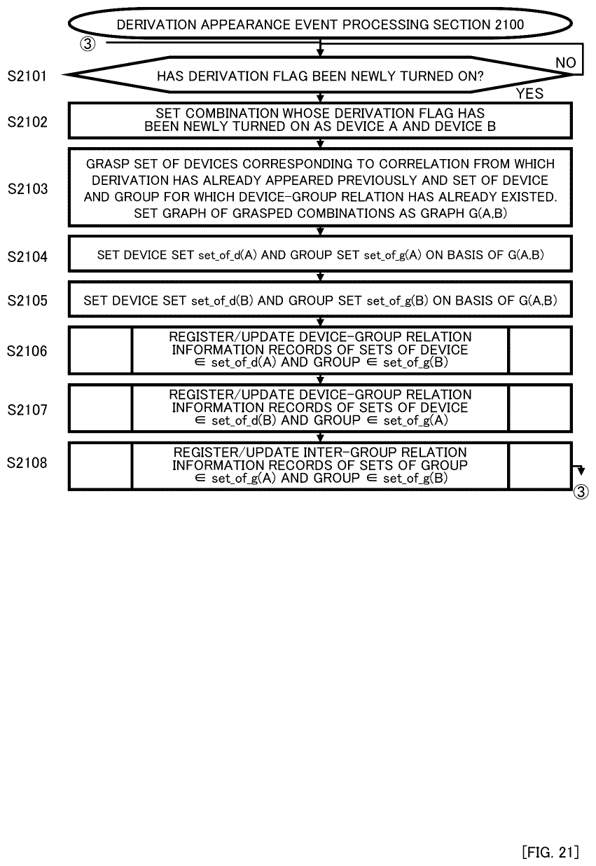

Details of a process performed by the derivation appearance event processing section 2100 are explained later with reference to FIG. 21.

### 4-2-1-6. Summary of Device-Group Relation Information Derivation Appearance Instance Updating Section

The device-group relation information derivation appearance instance updating section 2200, which is a functional section of the correlation analysis system 101, is configured to realize some functions of the derivation appearance/disappearance event processing section 121 depicted in FIG. 1.

In response to a request from the derivation appearance event processing section 2100, the device-group relation information derivation appearance instance updating section 2200 determines a change related to a device-group relation 164 accompanying the new appearance of a derivation. The device-group relation information derivation appearance instance updating section 2200 causes the determined change related to a device-group relation 164 to be reflected in the device-group relation information table 1400. In a case where, at this time, a device-group relation 164 newly appears, accompanying the new appearance of a derivation, the device-group relation information derivation appearance instance updating section 2200 newly registers, in the device-group relation information table 1400, a device-group relation information record for the device-group relation 164 that newly appears.

In order to make the determination described above, the device-group relation information derivation appearance instance updating section 2200 may perform a process while referring to the device-group relation information table 1400 and the device-group relation prohibition information table 1700.

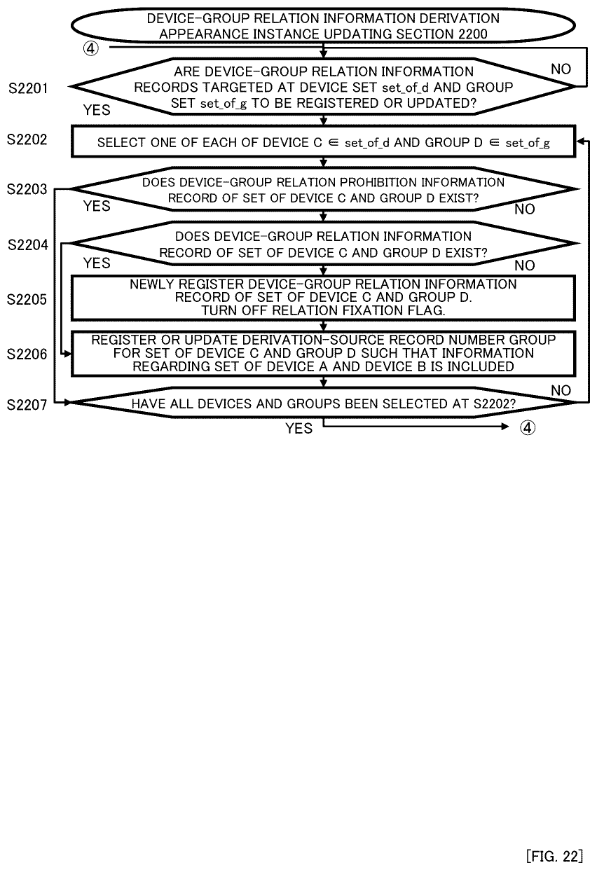

Details of a process performed by the device-group relation information derivation appearance instance updating section 2200 are explained later with reference to FIG. 22.

### 4-2-1-7. Summary of Inter-Group Relation Information Derivation Appearance Instance Updating Section

The inter-group relation information derivation appearance instance updating section 2300, which is a functional section of the correlation analysis system 101, is configured to realize some functions of the derivation appearance/disappearance event processing section 121 depicted in FIG. 1.

In response to a request from the derivation appearance event processing section 2100, the inter-group relation information derivation appearance instance updating section 2300 determines a change related to an inter-group relation 165, accompanying the new appearance of a derivation. The inter-group relation information derivation appearance instance updating section 2300 causes the determined change related to an inter-group relation 165 to be reflected in the inter-group relation information table 1500. In a case where, at this time, an inter-group relation 165 newly appears, accompanying the new appearance of a derivation, the inter-group relation information derivation appearance instance updating section 2300 newly registers, in the inter-group relation information table 1500, an inter-group relation information record for the inter-group relation 165 that newly appears.

In order to make the determination described above, the inter-group relation information derivation appearance instance updating section 2300 may perform a process while referring to the inter-group relation information table 1500, the inter-group relation prohibition information table 1800, and the group management information table 900.

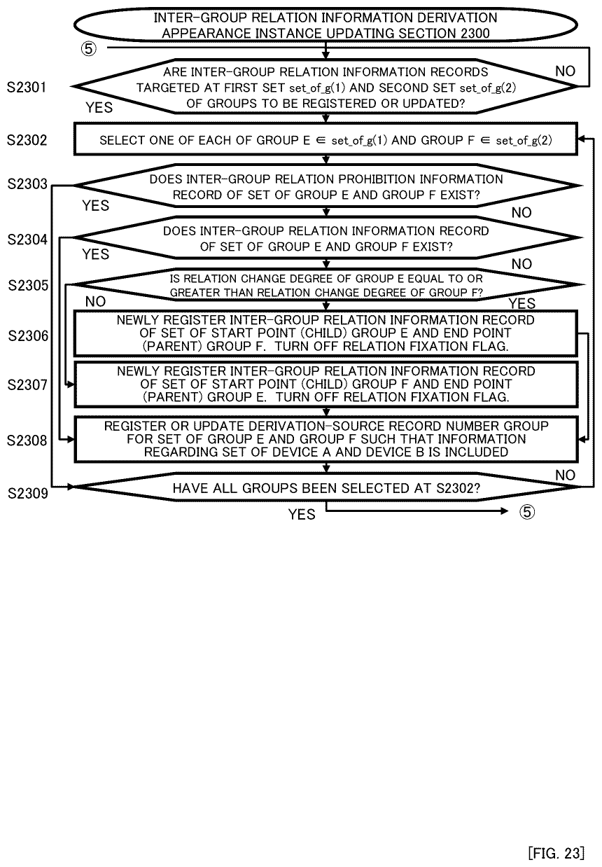

Details of a process performed by the inter-group relation information derivation appearance instance updating section 2300 are explained later with reference to FIG. 23.

### 4-2-1-8. Summary of Low Correlation Event Processing Section

The low correlation event processing section 2400, which is a functional section of the correlation analysis system 101, is configured to realize some functions of the correlation event processing section 120 depicted in FIG. 1.

When a low correlation event between devices 172 is sensed by the correlation event sensing section 1900, the low correlation event processing section 2400 adjusts a correlation strength value 1202 which represents the strength of the correlation 162 between the devices 172. In this adjustment, the correlation strength value 1202 is often adjusted in a direction to reduce the strength of the correlation 162. The low correlation event processing section 2400 causes the adjusted correlation strength value 1202 to be reflected in a correlation information record which is a record in the correlation information table 1200, and is for the combination of the devices 172 between which the low correlation event is sensed.

In addition, the low correlation event processing section 2400 determines whether a derivation (having existed until then) from the correlation 162 between the devices 172 to a relation (a device-group relation 164 or an inter-group relation 165) disappears as a result of the adjustment of the correlation strength value 1202 of the correlation between the devices 172. When the low correlation event processing section 2400 determines that a derivation (having existed until then) disappears, the low correlation event processing section 2400 may cause information (e.g., a derivation flag 1203 which is turned off (OFF)) representing that a derivation (having existed until then) has disappeared to be reflected in the correlation information record which is a record in the correlation information table 1200 and is for the combination of the devices 172 between which the low correlation event is sensed. When the low correlation event processing section 2400 determines that a derivation (having existed until then) disappears, the low correlation event processing section 2400 may directly inform the derivation disappearance event processing section 2500 of the disappearance of a derivation.

As explained later specifically, the low correlation event processing section 2400 may be controlled on the basis of the “correlation strength increase/reduction amount (t3)” and the “derivation disappearance threshold (t2)” depicted in FIG. 29 in the parameters 399.

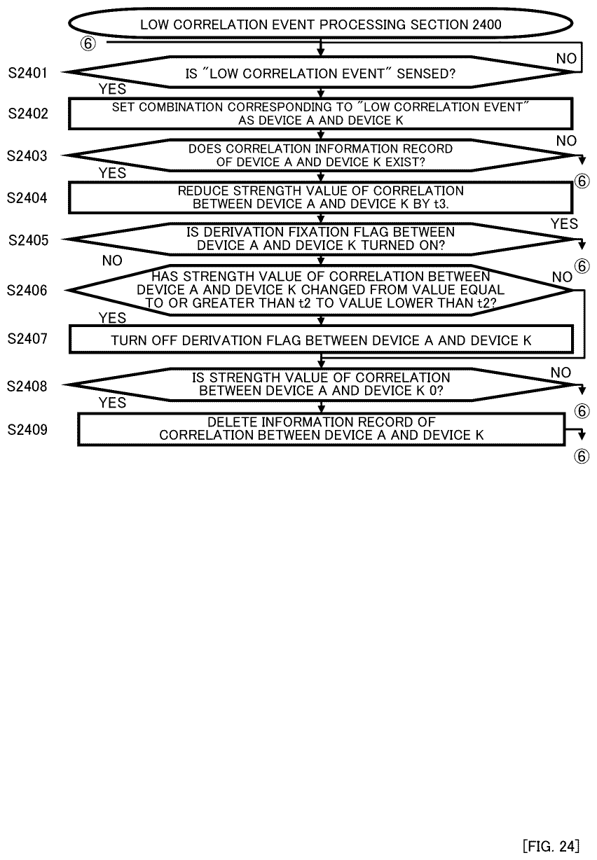

Details of a process performed by the low correlation event processing section 2400 are explained later with reference to FIG. 24.

### 4-2-1-9. Summary of Derivation Disappearance Event Processing Section

The derivation disappearance event processing section 2500, which is a functional section of the correlation analysis system 101, is configured to realize some functions of the derivation appearance/disappearance event processing section 121 depicted in FIG. 1.

When it is determined by the low correlation event processing section 2400 that a derivation (having existed until then) has disappeared, the derivation disappearance event processing section 2500 identifies a device-group relation 164 (relation settings cancellation candidate) and an inter-group relation 165 (relation settings cancellation candidate) that may disappear, accompanying the disappearance of the derivation. The derivation disappearance event processing section 2500 identifies a combination of a device 172 and a group 175 corresponding to a device-group relation 164 that may disappear, and a combination of groups 175 corresponding to an inter-group relation 165 that may disappear.

In order to perform the identification described above, the derivation disappearance event processing section 2500 may refer to the correlation information table 1200 and the device-group relation information table 1400 as appropriate.

The derivation disappearance event processing section 2500 may inform the device-group relation information derivation disappearance instance updating section 2600 of information identifying the combination (relation settings cancellation candidate) of a device 172 and a group 175 corresponding to the device-group relation 164 that may disappear, and then request the device-group relation information derivation disappearance instance updating section 2600 to perform a process of updating information regarding the existence or inexistence or the like of the device-group relation 164. In addition, the derivation disappearance event processing section 2500 may inform the inter-group relation information derivation disappearance instance updating section 2700 of information identifying the combination (relation settings cancellation candidate) of groups 175 corresponding to the inter-group relation 165 that may disappear, and then request the inter-group relation information derivation disappearance instance updating section 2700 to perform a process of updating information regarding the existence or inexistence or the like of the inter-group relation 165.

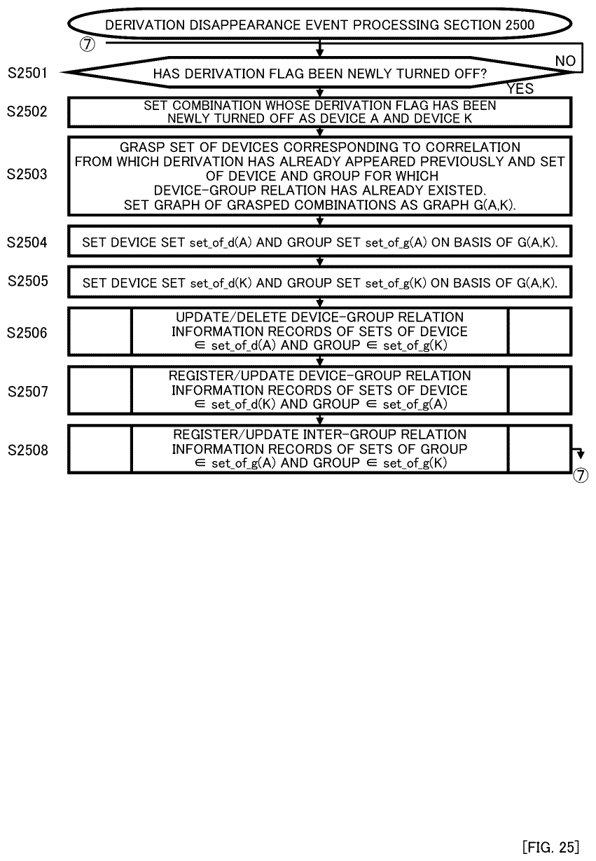

Details of a process performed by the derivation disappearance event processing section 2500 are explained later with reference to FIG. 25.

### 4-2-1-10. Summary of Device-Group Relation Information Derivation Disappearance Instance Updating Section

The device-group relation information derivation disappearance instance updating section 2600, which is a functional section of the correlation analysis system 101, is configured to realize some functions of the derivation appearance/disappearance event processing section 121 depicted in FIG. 1.

In response to a request from the derivation disappearance event processing section 2500, the device-group relation information derivation disappearance instance updating section 2600 determines a change related to a device-group relation 164, accompanying the disappearance of a derivation (having existed until then). The device-group relation information derivation disappearance instance updating section 2600 causes the determined change related to a device-group relation 164 to be reflected in the device-group relation information table 1400. In a case where, at this time, a device-group relation 164 disappears accompanying the disappearance of a derivation (having existed until then), the device-group relation information derivation disappearance instance updating section 2600 deletes, from the device-group relation information table 1400, a device-group relation information record for the device-group relation 164 that disappears.

In order to make the determination described above, the device-group relation information derivation disappearance instance updating section 2600 may perform a process while referring to the device-group relation information table 1400.

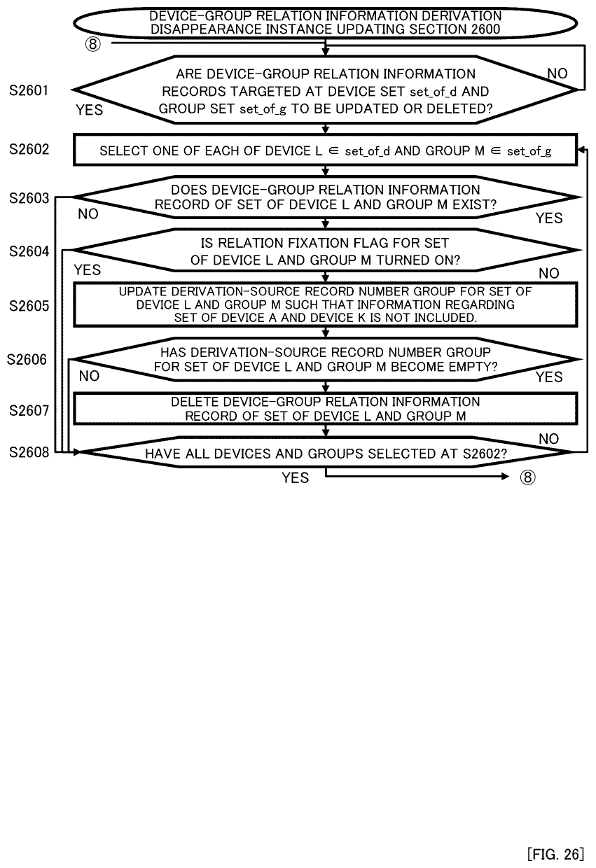

Details of a process performed by the device-group relation information derivation disappearance instance updating section 2600 are explained later with reference to FIG. 26.

### 4-2-1-11. Summary of Inter-Group Relation Information Derivation Disappearance Instance Updating Section

The inter-group relation information derivation disappearance instance updating section 2700, which is a functional section of the correlation analysis system 101, is configured to realize some functions of the derivation appearance/disappearance event processing section 121 depicted in FIG. 1.

In response to a request from the derivation disappearance event processing section 2500, the inter-group relation information derivation disappearance instance updating section 2700 determines a change related to an inter-group relation 165, accompanying the disappearance of a derivation (having existed until then). The inter-group relation information derivation disappearance instance updating section 2700 causes the determined change related to an inter-group relation 165 to be reflected in the inter-group relation information table 1500. In a case where, at this time, an inter-group relation 165 disappears accompanying the disappearance of a derivation (having existed until then), the inter-group relation information derivation disappearance instance updating section 2700 deletes, from the inter-group relation information table 1500, an inter-group relation information record for the inter-group relation 165 that disappears.

In order to make the determination described above, the inter-group relation information derivation disappearance instance updating section 2700 may perform a process while referring to the inter-group relation information table 1500.

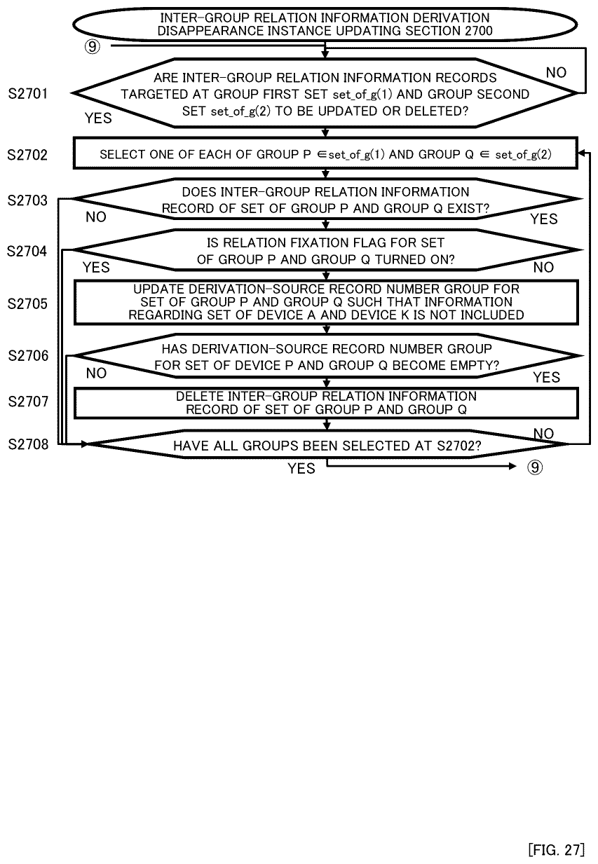

Details of a process performed by the inter-group relation information derivation disappearance instance updating section 2700 are explained later with reference to FIG. 27.

### 4-2-1-12. Summary of Fixation Setting Section

The fixation setting section 378, which is a functional section of the correlation analysis system 101, performs control as to whether to or not to adopt fixation of information that is handled by the correlation analysis system 101 and that is regarding some state retained by the meta information management system 302. The “some state” here may be one or more from the appearance of a derivation from a correlation 162 between devices 172 to a relation (a device-group relation 164 or an inter-group relation 165), the existence of a device-group relation 164 between a device 172 and a group 175, and the existence of an inter-group relation 165 between groups 175.

Note that the fixation setting section 388 having functions similar to those of the fixation setting section 378 may be provided to the meta information management system 302. Moreover, a fixation setting section having functions similar to those of the fixation setting section 378 may be provided to the development environment system 303 or the data use system 304 depicted in FIG. 3.

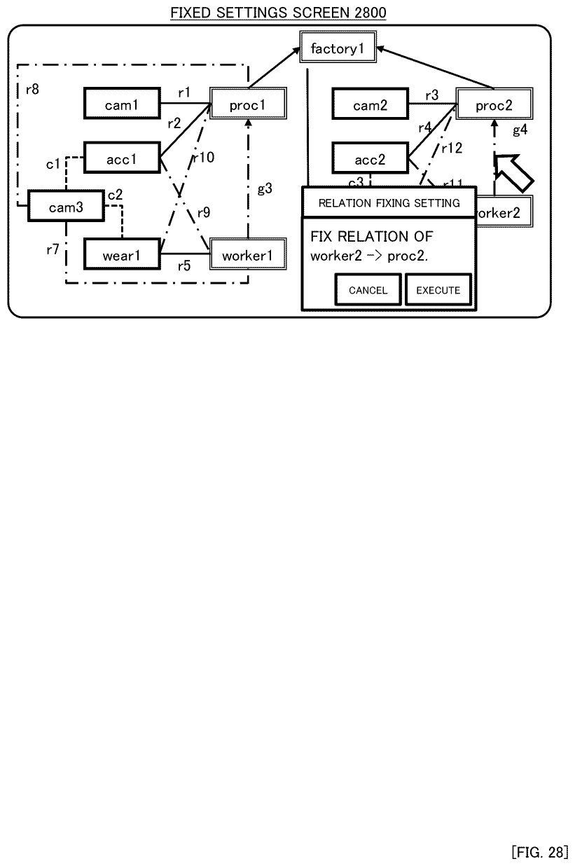

Details of a process performed by the fixation setting section 378 are explained later with reference to FIG. 28.

### 4-2-1-13. Summary of Parameter Setting Section

A parameter setting section 319, which is a functional section of the correlation analysis system 101, sets the parameters 399 on the basis of input information input to the correlation analysis system 101. The parameters 399 may include the “derivation appearance threshold (t1),” the “derivation disappearance threshold (t2),” the “correlation strength increase/reduction amount (t3),” and the “correlation event sensing period (k)” depicted in FIG. 29. The parameters 399 may include those other than the ones described above also.

Note that a parameter setting section 329 having functions similar to those of the parameter setting section 319 may be provided to the meta information management system 302. Moreover, a parameter setting section having functions similar to those of the parameter setting section 319 may be provided to the development environment system 303 or the data use system 304.

Details of a process performed by the parameter setting section 319 are explained later with reference to FIG. 29.

### 4-2-2. Summary of Information Involved in Detection or Management of Correlations and Relations

When details of processes performed by individual functional sections included in the correlation analysis system 101 are explained in “4-2-3. Processes Involved in Detection or Management of Correlations and Relations,” how information to be used in the processes is actually used also is explained. Before that, here, a summary of information (most of which is information retained by the meta information management system 302) used by the correlation analysis system 101 is given.

Note that the device management information table 800 which is included in information retained by the meta information management system 302 and is depicted in FIG. 8 has already been explained.

The whole of or part of information retained by the meta information management system 302 may form a knowledge database, a device catalog, or a data catalog.

### 4-2-2-1. Summary of Group Management Information Table

FIG. 9 depicts the group management information table 900 retained by the meta information management system 302. The group management information table 900 may be accessible to the correlation analysis system 101.

Each group management information record which is a record in the group management information table 900 may have fields of a group ID 901, a group name 902, and a relation change degree 903 (or a degree of inclusion 904).

The group ID 901 is identification information regarding a group associated with the group management information record. Group IDs 901 in FIG. 9 conform to those in FIG. 2 and FIG. 3.

The group name 902 is a name of a group associated with the group management information record.

The relation change degree 903 (or the degree of inclusion 904) represents whether the group 175 associated with the group management information record is likely to be relatively superior or relatively subordinate in a hierarchical relation between groups 175. According to definitions in the example depicted in FIG. 9, the lower the value of the relation change degree 903 (or the degree of inclusion 904) associated with a group 175 is, the more likely the group 175 becomes relatively superior in a hierarchical relation between groups 175. In the example depicted in FIG. 9, the value of the relation change degree 903 (or the degree of inclusion 904) of the factory 1 (factory1) is “0,” the values of the relation change degrees 903 (or the degrees of inclusion 904) of the process 1 (proc1) and the process 2 (proc2) are “20,” and the values of the relation change degrees 903 (or the degrees of inclusion 904) of the worker 1 (worker1) and the worker 2 (worker2) are “70.” Accordingly, in hierarchical relations between groups 175, the factory 1 (factory1) is likely to be relatively superior, the process 1 (proc1) and the process 2 (proc2) are likely to be relatively superior next to the factory 1 (factory1), and the worker 1 (worker1) and the worker 2 (worker2) are likely to be relatively subordinate. Note that the term “relation change degree” represents the “likelihood” of a corresponding group 175 being a “trigger of a change in a correlation or a relation.” For example, the worker 1 (worker1) or the worker 2 (worker2) is likely to be a “trigger of a change in a correlation or a relation” by moving by her/himself. In contrast, it can be said that the factory 1 (factory1), the process 1 (proc1), or the process 2 (proc2) itself is unlikely to be a “trigger of a change in a correlation or a relation” (as compared to the worker 1 (worker1) or the worker 2 (worker2)).

Since there are the fields of relation change degrees 903 (or degrees of inclusion 904) associated with groups in group management information records, it is possible to clearly specify which of two groups 175 is made relatively superior when an inter-group relation 165 is caused to exist. Accordingly, a hierarchical relation between groups 175 is constructed promptly and appropriately.

Note that, instead of relation change degrees 903 (or degrees of inclusion 904), other indicators like ones that represent tendencies of positioning within hierarchical relations between groups 175 may be used.

### 4-2-2-2. Summary of Motion Detection Information Table

FIG. 10 depicts the motion detection information table 1000 retained by the correlation analysis system 101.

Whereas FIG. 10 depicts only a table for the camera 1 (cam1) and the camera 2 (cam2), similar tables may be provided for other devices 172 also.

Each motion detection information record which is a record in the motion detection information table 1000 may have information in fields of a record number 1001, a device ID 801, a timestamp 1002, and a motion/no-motion flag 1003.

The device ID 801 is identification information regarding a device associated with the motion detection information record. Device IDs 801 may be the same as those in FIG. 8. Note that, in a case where a motion detection information table 1000 is provided separately for each device ID 801, the fields of device IDs 801 are not required to be in individual motion detection information records.

The timestamp 1002 represents a time (or a time period) associated with the motion detection information record. Whereas timestamps 1002 are written in a format including a date/year and a time in 24-hour format in FIG. 10, timestamps 1002 may be in another format.

The motion/no-motion flag 1003 is a flag representing whether or not a device 172 represented by the device ID 801 in the motion detection information record has shown a motion with magnitude which is equal to or greater than a certain threshold (or is greater than the certain threshold) at the time (or in the time period) represented by the timestamp 1002 in the motion detection information record.

### 4-2-2-3. Summary of Motion Time Information Table

FIG. 11 depicts the motion time information table 1100 retained by the correlation analysis system 101.

Each motion time information record which is a record in the motion time information table 1100 may have information in fields of a device ID 801, a device name 802, a latest motion detection start time 1111, and a latest motion detection end time 1112.

The device ID 801 is identification information regarding a device associated with the motion time information record. Device IDs 801 may be the same as those in FIG. 8.

The device name 802 is a name of the device associated with the motion time information record. Device names 802 may be the same as those in FIG. 8. Note that the fields of device names 802 are not required to be in motion time information records.

The latest motion detection start time 1111 represents the start time of the latest time period in time periods when the device 172 represented by the device ID 801 in the motion time information record has shown a motion with magnitude which is equal to or greater than a certain threshold (or is greater than the certain threshold).

The latest motion detection end time 1112 represents the end time of the latest time period in the time periods when the device 172 represented by the device ID 801 in the motion time information record has shown a motion with magnitude which is equal to or greater than the certain threshold (or is greater than the certain threshold). Note that, in a case where the device 172 represented by the device ID 801 in the motion time information record is currently showing a motion with magnitude which is equal to or greater than the certain threshold (or is greater than the certain threshold) at the latest time, the latest motion detection end time 1112 may be left blank.

Note that latest motion detection start times 1111 and latest motion detection end times 1112 in FIG. 11 are in a format representing the absolute values of elapsed time since a predetermined standard time. However, latest motion detection start times 1111 and latest motion detection end times 1112 may be written by another technique. For example, latest motion detection start times 1111 and latest motion detection end times 1112 may be written in a format including a date/year and a time in 24-hour format as in FIG. 10.

### 4-2-2-4. Summary of Correlation Information Table

FIG. 12 depicts the correlation information table 1200 retained by the meta information management system 302. The correlation information table 1200 may be accessible to the correlation analysis system 101. The correlation information table 1200 in FIG. 12 represents correlation information before the worker 1 (worker1) moves in the example depicted in FIG. 2 and FIG. 3.

Each correlation information record which is a record in the correlation information table 1200 may have information in fields of a record number 1201, a first device ID 801-1, a second device ID 801-2, a correlation strength value 1202, a derivation flag 1203, and a derivation fixation flag 1204.

The record number 1201 is stored in the field of the derivation-source record number group 1403 in a device-group relation information record which is a record in the device-group relation information table 1400 in FIG. 14 or the derivation-source record number group 1403 in an inter-group relation information record which is a record in the inter-group relation information table 1500 in FIG. 15, in some cases. The correlation 162 represented by the correlation information record to which the record number 1201 belongs and a device-group relation 164 represented by a device-group relation information record having stored therein the record number 1201 in the field of the derivation-source record number group 1403 are in a relation of a derivation source and a derivation destination. Similarly, the correlation 162 represented by the correlation information record to which the record number 1201 belongs and an inter-group relation 165 represented by an inter-group relation information record having stored therein the record number 1201 in the field of the derivation-source record number group 1403 are in a relation of a derivation source and a derivation destination.

The first device ID 801-1 and the second device ID 801-2 identify a combination of target devices 172 of the correlation 162 represented by the corresponding correlation information record.

The correlation strength value 1202 represents the strength of the correlation 162 represented by the correlation information record to which the correlation strength value 1202 belongs. For example, the correlation strength value 1202 may also be increased as the strength of the correlation 162 increases. However, this is not the sole example. Depending on the situation of device data 182 output from each of the target devices 172 of the correlation 162, the correlation strength value 1202 can increase or decrease.

The derivation flag 1203 represents whether a derivation has appeared from the correlation 162 represented by the correlation information record to which the derivation flag 1203 belongs to a relation (a device-group relation 164 or an inter-group relation 165). For example, the derivation flag 1203 may be turned on (ON) in a case where a derivation has appeared, and the derivation flag 1203 may be turned off (OFF) in a case where a derivation has not appeared (a derivation has disappeared). Note that, in the present disclosure, for example, whether derivation flags 1203 are turned on (ON) or turned off (OFF) may be represented by any mode of representation such as binary representation or character representation.

The derivation fixation flag 1204 represents whether the derivation flag 1203 in the correlation information record to which the derivation fixation flag 1204 belongs is fixed in a state where the derivation flag 1203 is kept turned on (ON) (the appearance of a derivation is fixed). The derivation fixation flag 1204 is turned on (ON) in a case where the appearance of a derivation is fixed, and the derivation fixation flag 1204 is turned off (OFF) in a case where the appearance of a derivation is not fixed (a case where a derivation may either appear or disappear). Note that the derivation flag 1203 also is turned on (ON) in a case where the derivation fixation flag 1204 is turned on (ON). Even if the correlation strength value 1202 which represents the strength of the correlation 162 represented by the correlation information record in which the derivation fixation flag 1204 is turned on (ON) has lowered, the derivation flag 1203 is inhibited from being turned off (OFF) (a derivation is inhibited from disappearing).

By providing a derivation fixation flag 1204, for example, it is possible to prevent a derivation of a particular combination of devices 172 from inadvertently disappearing for a reason such as low measurement precision of device data 182 while it is known that it is reasonable to cause the derivation to appear from a correlation 162.

FIG. 13 depicts the correlation information table 1300 after the worker 1 (worker1) has moved, representing a case where, in the situation depicted in the upper section in FIG. 2, the worker 1 (worker1) has moved from the work field of the process 1 (proc1) to the work field of the process 2 (proc2), which results in the situation depicted in the lower section in FIG. 2. (FIG. 12 depicts the correlation information table before the worker 1 (worker1) moves.) In FIG. 13, changes from FIG. 12 are surrounded by dotted-line frames.

Due to the change from the situation depicted in the upper section in FIG. 2 to the situation depicted in the lower section in FIG. 2, a derivation from a correlation 162 between the camera 2 (cam2) and the wearable terminal 1 (wear1) appears as denoted with “c4” in the lower section in FIG. 2. Meanwhile, due to the change from the situation depicted in the upper section in FIG. 2 to the situation depicted in the lower section in FIG. 2, a derivation from a correlation 162 between the camera 3 (cam3) and the wearable terminal 1 (wear1) denoted with “c2” in the upper section in FIG. 2 disappears.

The appearance and disappearance of the derivations described above are depicted in FIG. 13 in the following manner.

First, in a correlation information record whose record number 1201 is “c4” in the correlation information table 1300 in FIG. 13, the set of the first device ID 801-1 and the second device ID 801-2 are “cam2” and “wear1,” the correlation strength value 1202 increases sufficiently (becomes “60” in FIG. 13), and the derivation flag 1203 is turned on (ON). This represents that a derivation from the correlation 162 between the camera 2 (cam2) and the wearable terminal 1 (wear1) has appeared.

In contrast, in a correlation information record whose record number 1201 is “c2” in the correlation information table 1300 in FIG. 13, the set of the first device ID 801-1 and the second device ID 801-2 is “cam3” and “wear1,” the correlation strength value 1202 lowers sufficiently (the correlation strength value 1202, which is “70” in FIG. 12, becomes “10” in FIG. 13), and the derivation flag 1203 (having been turned on (ON) in FIG. 12) is turned off (OFF). This represents that a derivation from the correlation 162 between the camera 3 (cam3) and the wearable terminal 1 (wear1) has disappeared.

Note that, whereas there is still the correlation information record whose record number 1201 is “c2” in FIG. 13, the correlation information record whose record number 1201 is “c2” may be deleted in a case where the correlation strength value 1202 has lowered further (e.g., in a case where the correlation strength value 1202 has become zero).

### 4-2-2-5. Summary of Device-Group Relation Information Table

FIG. 14 depicts the device-group relation information table 1400 retained by the meta information management system 302. The device-group relation information table 1400 may be accessible to the correlation analysis system 101.

Each device-group relation information record which is a record in the device-group relation information table 1400 may have information in fields of a record number 1401, a device ID 801, a group ID 901, a relation fixation flag 1402, and a derivation-source record number group 1403.

The record number 1401 is stored in the field of the derivation-source record number group 1403 in another device-group relation information record other than the device-group relation information record to which the record number 1401 belongs or the derivation-source record number group 1403 in an inter-group relation information record which is a record in the inter-group relation information table 1500 in FIG. 15, in some cases. The device-group relation 164 represented by the device-group relation information record to which the record number 1401 belongs and the device-group relation 164 represented by another device-group relation information record having stored therein the record number 1401 in the field of the derivation-source record number group 1403 are in a relation of a “cause in a causal relation” (similar to a derivation source) and a “result in the causal relation” (similar to a derivation destination) between the device-group relations 164. Similarly, the device-group relation 164 represented by the device-group relation information record to which the record number 1401 belongs and the inter-group relation 165 represented by an inter-group relation information record having stored therein the record number 1401 in the field of the derivation-source record number group 1403 are in a relation of a “cause in a causal relation” (similar to a derivation source) and a “result in the causal relation” (similar to a derivation destination) from the device-group relation 164 to the inter-group relation 165.

The device ID 801 and the group ID 901 identify a combination of a target device 172 and group 175 of the device-group relation 164 represented by the corresponding device-group relation information record.

The relation fixation flag 1402 represents whether it is not permitted to delete, from the device-group relation information table 1400, the device-group relation information record to which the relation fixation flag 1402 belongs (whether the device-group relation 164 is fixed). The relation fixation flag 1402 is turned on (ON) in a case where the device-group relation 164 is fixed, and the relation fixation flag 1402 is turned off (OFF) in a case where the device-group relation 164 is not fixed (in a case where the device-group relation information record may be deleted). Even if the derivation-source record number group 1403 in the device-group relation information record whose relation fixation flag 1402 is turned on (ON) is empty, the device-group relation information record is inhibited from being deleted (the device-group relation 164 is inhibited from disappearing).

By providing a relation fixation flag 1402, for example, it is possible to prevent a device-group relation 164 of a particular combination of a device 172 and a group 175 from inadvertently disappearing in a case where, while it is known that it is reasonable to cause the device-group relation 164 to exist, there is a fear that the device-group relation 164 is caused to disappear by an error for a reason such as low measurement precision of device data 182.

As for the example depicted in FIG. 2 and FIG. 3, in a case where it is known in advance that the worker 1 (worker1) necessarily carries the wearable terminal 1 (wear1), it is useful to turn on (ON) the relation fixation flag 1402 about the device-group relation 164 between the wearable terminal 1 (wear1) and the worker 1 (worker1).

Note that a device-group relation 164 represented by a device-group relation record whose relation fixation flag 1402 is turned on (ON) may be called a “fixed-type device-group relation.” In addition, a device-group relation 164 represented by a device-group relation record whose relation fixation flag 1402 is turned off (OFF), and whose basis of existence is the existence of any derivation of a correlation 162 or another device-group relation may be called a “derivation-type device-group relation.”

The derivation-source record number group 1403 stores information identifying a correlation 162 which is a derivation source of the device-group relation 164 represented by the device-group relation record to which the derivation-source record number group 1403 belongs. In addition, the derivation-source record number group 1403 stores information identifying another device-group relation 164 which is a “cause in a causal relation” (similar to a derivation source) of a device-group relation 164 represented by the device-group relation record to which the derivation-source record number group 1403 belongs.

The information identifying a correlation 162 stored in the derivation-source record number group 1403 may be the record number 1201 in a correlation information record representing the correlation 162. The information identifying another device-group relation 164 stored in the derivation-source record number group 1403 may be the record number 1401 in another device-group relation record representing the device-group relation 164.

As for the case depicted in the upper section in FIG. 2, one of bases of the existence of a device-group relation 164 between the camera (cam3) and the worker 1 (worker1) denoted with “r7” is a combination of the appearance of a derivation from the correlation 162 between the camera (cam3) and the wearable terminal 1 (wear1) denoted with “c2” and the existence of a fixed-type device-group relation 164 between the wearable terminal 1 (wear1) and the worker 1 (worker1) denoted with “r5.” In order for the device-group relation information table 1400 to reflect this, in the device-group relation information table 1400, the derivation-source record number group 1403 in the device-group relation information record whose record number 1401 is “r7” includes “c2-r5.” “c2” in “c2-r5” is the record number 1201 in the correlation information record representing the correlation 162 between the camera (cam3) and the wearable terminal 1 (wear1). “r5” in “c2-r5” is the record number 1401 in the device-group relation information record representing the fixed-type device-group relation 164 between the wearable terminal 1 (wear1) and the worker 1 (worker1).

Note that the derivation-source record number group 1403 in the device-group relation information record whose record number 1401 is “r7” includes “c1-r9” in addition to “c2-r5.” “c1-r9” represents a combination of the appearance of a derivation from the correlation 162 between the camera 3 (cam3) and the acceleration sensor 1 (acc1) and the existence of the derivation-type device-group relation 164 between the acceleration sensor 1 (acc1) and the worker 1 (worker1). In this manner, a plurality of bases may be set as bases of the existence of one device-group relation 164.

In FIG. 14, outline arrows are depicted from device-group relation information records whose record numbers 1401 are “r7,” “r9,” and “r10” to device-group relation records whose record numbers 1401 are “r13” and “r14.” This represents that, when the situation depicted in the upper section in FIG. 2 changes to the situation depicted in the lower section in FIG. 2, while the device-group relation information records whose record numbers 1401 are “r7,” “r9,” and “r10” are deleted, the device-group relation records whose record numbers 1401 are “r13” and “r14” are newly registered.

### 4-2-2-6. Summary of Inter-Group Relation Information Table

FIG. 15 depicts the inter-group relation information table 1500 retained by the meta information management system 302. The inter-group relation information table 1500 may be accessible to the correlation analysis system 101.

Each inter-group relation information record which is a record in the inter-group relation information table 1500 may have information in fields of a record number 1501, a start point group ID 901-1 (child group ID), an end point group ID 901-2 (parent group ID), a relation fixation flag 1402, and a derivation-source record number group 1403.

The start point group ID 901-1 (child group ID) and the end point group ID 901-2 (parent group ID) are identification information regarding groups 175 included in a combination of target groups 175 of the inter-group relation 165 represented by the corresponding inter-group relation information record.

Here, the start point group ID 901-1 (child group ID) represents a relatively subordinate group 175 in a hierarchical relation of the groups 175. In contrast, the end point group ID 901-2 (parent group ID) represents a relatively superior group 175 in the hierarchical relation of the groups 175.

The role of the relation fixation flag 1402 in the inter-group relation information record is similar to the role of the relation fixation flag 1402 in a device-group relation information record.

The relation fixation flag 1402 in the inter-group relation information record represents whether it is not permitted to delete, from the inter-group relation information table 1500, the inter-group relation information record to which the relation fixation flag 1402 belongs (whether the inter-group relation 165 is fixed). The relation fixation flag 1402 is turned on (ON) in a case where the inter-group relation 165 is fixed, and the relation fixation flag 1402 is turned off (OFF) in a case where the inter-group relation 165 is not fixed (in a case where the inter-group relation information record may be deleted). Even if the derivation-source record number group 1403 in an inter-group relation information record whose relation fixation flag 1402 is turned on (ON) is empty, the inter-group relation information record is inhibited from being deleted (the inter-group relation 165 is inhibited from disappearing).

By providing a relation fixation flag 1402 in an inter-group relation information record, for example, it is possible to prevent an inter-group relation 165 of a particular combination of groups 175 from inadvertently disappearing in a case where, while it is known that it is reasonable to cause the inter-group relation 165 to exist, there is a fear that the inter-group relation 165 is caused to disappear by an error for a reason such as low measurement precision of device data 182.

As for the example depicted in FIG. 2 and FIG. 3, in a case where it is known in advance that the process 1 (proc1) and the process 2 (proc2) are necessarily under the factory 1 (factory1), it is useful to turn on (ON) the relation fixation flags 1402 for the inter-group relation 165 between the process 1 (proc1) and the factory 1 (factory1) and the inter-group relation 165 between the process 2 (proc2) and the factory 1 (factory1).

Note that an inter-group relation 165 represented by an inter-group relation record whose relation fixation flag 1402 is turned on (ON) may be called a “fixed-type inter-group relation.” In addition, an inter-group relation 165 represented by an inter-group relation record whose relation fixation flag 1402 is turned off (OFF) may be called a “derivation-type inter-group relation.”

The role of the derivation-source record number group 1403 in an inter-group relation information record is similar to the role of the derivation-source record number group 1403 in a device-group relation information record.

The derivation-source record number group 1403 in the inter-group relation information record stores information identifying a correlation 162 which is a derivation source of the inter-group relation 165 represented by the inter-group relation record to which the derivation-source record number group 1403 belongs. In addition, the derivation-source record number group 1403 stores information identifying a device-group relation 164 which is a “cause in a causal relation” (similar to a derivation source) of an inter-group relation 165 represented by the inter-group relation record to which the derivation-source record number group 1403 belongs.

Similarly to the case of the derivation-source record number group 1403 in a device-group relation information record, a plurality of bases may be set as bases of the existence of one inter-group relation 165 also in the derivation-source record number group 1403 in an inter-group relation information record.

In FIG. 15, an outline arrow is depicted from an inter-group relation information record whose record number 1501 is “g3” to an inter-group relation record whose record number 1501 is “g5.” This represents that, when the situation depicted in the upper section in FIG. 2 changes the situation depicted in the lower section in FIG. 2, while the inter-group relation information record whose record number 1501 is “g3” is deleted, the inter-group relation record whose record number 1501 is “g5” is newly registered.

### 4-2-2-7. Summary Of Derivation Prohibition Information Table

FIG. 16 depicts the derivation prohibition information table 1600 retained by the meta information management system 302. The derivation prohibition information table 1600 may be accessible to the correlation analysis system 101.

Each derivation prohibition information record which is a record in the derivation prohibition information table 1600 may have information in fields of a record number 1601, a first device ID 801-1, and a second device ID 801-2.

The first device ID 801-1 and the second device ID 801-2 in the derivation prohibition information record represent a device ID 801 of each of devices 172 having a correlation 162 in a case where the appearance of a derivation from the correlation 162 is prohibited.

For example, in FIG. 16, a derivation prohibition information record whose record number 1601 is “cn2” represents that the appearance of a derivation from a correlation 162 between the camera 1 (cam1) and the camera 2 (cam2) is prohibited.

As depicted in FIG. 2 and FIG. 3, in a case where it is known in advance that the camera 1 (cam1) is configured to capture images of the work field of the process 1 (proc1), the camera 2 (cam2) is configured to capture images of the work field of the process 2 (proc2), and the two work fields are separated by a wall or the like, the derivation prohibition information record whose record number 1601 is “cn2” like the one described above may be registered.

In this manner, by registering a derivation prohibition information record in the derivation prohibition information table 1600, for example, it is possible to prevent a derivation from inadvertently appearing in a case where, while it is known that it is not reasonable to cause a derivation to appear from a correlation 162 of a particular combination of devices 172, there is a fear that the derivation appears by an error for a reason such as low measurement precision of device data 182.

### 4-2-2-8. Summary of Device-Group Relation Prohibition Information Table

FIG. 17 depicts the device-group relation prohibition information table 1700 retained by the meta information management system 302. The device-group relation prohibition information table 1700 may be accessible to the correlation analysis system 101.

Each device-group relation prohibition information record which is a record in the device-group relation prohibition information table 1700 may have information in fields of a record number 1701, a device ID 801, and a group ID 901.

The device ID 801 and the group ID 901 in the device-group relation prohibition information record represent a device ID 801 of a device 172 and a group ID 901 of a group 175 in a case where the existence of a device-group relation 164 between the device 172 and the group 175 is prohibited.

For example, in FIG. 17, a device-group relation prohibition information record whose record number 1701 is “rn3” represents prohibition of the existence of a device-group relation 164 between the camera 2 (cam2) and the process 1 (proc1).

As depicted in FIG. 2 and FIG. 3, in a case where it is known in advance that the camera 2 (cam2) is configured to capture images of the work field of the process 2 (proc2), the camera 2 (cam2) is not configured to capture images of the work field of the process 1 (proc1), and the two work fields are separated by a wall or the like, the derivation prohibition information record whose record number 1701 is “rn3” like the one described above may be registered.

In this manner, by registering a device-group relation prohibition information record in the device-group relation prohibition information table 1700, for example, it is possible to prevent a device-group relation 164 of a particular combination of a device 172 and a group 175 from inadvertently appearing in a case where, while it is known that it is not reasonable to cause the device-group relation 164 to exist, there is a fear that the device-group relation 164 appears by an error for a reason such as low measurement precision of device data 182.

### 4-2-2-9. Summary of Inter-Group Relation Prohibition Information Table

FIG. 18 depicts the inter-group relation prohibition information table 1800 retained by the meta information management system 302. The inter-group relation prohibition information table 1800 may be accessible to the correlation analysis system 101.

Each inter-group relation prohibition information record which is a record in the inter-group relation prohibition information table 1800 may have information in fields of a record number 1801, a first group ID 901-1, and a second group ID 901-2.

The first group ID 901-1 and the second group ID 901-2 in the inter-group relation prohibition information record represent a group ID 901 of each of groups 175 having an inter-group relation 165 in a case where the existence of the inter-group relation 165 is prohibited.

For example, in FIG. 18, an inter-group relation prohibition information record whose record number 1801 is “gn2” represents prohibition of the existence of an inter-group relation 165 between the worker 1 (worker1) and the worker 2 (worker2).

In this manner, by registering an inter-group relation prohibition information record in the inter-group relation prohibition information table 1800, for example, it is possible to prevent an inter-group relation 165 of a particular combination of groups 175 from inadvertently appearing in a case where, while it is known that it is not reasonable to cause the inter-group relation 165 to exist, there is a fear that the inter-group relation 165 appears by an error for a reason such as low measurement precision of device data 182.

### 4-2-3. Processes Involved in Detection or Management of Correlations and Relations

This section explains details of a process performed by each of functional sections that the correlation analysis system 101 has.

### 4-2-3-1. Process Performed by Correlation Event Sensing Section

FIG. 19 depicts a flowchart of a process performed by the correlation event sensing section 1900. The following gives explanation in the processing order depicted in FIG. 19.

Note that each of processing steps in the flowchart in FIG. 19 may be interpreted as forming a “correlation event sensing step.”

Since functions and processes like the ones explained below are realized, it is possible to acquire information for presuming that a correlation 162 between devices 172 exists or does not exist on the basis of each piece of device data 182 output from each of devices 172. In addition, even if the existence or inexistence of a correlation 162 between devices 172 has changed over time, it is possible to acquire also information for presuming the change.

At Step 1901 in FIG. 19, the correlation event sensing section 1900 determines whether a change of the value of a motion/no-motion flag 1003 of any of devices 172 (here, it is assumed that the device is a device A) is sensed. The motion/no-motion flag 1003 mentioned here may be one in the motion detection information table 1000 in FIG. 10. If the determination result of Step 1901 is YES, the control proceeds to Step 1902. If the determination result of Step 1901 is NO, Step 1901 is repeated.

At Step 1902 in FIG. 19, the correlation event sensing section 1900 waits for k seconds. k here is the correlation event sensing period in FIG. 29. k is included in the parameters 399 depicted in FIG. 5.

At Step 1903 in FIG. 19, the correlation event sensing section 1900 identifies each (here, it is assumed that the device is a device B) of devices 172 corresponding to the value of a motion/no-motion flag 1003 that has changed similarly to the change of the value of the motion/no-motion flag 1003 for the device A at Step 1901 from 2k seconds before (as measured from a time point which is the k seconds after as a result of the waiting at Step 1902) until now. That is, when the value of the motion/no-motion flag 1003 of the device A has changed, the correlation event sensing section 1900 identifies the device B whose motion/no-motion flag 1003 has changed similarly in the time period including the k seconds before and after the time at which the motion/no-motion flag 1003 of the device A has changed.

Then, the correlation event sensing section 1900 determines that a “high correlation event” is sensed between the device A and the device B. That is, the correlation event sensing section 1900 determines that an event that leads to a presumption that a correlation between the device A and the device B exists is sensed since there is a certain degree of similarity between the change of the motion/no-motion flag 1003 of the device A and the change of the motion/no-motion flag 1003 of the device B.

At Step 1904 in FIG. 19, the correlation event sensing section 1900 identifies each (here, it is assumed that the device is a device K) of devices 172 corresponding to the value of a motion/no-motion flag 1003 that has not changed similarly to the change of the value of the motion/no-motion flag 1003 for the device A at Step 1901 from 2k seconds before (as measured from the time point which is the k seconds after as a result of the waiting at Step 1902) until now. That is, when the value of the motion/no-motion flag 1003 of the device A has changed, the correlation event sensing section 1900 identifies the device K whose motion/no-motion flag 1003 has not changed similarly in the time period including the k seconds before and after the time at which the motion/no-motion flag 1003 of the device A has changed.

Then, the correlation event sensing section 1900 determines that a “low correlation event” is sensed between the device A and the device K. That is, the correlation event sensing section 1900 determines that an event that leads to a presumption that a correlation between the device A and the device K does not exist is sensed since there is no or weak similarity between the change of the motion/no-motion flag 1003 of the device A and the change of the motion/no-motion flag 1003 of the device K.

After Step 1904 in FIG. 19, the control returns to Step 1901.

Note that the process performed by the correlation event sensing section 1900 depicted in FIG. 19 is an example for sensing a “high correlation event” or a “low correlation event” between devices 172. The correlation event sensing section 1900 may use any technique as long as a “high correlation event” or a “low correlation event” between devices 172 can be sensed. For example, a “high correlation event” or a “low correlation event” between devices 172 may be sensed using a technique to determine the degree of similarity between time series information of each piece of device data 182 output from each of devices 172 (e.g., Dynamic Time Warping (DTW) or a cross correlation function).

### 4-2-3-2. Process Performed by High Correlation Event Processing Section

FIG. 20 depicts a flowchart of a process performed by the high correlation event processing section 2000. The following gives explanation in the processing order depicted in FIG. 20. Note that each of processing steps in the flowchart in FIG. 20 may be interpreted as forming a “high correlation event processing step.” In addition, each of Step 2003, Step 2004, and Step 2008 in the flowchart in FIG. 20, and Step 2403, Step 2404, Step 2408, and Step 2409 in a flowchart in FIG. 24 mentioned later may be interpreted as forming a “correlation strength management step.” Moreover, each of Step 2005, Step 2006, and Step 2007 in the flowchart in FIG. 20, and Step 2405, Step 2406, and Step 2407 in a flowchart in FIG. 24 mentioned later may be interpreted as forming a “derivation appearance/disappearance determination step.”

Since functions and processes like the ones explained below are realized, in response to sensing of an event that leads to a presumption that a correlation 162 between devices 172 exists, a correlation strength value 1202 representing the strength of the correlation 162 between the devices 172 can be adjusted appropriately. In addition, on the basis of the correlation strength value 1202, the appearance of a derivation from the correlation 162 to a relation (a device-group relation 164 or an inter-group relation 165) can be determined appropriately.

At Step 2001 in FIG. 20, the high correlation event processing section 2000 determines whether a “high correlation event” of any combination of devices 172 is sensed. For example, when the correlation event sensing section 1900 senses a “high correlation event” at Step 1903 in FIG. 19, the correlation event sensing section 1900 may notify the high correlation event processing section 2000 that a “high correlation event” is sensed. Any technique may be used for the notification. For example, an interrupt technique, a notification transmission technique using mailbox-type memory mediation, or the like may be used. If the determination result of Step 2001 is YES, the control proceeds to Step 2002. If the determination result of Step 2001 is NO, Step 2001 is repeated.

As depicted in Step 2002 in FIG. 20, hereinbelow, a combination of devices 172 between which a “high correlation event” is sensed is set as the device A and the device B.

At Step 2003 in FIG. 20, the high correlation event processing section 2000 determines whether, as a record in the correlation information table 1200 depicted in FIG. 12, a correlation information record for the combination of the device A and the device B corresponding to the “high correlation event” exists already. If the determination result of Step 2003 is YES, the control proceeds to Step 2004. If the determination result of Step 2003 is NO, the control proceeds to Step 2007.

At Step 2004 in FIG. 20, the high correlation event processing section 2000 increases, by t3, the correlation strength value 1202 in the correlation information record for the combination of the device A and the device B corresponding to the “high correlation event” existing already in the correlation information table 1200. Here, t3 may be the correlation strength increase/reduction amount depicted in FIG. 29. Whereas FIG. 29 depicts an example in which the value of the correlation strength increase/reduction amount t3 is 10, the value of the correlation strength increase/reduction amount t3 may be any value. The correlation strength increase/reduction amount t3 is included in the parameters 399 depicted in FIG. 5. Note that there may be a preset upper limit value of the correlation strength value 1202 when the correlation strength value 1202 is increased at Step 2004. In a case where the correlation strength value 1202 in the correlation information record for the combination of the device A and the device B exceeds the upper limit value if the correlation strength value 1202 is increased by t3, the correlation strength value 1202 may be set to the upper limit value. For example, the upper limit value may be 100, but the upper limit value may be set to any value.

At Step 2005 in FIG. 20, the high correlation event processing section 2000 determines whether the correlation strength value 1202 in the correlation information record for the combination of the device A and the device B corresponding to the “high correlation event” has changed from a value lower than t1 to a value equal to or greater than t1 before and after the process of increasing the correlation strength value 1202 at Step 2004. Here, t1 may be the derivation appearance threshold depicted in FIG. 29. Whereas FIG. 29 depicts an example in which the value of the derivation appearance threshold t1 is 60, the value of the derivation appearance threshold t1 may be any value. It should be noted that it is desirable that the value of the derivation appearance threshold t1 is greater than the derivation disappearance threshold t2 depicted in FIG. 29 considering the stability of control of the appearance and disappearance of a derivation. In a case where the determination result of Step 2005 is YES, the control proceeds to Step 2006. In a case where the determination result of Step 2005 is NO, the control returns to Step 2001, and the high correlation event processing section 2000 waits until the next sensing of a “high correlation event.”

At Step 2006 in FIG. 20, the high correlation event processing section 2000 turns on (ON) the derivation flag 1203 in the correlation information record for the combination of the device A and the device B. That is, since the correlation strength value 1202 corresponding to the combination of the device A and the device B has become equal to or greater than the derivation appearance threshold t1, it is determined that a derivation from the correlation 162 between the device A and the device B to a relation (a device-group relation 164 or an inter-group relation 165) has appeared. Along with the derivation flag 1203 being turned on (ON), the determination result of Step 2101 in FIG. 21 becomes YES.

After Step 2006, the control returns to Step 2001, and the high correlation event processing section 2000 waits until the next sensing of a “high correlation event.”

In the situation where the control proceeds to Step 2007 in FIG. 20, a correlation information record for the combination of the device A and the device B corresponding to the “high correlation event” does not exist in the correlation information table 1200 yet.

At Step 2007 in FIG. 20, the high correlation event processing section 2000 determines whether a derivation prohibition information record for the combination of the device A and the device B corresponding to the “high correlation event” exists in the derivation prohibition information table 1600 in FIG. 16. That is, the high correlation event processing section 2000 checks whether one matching the combination of the device A and the device B exists in combinations of first device IDs 801-1 and second device IDs 801-2 in respective records included in the derivation prohibition information table 1600. In a case where the determination result of Step 2007 is YES, new registration of a correlation information record for the combination of the device A and the device B in the correlation information table 1200 is prohibited. Accordingly, the control returns to Step 2001, and the high correlation event processing section 2000 waits until the next sensing of a “high correlation event.” In a case where the determination result of Step 2007 is NO, the control proceeds to Step 2008.

At Step 2008 in FIG. 20, the high correlation event processing section 2000 newly registers a correlation information record for the combination of the device A and the device B corresponding to the “high correlation event” in the correlation information table 1200. The initial value of the correlation strength value 1202 in the newly-registered correlation information record may be any value, and, for example, may be a value which is the same as the correlation strength increase/reduction amount t3. In addition, the high correlation event processing section 2000 turns off (OFF) both the derivation flag 1203 and the derivation fixation flag 1204 in the newly-registered correlation information record.

After Step 2008, the control returns to Step 2001, and the high correlation event processing section 2000 waits until the next sensing of a “high correlation event.”

4-2-3-3. Process Performed by Derivation Appearance Event Processing Section

FIG. 21 depicts a flowchart of a process performed by the derivation appearance event processing section 2100. The following gives explanation in the processing order depicted in FIG. 21. Note that each of processing steps in the flowchart in FIG. 21 may be interpreted as forming a “derivation appearance event processing step.” In addition, each of processing steps in flowcharts in FIG. 21, FIG. 22 mentioned later, FIG. 23 mentioned later, FIG. 25 mentioned later, FIG. 26 mentioned later, and FIG. 27 mentioned later may be interpreted as forming a “derivation appearance/disappearance event processing step.” Moreover, Step 2103, Step 2104, Step 2105, Step 2106, and Step 2107 in the flowchart in FIG. 21, each of processing steps in the flowchart in FIG. 22, Step 2503, Step 2504, Step 2505, Step 2506, and Step 2507 in the flowchart in FIG. 25, and each of processing steps in the flowchart in FIG. 26 may be interpreted as forming a “device-group relation updating step.” Further, Step 2103, Step 2104, Step 2105, and Step 2108 in the flowchart in FIG. 21, each of processing steps in the flowchart in FIG. 23, Step 2503, Step 2504, Step 2505, and Step 2508 in the flowchart in FIG. 25, and each of processing steps in the flowchart in FIG. 26 may be interpreted as forming an “inter-group relation updating step.”

Since functions and processes like the ones explained below are realized, a combination of a device 172 and a group 175 between which a device-group relation 164 may appear accompanying the new appearance of a derivation can be grasped. In addition, a combination of groups 175 between which an inter-group relation 165 may appear accompanying the new appearance of a derivation can be grasped.

At Step 2101 in FIG. 21, the derivation appearance event processing section 2100 determines whether or not a derivation from a correlation 162 of any of combinations of devices 172 to a relation (a device-group relation 164 or an inter-group relation 165) has newly appeared. For example, when the high correlation event processing section 2000 performs the process at Step 2006 in FIG. 20, the high correlation event processing section 2000 may notify the derivation appearance event processing section 2100 of the new appearance of a derivation from the correlation 162 between the device A and the device B. This notification may be in any mode (e.g., an interrupt format, a notification transmission format using memory mediation). Alternatively, in response to the high correlation event processing section 2000 turning on (ON) the derivation flag 1203 in the correlation information record for the combination of the device A and the device B at Step 2006 in FIG. 20, the derivation appearance event processing section 2100 may sense the derivation flag 1203 that has been newly turned on (ON).

As depicted in Step 2102 in FIG. 21, it is assumed below that a combination of devices 172 corresponding to the correlation 162 from which a derivation has newly appeared is the device A and the device B.

At Step 2203 in FIG. 21, the derivation appearance event processing section 2100 grasps combinations of devices 172 corresponding to correlations 162 from which derivations have appeared already and combinations of devices 172 and groups 175 corresponding to device-group relations 164 that already exist, immediately before the new appearance of the derivation from the correlation 162 between the device A and the device B.

For example, the derivation appearance event processing section 2100 grasps combinations of devices 172 represented by correlation information records whose derivation flags 1203 have already been turned on (ON), other than the correlation information record for the combination of the device A and the device B from which the appearance of the derivation is newly sensed at Step 2101. Specifically, the derivation appearance event processing section 2100 refers to the first device IDs 801-1 and the second device IDs 801-2 in the correlation information records whose derivation flags 1203 have already been turned on (ON).

In addition, for example, the derivation appearance event processing section 2100 grasps combinations of devices 172 and groups 175 represented by device-group relation information records that already exist. Specifically, the derivation appearance event processing section 2100 refers to the device IDs 801 and the group IDs 901 in the device-group relation information records that already exist.

Here, a graph representing the group of the combinations of the devices 172 and the combinations of the devices 172 and the groups 175 that are grasped as described above is written as G(A,B). The graph G(A,B) represents “relations” or “interconnectivities” between devices 172 and groups 175 that are formed by the correlations 162 from which derivations have already appeared and the device-group relations 164 that already exist immediately before the new appearance of the derivation from the correlation 162 between the device A and the device B.

At Step 2104 in FIG. 21, the derivation appearance event processing section 2100 determines a set of devices 172 that can be tracked from the device A on the basis of the graph G(A,B), and sets the set as set_of_d(A). Here, devices 172 that can be tracked from the device A mean devices 172 that are included in the graph G(A,B) and that can be tracked with the device A as the starting point on the basis of the correlations 162 from which derivations have already appeared. In addition, the derivation appearance event processing section 2100 determines a set of groups 175 that can be tracked from the device A on the basis of the graph G(A,B), and sets the set as set_of_g(A). Here, groups 175 that can be tracked from the device A mean groups 175 that are included in the graph G(A,B) and that can be tracked with the device A as the starting point on the basis of the correlations 162 from which derivations have already appeared and the device-group relations 164 that already exist.

At Step 2105 in FIG. 21, the derivation appearance event processing section 2100 determines a set of devices 172 that can be tracked from the device B on the basis of the graph G(A,B), and sets the set as set_of_d(B). In addition, the derivation appearance event processing section 2100 determines a set of groups 175 that can be tracked from the device B on the basis of the graph G(A,B), and sets the set as set_of_g(B).

Here, a device-group relation 164 may newly appear for a combination of each of devices 172 included in set_of_d(A) and each of groups 175 included in set_of_g(B) due to the new appearance of the derivation from the correlation 162 between the device A and the device B. Similarly, a device-group relation 164 may newly appear for a combination of each of devices 172 included in set_of_d(B) and each of groups 175 included in set_of_g(A) due to the new appearance of the derivation from the correlation 162 between the device A and the device B. Moreover, similarly, an inter-group relation 165 may newly appear for a combination of each of groups 175 included in set_of_g(A) and each of groups 175 included in set_of_g(B) due to the new appearance of the derivation from the correlation 162 between the device A and the device B.

Note that there can also be a case where, as a result of the processes at Step 2104 and Step 2105, the set of devices 172 belonging to set_of_d(A) and the set of devices 172 belonging to set_of_d(B) become completely the same, and the set of groups 175 belonging to set_of_g(A) and the set of groups 175 belonging to set_of_d(B) become completely the same. In this case, there are no device-group relations 164 and inter-group relations 165 at all that newly appear due to the new appearance of the derivation from the correlation 162 between the device A and the device B. In this case, derivation-source record number groups in device-group relation information records and inter-group relation records that already exist are merely updated in FIG. 22 and FIG. 23.

At Step 2106 in FIG. 21, if set_of_g(B) is not an empty set regarding groups 175, the derivation appearance event processing section 2100 registers or updates a device-group relation information record of a combination of each of devices 172 included in set_of_d(A) and each of groups 175 included in set_of_g(B). Specifically, the derivation appearance event processing section 2100 causes the device-group relation information derivation appearance instance updating section 2200 to execute a process depicted in FIG. 22. If there is a device-group relation 164 that newly appears as a result of the process in FIG. 22, a device-group relation information record for the device-group relation 164 is registered in the device-group relation information table 1400.

At Step 2107 in FIG. 21, if set_of_g(A) is not an empty set regarding groups 175, the derivation appearance event processing section 2100 registers or updates a device-group relation information record of a combination of each of devices 172 included in set_of_d(B) and each of groups 175 included in set_of_g(A). Specifically, the derivation appearance event processing section 2100 causes the device-group relation information derivation appearance instance updating section 2200 to execute a process depicted in FIG. 22. If there is a device-group relation 164 that newly appears as a result of the process in FIG. 22, a device-group relation information record for the device-group relation 164 is registered in the device-group relation information table 1400.

At Step 2108 in FIG. 21, if neither set_of_g(A) nor set_of_g(B) is an empty set regarding groups 175, the derivation appearance event processing section 2100 registers or updates an inter-group relation information record of a combination of each of groups 175 included in set_of_g(A) and each of groups 175 included in set_of_g(B). Specifically, the derivation appearance event processing section 2100 causes the inter-group relation information derivation appearance instance updating section 2300 to execute a process depicted in FIG. 23. If there is an inter-group relation 165 that newly appears as a result of the process in FIG. 23, an inter-group relation information record for the inter-group relation 165 is registered in the inter-group relation information table 1500.

After Step 2108, the control returns to 2101, and the derivation appearance event processing section 2100 waits until the new appearance of a derivation is sensed.

### 4-2-3-4. Process Performed by Device-Group Relation Information Derivation Appearance Instance Updating Section

FIG. 22 depicts a flowchart of a process performed by the device-group relation information derivation appearance instance updating section 2200. The following gives explanation in the processing order depicted in FIG. 22. Note that each of processing steps in the flowchart in FIG. 22 may be interpreted as forming a “device-group relation derivation appearance instance updating step.”

Since functions and processes like the ones explained below are realized, it is possible to appropriately determine a change in information regarding a device-group relation 164 accompanying the appearance of a derivation, and cause the determined change to be reflected in the device-group relation information table 1400. In addition, in a case where a device-group relation 164 newly appears accompanying the appearance of a derivation, it is possible to cause the new appearance to be reflected in the device-group relation information table 1400.

At Step 2201 in FIG. 22, the device-group relation information derivation appearance instance updating section 2200 determines whether to register or update a device-group relation information record accompanying the new appearance of a derivation from a correlation 162. For example, the derivation appearance event processing section 2100 determines, at Step 2106 in FIG. 21, to register or update a device-group relation information record of a combination of a device 172 included in set_of_d(A) and a group 175 included in set_of_g(B), and the derivation appearance event processing section 2100 gives a notification to that effect to the device-group relation information derivation appearance instance updating section 2200. In addition, for example, the derivation appearance event processing section 2100 determines, at Step 2107 in FIG. 21, to register or update a device-group relation information record of a combination of a device 172 included in set_of_d(B) and a group 175 included in set_of_g(A), and the derivation appearance event processing section 2100 gives a notification to that effect to the device-group relation information derivation appearance instance updating section 2200. In the following explanation given with reference to FIG. 22, the set of devices 172 described above is written as set_of_d, and the set of groups 175 described above is written as set_of_g.

At Step 2202 in FIG. 22, the device-group relation information derivation appearance instance updating section 2200 selects one of devices 172 included in set_of_d, and sets the selected device 172 as a device C. In addition, the device-group relation information derivation appearance instance updating section 2200 selects one of groups 175 included in set_of_g, and sets the selected group 175 as a group D. That is, a combination of the device C and the group D is selected as a candidate (relation settings candidate) from which a device-group relation 164 is to newly appear.

At Step 2203 in FIG. 22, the device-group relation information derivation appearance instance updating section 2200 determines whether a device-group relation prohibition information record for the combination of the device C and the group D selected at the latest Step 2202 exists in the device-group relation prohibition information table 1700 in FIG. 17. If the determination result of Step 2203 is YES, the existence of a device-group relation 164 between the device C and the group D is not permitted. Accordingly, Step 2204, Step 2205, and Step 2206 are skipped, and the control proceeds to Step 2207. If the determination result of Step 2203 is NO, the control proceeds to Step 2204.

At Step 2204 in FIG. 22, the device-group relation information derivation appearance instance updating section 2200 determines whether a device-group relation information record for the combination of the device C and the group D selected at the latest Step 2202 exists in the device-group relation information table 1400 in FIG. 14. If the determination result of Step 2204 is YES, Step 2205 is skipped, and the control proceeds to Step 2206. If the determination result of Step 2204 is NO, the control proceeds to Step 2205.

At Step 2205 in FIG. 22, the device-group relation information derivation appearance instance updating section 2200 newly registers a device-group relation information record for the combination of the device C and the group D selected at the latest Step 2202 in the device-group relation information table 1400 in FIG. 14. In the newly-registered device-group relation information record, the device ID 801 is set to a device ID of the device C, and the group ID 901 is set to a group ID of the group D. In the newly-registered device-group relation information record, the relation fixation flag 1402 is turned off (OFF). After Step 2205, the control proceeds to Step 2206.

At Step 2206 in FIG. 22, the device-group relation information derivation appearance instance updating section 2200 registers or updates the derivation-source record number group 1403 in a device-group relation information record for the combination of the device C and the group D selected at the latest Step 2202. Specifically, the device-group relation information derivation appearance instance updating section 2200 includes, in the derivation-source record number group 1403, information identifying a correlation 162 from which a derivation has newly appeared and which is a derivation source of a device-group relation 164 to newly appear. That is, the device-group relation information derivation appearance instance updating section 2200 includes, in the derivation-source record number group 1403, information representing the combination of the device A and the device B. If the record number 1201 exists in each of correlation information records in the correlation information table 1200 as depicted in FIG. 12 and FIG. 13, at Step 2206, the device-group relation information derivation appearance instance updating section 2200 may include, in the derivation-source record number group 1403, the record number 1201 in the correlation information record for the combination of the device A and the device B.

A case where a derivation appears from the correlation 162 between the camera 2 (cam2) and the wearable terminal 1 (wear1) accompanying the change from the situation depicted in the upper section in FIG. 2 to the situation depicted in the lower section in FIG. 2 is explained. In this case, as represented by changes from the correlation information table 1200 in FIG. 12 to the correlation information table 1300 in FIG. 13, the derivation flag 1203 of the correlation information record for the combination of the camera 2 (cam2) and the wearable terminal 1 (wear1) is turned on (ON). Accompanying this, a device-group relation 164 appears between the camera 2 (cam2) and the worker 1 (worker1). At this time, as depicted in FIG. 14, the device-group relation information derivation appearance instance updating section 2200 registers a device-group relation information record for the combination of the camera 2 (cam2) and the worker 1 (worker1), and then includes, in the derivation-source record number group 1403 in the record, “c4,” which is the record number 1201 in the correlation information record for the combination of the camera 2 (cam2) and the wearable terminal 1 (wear1).

Note that, as is apparent from the lower section in FIG. 2, bases of the existence of the device-group relation 164 between the camera 2 (cam2) and the worker 1 (worker1) are the appearance of a derivation from the correlation 162 between the camera 2 (cam2) and the wearable terminal 1 (wear1) and the fixed-type device-group relation 164 between the wearable terminal 1 (wear1) and the worker 1 (worker1). Accordingly, as represented by the device-group relation information record whose record number 1401 is “r13” in FIG. 14, “c4,” which is the record number 1201 in the correlation information record for the combination of the camera 2 (cam2) and the wearable terminal 1 (wear1), and “r5,” which is the record number 1401 in the device-group relation information record for the combination of the wearable terminal 1 (wear1) and the worker 1 (worker1), are registered in association with each other in the derivation-source record number group 1403 in the device-group relation information record for the combination of the camera 2 (cam2) and the worker 1 (worker1).

After Step 2206, the control proceeds to Step 2207.

At Step 2207 in FIG. 22, the device-group relation information derivation appearance instance updating section 2200 determines whether all possible combinations of a device 172 (device C) included in set_of_d and a group 175 (group D) included in set_of_g have been selected at Step 2202. If the determination result of Step 2207 is YES, the control returns to Step 2201, and the device-group relation information derivation appearance instance updating section 2200 waits until the next opportunity of registration or updating of a device-group relation information record. If the determination result of Step 2207 is NO, the control returns to 2202, and a combination of the device C and the group D that has not been selected yet is newly selected.

### 4-2-3-5. Process Performed by Inter-Group Relation Information Derivation Appearance Instance Updating Section

FIG. 23 depicts a flowchart of a process performed by the inter-group relation information derivation appearance instance updating section 2300. The following gives explanation in the processing order depicted in FIG. 23. Note that each of processing steps in the flowchart in FIG. 23 may be interpreted as forming an “inter-group relation derivation appearance instance updating step.”

Since functions and processes like the ones explained below are realized, it is possible to appropriately determine a change in information regarding an inter-group relation 165 accompanying the appearance of a derivation, and causes the determined change to be reflected in the inter-group relation information table 1500. In addition, in a case where an inter-group relation 165 newly appears accompanying the appearance of a derivation, it is possible to cause the new appearance to be reflected in the inter-group relation information table 1500.

At Step 2301 in FIG. 23, the inter-group relation information derivation appearance instance updating section 2300 determines whether to register or update an inter-group relation information record accompanying the new appearance of a derivation from a correlation 162. For example, the derivation appearance event processing section 2100 determines, at Step 2108 in FIG. 21, to register or update an inter-group relation information record of a combination of a group 175 included in set_of_g(A) and a group 175 included in set_of_g(B), and the derivation appearance event processing section 2100 gives a notification to that effect to the inter-group relation information derivation appearance instance updating section 2300. In the following explanation given with reference to FIG. 23, one set (first set) in the two sets of groups 175 described above is written as set_of_g(1), and the other set (second set) is written as set_of_g(2).

At Step 2302 in FIG. 23, the inter-group relation information derivation appearance instance updating section 2300 selects one of groups 175 included in set_of_g(1), and sets the selected group 175 as a group E. In addition, the inter-group relation information derivation appearance instance updating section 2300 selects one of groups 175 included in set_of_g(2), and sets the selected group 175 as a group F. That is, a combination of the group E and the group F is selected as a candidate (relation settings candidate) from which an inter-group relation 165 is to newly appear.

At Step 2303 in FIG. 23, the inter-group relation information derivation appearance instance updating section 2300 determines whether an inter-group relation prohibition information record for the combination of the group E and the group F selected at the latest Step 2302 exists in the inter-group relation prohibition information table 1800 in FIG. 18. If the determination result of Step 2303 is YES, the existence of an inter-group relation 165 between the group E and the group F is not permitted. Accordingly, Step 2304, Step 2305, Step 2306, Step 2307, and Step 2308 are skipped, and the control proceeds to Step 2309. If the determination result of Step 2303 is NO, the control proceeds to Step 2304.

At Step 2304 in FIG. 23, the inter-group relation information derivation appearance instance updating section 2300 determines whether an inter-group relation information record for the combination of the group E and the group F selected at the latest Step 2302 exists in the inter-group relation information table 1500 in FIG. 15. If the determination result of Step 2304 is YES, Step 2305, Step 2306, and Step 2307 are skipped, and the control proceeds to Step 2308. If the determination result of Step 2304 is NO, the control proceeds to Step 2305.

At Step 2305 in FIG. 23, the inter-group relation information derivation appearance instance updating section 2300 decides which group 175, the group E or the group F selected at the latest Step 2302, is relatively superior in the hierarchical relation of the groups 175. Specifically, by referring to the group management information table 900 in FIG. 9, the inter-group relation information derivation appearance instance updating section 2300 compares the relation change degree 903 (or the degree of inclusion 904) in the group management information record for the group E and the relation change degree 903 (or the degree of inclusion 904) in the group management information record for the group F. The inter-group relation information derivation appearance instance updating section 2300 determines whether the relation change degree 903 (or the degree of inclusion 904) of the group E is equal to or greater than the relation change degree 903 (or the degree of inclusion 904) of the group F. In a case where the determination result of Step 2305 is YES (the group F is handled as a relatively superior one), the control proceeds to Step 2306. In a case where the determination result of Step 2305 is NO (the group E is handled as a relatively superior one), the control proceeds to Step 2307.

At Step 2306 in FIG. 23, the inter-group relation information derivation appearance instance updating section 2300 newly registers, in the inter-group relation information table 1500 in FIG. 15, an inter-group relation record for the combination of the group E, which is relatively subordinate, and the group F, which is relatively superior, in the hierarchical relation of the groups 175. The start point group ID 901-1 (child group ID) in the record is set to a group ID representing the group E, and the end point group ID (parent group ID) in the record is set to a group ID representing the group F. In addition, the relation fixation flag 1402 in the record is turned off (OFF). After Step 2306, the control proceeds to Step 2308.

At Step 2307 in FIG. 23, the inter-group relation information derivation appearance instance updating section 2300 newly registers, in the inter-group relation information table 1500 in FIG. 15, an inter-group relation record for the combination of the group F, which is relatively subordinate, and the group E, which is relatively superior, in the hierarchical relation of the groups 175. The start point group ID 901-1 (child group ID) in the record is set to a group ID representing the group F, and the end point group ID (parent group ID) in the record is set to a group ID representing the group E. In addition, the relation fixation flag 1402 in the record is turned off (OFF). After Step 2307, the control proceeds to Step 2308.

At Step 2308 in FIG. 23, the inter-group relation information derivation appearance instance updating section 2300 registers or updates the derivation-source record number group 1403 in an inter-group relation information record for the combination of the group E and the group F selected at the latest Step 2302. Specifically, the inter-group relation information derivation appearance instance updating section 2300 includes, in the derivation-source record number group 1403, information identifying a correlation 162 from which a derivation has newly appeared, and which is a derivation source of an inter-group relation 165 to newly appear. That is, the inter-group relation information derivation appearance instance updating section 2300 includes, in the derivation-source record number group 1403, information representing the combination of the device A and the device B. If the record number 1201 exists in each of correlation information records in the correlation information table 1200 as depicted in FIG. 12 and FIG. 13, at Step 2308, the inter-group relation information derivation appearance instance updating section 2300 may include, in the derivation-source record number group 1403, the record number 1201 in the correlation information record for the combination of the device A and the device B.

For example, a case where a derivation appears from the correlation 162 between the camera 2 (cam2) and the wearable terminal 1 (wear1) accompanying the change from the situation depicted in the upper section in FIG. 2 to the situation depicted in the lower section in FIG. 2 is explained. In this case, as represented by changes from the correlation information table 1200 in FIG. 12 to the correlation information table 1300 in FIG. 13, the derivation flag 1203 of the correlation information record for the combination of the camera 2 (cam2) and the wearable terminal 1 (wear1) is turned on (ON). Accompanying this, for example, an inter-group relation 165 appears between the worker 1 (worker1), which is relatively subordinate, and the process 2 (proc2), which is relatively superior. At this time, as depicted in FIG. 15, the inter-group relation information derivation appearance instance updating section 2300 registers an inter-group relation information record for the combination of the worker 1 (worker1), which is relatively subordinate, and the process 2 (proc2), which is relatively superior, and then includes, in the derivation-source record number group 1403 in the record, “c4,” which is the record number 1201 in the correlation information record for the combination of the camera 2 (cam2) and the wearable terminal 1 (wear1).

As is apparent from the lower section in FIG. 2, one of bases of the existence of the inter-group relation 165 between the worker 1 (worker1), which is relatively subordinate, and the process 2 (proc2), which is relatively superior, is a combination of the appearance of a derivation from the correlation 162 between the camera 2 (cam2) and the wearable terminal 1 (wear1), the fixed-type device-group relation 164 between the wearable terminal 1 (wear1) and the worker 1 (worker1), and the fixed-type device-group relation 164 between the camera 2 (cam2) and the process 2 (proc2). Accordingly, as represented by the inter-group relation information record whose record number 1501 is “g5” in FIG. 15, “r5,” which is the record number 1401 in the device-group relation information record for the combination of the wearable terminal 1 (wear1) and the worker 1 (worker1), “c4,” which is the record number 1201 in the correlation information record for the combination of the camera 2 (cam2) and the wearable terminal 1 (wear1), and “r3,” which is the record number 1401 in the device-group relation information record for the combination of the camera 2 (cam2) and the process 2 (proc2) are registered in association with each other in the derivation-source record number group 1403 in the inter-group relation information record for the combination of the worker 1 (worker1), which is relatively subordinate, and the process 2 (proc2), which is relatively superior.

Note that, as is apparent from the lower section in FIG. 2, also other bases of the existence of the inter-group relation 165 between the worker 1 (worker1), which is relatively subordinate, and the process 2 (proc2), which is relatively superior, than those described above exist. Specifically, a combination of the (derivation-type) device-group relation 164 between the camera 2 (cam2) and the worker 1 (worker1) and the fixed-type device-group relation 164 between the camera 2 (cam2) and the process 2 (proc2) also is a basis of the existence of the inter-group relation 165 between the worker 1 (worker1), which is relatively subordinate, and the process 2 (proc2), which is relatively superior. In addition, a combination of the fixed-type device-group relation 164 between the wearable terminal 1 (wear1) and the worker 1 (worker1) and the (derivation-type) device-group relation 164 between the wearable terminal 1 (wear1) and the process 2 (proc2) also is a basis of the existence of the inter-group relation 165 between the worker 1 (worker1), which is relatively subordinate, and the process 2 (proc2), which is relatively superior. Accordingly, a record number 1201 and a record number 1401 representing these bases also may be included in the derivation-source record number group 1403 in the inter-group relation information record for the combination of the worker 1 (worker1), which is relatively subordinate, and the process 2 (proc2), which is relatively superior.

After Step 2308, the control proceeds to Step 2309.

At Step 2309 in FIG. 23, the inter-group relation information derivation appearance instance updating section 2300 determines whether all possible combinations of a group 175 (group E) included in set_of_g(1) and a group 175 (group F) included in set_of_g(2) have been selected at Step 2302. If the determination result of Step 2309 is YES, the control returns to Step 2309, and the inter-group relation information derivation appearance instance updating section 2300 waits until the next opportunity of registration or updating of an inter-group relation information record. If the determination result of Step 2309 is NO, the control returns to Step 2302, and a combination of the group E and the group F that has not been selected yet is newly selected.

### 4-2-3-6. Process Performed by Low Correlation Event Processing Section

FIG. 24 depicts a flowchart of a process performed by the low correlation event processing section 2400. The following gives explanation in the processing order depicted in FIG. 24. Note that each of processing steps in the flowchart in FIG. 24 may be interpreted as forming a “low correlation event processing step.”

Since functions and processes like the ones explained below are realized, in response to sensing of an event that leads to a presumption that a correlation 162 between devices 172 does not exist, a correlation strength value 1202 representing the strength of the correlation 162 between the devices 172 can be adjusted appropriately. In addition, on the basis of the correlation strength value 1202, the disappearance of a derivation (having existed until then) from the correlation 162 to a relation (a device-group relation 164 or an inter-group relation 165) can be determined appropriately.

At Step 2401 in FIG. 24, the low correlation event processing section 2400 determines whether a “low correlation event” of any combination of devices 172 is sensed. For example, when the correlation event sensing section 1900 senses a “low correlation event” at Step 1904 in FIG. 19, the correlation event sensing section 1900 may notify the low correlation event processing section 2400 that a “low correlation event” is sensed. Any technique may be used for the notification. For example, an interrupt technique, a notification transmission technique using mailbox-type memory mediation, or the like may be used. If the determination result of Step 2401 is YES, the control proceeds to Step 2402. If the determination result of Step 2401 is NO, Step 2401 is repeated.

As depicted in Step 2402 in FIG. 24, hereinbelow, a combination of devices 172 between which a “low correlation event” is sensed is set as the device A and the device K.

At Step 2403 in FIG. 24, the low correlation event processing section 2400 determines whether, as a record in the correlation information table 1200 depicted in FIG. 12 (or the correlation information table 1300 depicted in FIG. 13), a correlation information record for the combination of the device A and the device K corresponding to the “low correlation event” exists already. If the determination result of Step 2403 is YES, the control proceeds to Step 2404. If the determination result of Step 2403 is NO, the control returns to Step 2401, and the low correlation event processing section 2400 waits until the next sensing of a “low correlation event.”

At Step 2404 in FIG. 24, the low correlation event processing section 2400 reduces, by t3, the correlation strength value 1202 in the correlation information record for the combination of the device A and the device K corresponding to the “low correlation event” existing already in the correlation information table 1200 (or the correlation information table 1300). Here, t3 may be the correlation strength increase/reduction amount depicted in FIG. 29. Whereas FIG. 29 depicts an example in which the value of the correlation strength increase/reduction amount t3 is 10, the value of the correlation strength increase/reduction amount t3 may be any value. The correlation strength increase/reduction amount t3 is included in the parameters 399 depicted in FIG. 5. (Whereas the increase amount to be used when a correlation strength value 1202 is increased in the flowchart in FIG. 20 and the reduction amount to be used when a correlation strength value 1202 is reduced in the flowchart in FIG. 24 are the same, t3, in the example depicted in FIG. 29, the increase amount and the reduction amount may be different values.) There may be a preset lower limit value of the correlation strength value 1202 when the correlation strength value 1202 is reduced at Step 2404. In a case where the correlation strength value 1202 in the correlation information record for the combination of the device A and the device K falls below the lower limit value if the correlation strength value 1202 is reduced by t3, the correlation strength value 1202 may be set to the lower limit value. For example, the lower limit value may be zero, but the lower limit value may be set to any value.

At Step 2405 in FIG. 24, the low correlation event processing section 2400 determines whether the derivation fixation flag 1204 in the correlation information record for the combination of the device A and the device K corresponding to the “low correlation event” is turned on (ON). In a case where the determination result of Step 2405 is YES, the derivation from the correlation 162 between the device A and the device K to a relation (a device-group relation 164 and an inter-group relation 165) is a fixed-type derivation, and the disappearance of the derivation is not permitted. Accordingly, the control returns to Step 2401, and the low correlation event processing section 2400 waits until the next sensing of a “low correlation event.” In a case where the determination result of Step 2405 is NO, the control proceeds to Step 2406.

At Step 2406 in FIG. 24, the low correlation event processing section 2400 determines whether the correlation strength value 1202 in the correlation information record for the combination of the device A and the device K corresponding to the “low correlation event” has changed from a value equal to or greater than t2 to a value lower than t2 before and after the process of reducing the correlation strength value 1202 at Step 2404. Here, t2 may be the derivation disappearance threshold depicted in FIG. 29. Whereas FIG. 29 depicts an example in which the value of the derivation disappearance threshold t2 is 40, the value of the derivation disappearance threshold t2 may be any value. In a case where the determination result of Step 2406 is YES (i.e., the correlation strength value 1202 has changed from a value equal to or greater than t2 to a value lower than t2), the control proceeds to Step 2407. In a case where the determination result of Step 2406 is NO, Step 2407 is skipped, and the control proceeds to Step 2408.

At Step 2407 in FIG. 24, the low correlation event processing section 2400 turns off (OFF) the derivation flag 1203 in the correlation information record for the combination of the device A and the device K corresponding to the “low correlation event.” That is, since the correlation strength value 1202 corresponding to the combination of the device A and the device K has become lower than the derivation disappearance threshold t2, it is determined that a derivation from the correlation 162 between the device A and the device K to a relation (a device-group relation 164 or an inter-group relation 165) has disappeared. Along with the derivation flag 1203 being turned off (OFF), the determination result of Step 2501 in FIG. 25 becomes YES.

After Step 2407, the control proceeds to Step 2408.

At Step 2408 in FIG. 24, the low correlation event processing section 2400 determines whether the correlation strength value 1202 in the correlation information record for the combination of the device A and the device K corresponding to the “low correlation event” has become a predetermined minimum value. The predetermined minimum value may be any value, and, for example, the predetermined minimum value may be zero. If the determination result of Step 2408 is YES, the control proceeds to Step 2409. If the determination result of Step 2408 is NO, the correlation information record for the combination of the device A and the device K has not been deleted yet. Accordingly, the control returns to Step 2401, and the low correlation event processing section 2400 waits until the next sensing of a “low correlation event.”

At Step 2409 in FIG. 24, the low correlation event processing section 2400 deletes, from the correlation information table 1200 (or the correlation information table 1300), the correlation information record for the combination of the device A and the device K corresponding to the “low correlation event.”

By performing such deletion, it can be expected that the number of combinations of devices 172 that are managed in the correlation information table 1200 can be optimized.

After Step 2409, the control returns to Step 2401, and the low correlation event processing section 2400 waits until the next sensing of a “low correlation event.”

### 4-2-3-7. Process Performed by Derivation Disappearance Event Processing Section

FIG. 25 depicts a flowchart of a process performed by the derivation disappearance event processing section 2500. The following gives explanation in the processing order depicted in FIG. 25. Note that each of processing steps in the flowchart in FIG. 25 may be interpreted as forming a “derivation disappearance event processing step.”

Since functions and processes like the ones explained below are realized, a combination of a device 172 and a group 175 between which a device-group relation 164 may disappear accompanying the disappearance of a derivation (having existed until then) can be grasped. In addition, a combination of groups 175 between which an inter-group relation 165 may disappear accompanying the disappearance of a derivation (having existed until then) can be grasped.

At Step 2501 in FIG. 25, the derivation disappearance event processing section 2500 determines whether or not a derivation (having existed until then) from a correlation 162 of any of combinations of devices 172 to a relation (a device-group relation 164 or an inter-group relation 165) has disappeared. For example, when the low correlation event processing section 2400 performs the process at Step 2407 in FIG. 24, the low correlation event processing section 2400 may notify the derivation disappearance event processing section 2500 of the disappearance of a derivation (having existed until then) from the correlation 162 between the device A and the device K. This notification may be in any mode (e.g., an interrupt format, a notification transmission format using memory mediation). Alternatively, in response to the low correlation event processing section 2400 turning off (OFF) the derivation flag 1203 in the correlation information record for the combination of the device A and the device K at Step 2407 in FIG. 24, the derivation disappearance event processing section 2500 may sense the derivation flag 1203 that has been newly turned off (OFF).

As depicted in Step 2502 in FIG. 25, it is assumed in the following explanation that a combination of devices 172 corresponding to the correlation 162 from which a derivation (having existed until then) has disappeared is the device A and the device K.

At Step 2503 in FIG. 25, the derivation disappearance event processing section 2500 grasps combinations of devices 172 corresponding to correlations 162 from which derivations have appeared already and combinations of devices 172 and groups 175 corresponding to device-group relations 164 that already exist immediately after the disappearance of the derivation (having existed until then) from the correlation 162 between the device A and the device K.

For example, the derivation disappearance event processing section 2500 grasps combinations of devices 172 represented by correlation information records whose derivation flags 1203 have already been turned on (ON), other than the correlation information record for the combination of the device A and the device K from which the disappearance of the derivation (having existed until then) is sensed at Step 2501. Specifically, the derivation disappearance event processing section 2500 refers to the first device IDs 801-1 and the second device IDs 801-2 in the correlation information records whose derivation flags 1203 have already been turned on (ON).

In addition, for example, the derivation disappearance event processing section 2500 grasps combinations of devices 172 and groups 175 represented by device-group relation information records that already exist. Specifically, the derivation disappearance event processing section 2500 refers to the device IDs 801 and the group IDs 901 in the device-group relation information records that already exist.

A graph representing the group of the combinations of the devices 172 and the combinations of the devices 172 and the groups 175 that are grasped as described above is written as G(A,K). The graph G(A,K) represents “relations” or “interconnectivities” between devices 172 and groups 175 that are formed by the correlations 162 from which derivations have already appeared and the device-group relations 164 that already exist immediately after the disappearance of the derivation (having existed until then) from the correlation 162 between the device A and the device K.

At Step 2504 in FIG. 25, the derivation disappearance event processing section 2500 determines a set of devices 172 that can be tracked from the device A on the basis of the graph G(A,K), and sets the set as set_of_d(A). Here, devices 172 that can be tracked from the device A mean devices 172 that are included in the graph G(A,K) and that can be tracked with the device A as the starting point on the basis of the correlations 162 from which derivations have already appeared. In addition, the derivation disappearance event processing section 2500 determines a set of groups 175 that can be tracked from the device A on the basis of the graph G(A,K), and sets the set as set_of_g(A). Here, groups 175 that can be tracked from the device A mean groups 175 that are included in the graph G(A,K) and that can be tracked with the device A as the starting point on the basis of the correlations 162 from which derivations have already appeared and the device-group relations 164 that already exist.

At Step 2505 in FIG. 25, the derivation disappearance event processing section 2500 determines a set of devices 172 that can be tracked from the device K on the basis of the graph G(A,K), and sets the set as set_of_d(K). In addition, the derivation disappearance event processing section 2500 determines a set of groups 175 that can be tracked from the device K on the basis of the graph G(A,K), and sets the set as set_of_g(K).

Here, a device-group relation 164 may disappear for a combination of each of devices 172 included in set_of_d(A) and each of groups 175 included in set_of_g(K) due to the disappearance of the derivation (having existed until then) from the correlation 162 between the device A and the device K. Similarly, a device-group relation 164 may disappear for a combination of each of devices 172 included in set_of_d(K) and each of groups 175 included in set_of_g(A) due to the disappearance of the derivation (having existed until then) from the correlation 162 between the device A and the device K. Moreover, similarly, an inter-group relation 165 may disappear for a combination of each of groups 175 included in set_of_g(A) and each of groups 175 included in set_of_g(K) due to the disappearance of the derivation (having existed until then) from the correlation 162 between the device A and the device K.

Note that there can also be a case where, as a result of the processes at Step 2504 and Step 2505, the set of devices 172 belonging to set_of_d(A) and the set of devices 172 belonging to set_of_d(K) become completely the same, and the set of groups 175 belonging to set_of_g(A) and the set of groups 175 belonging to set_of_d(K) become completely the same. In this case, there are no device-group relations 164 and inter-group relations 165 at all that disappear due to the disappearance of the derivation (having existed until then) from the correlation 162 between the device A and the device K. In this case, derivation-source record number groups in device-group relation information records and inter-group relation records that already exist are merely updated in FIG. 26 and FIG. 27.

At Step 2506 in FIG. 25, if set_of_g(K) is not an empty set regarding groups 175, the derivation disappearance event processing section 2500 updates or deletes a device-group relation information record of a combination of each of devices 172 included in set_of_d(A) and each of groups 175 included in set_of_g(K). Specifically, the derivation disappearance event processing section 2500 causes the device-group relation information derivation disappearance instance updating section 2600 to execute a process depicted in FIG. 26. If there is a device-group relation 164 that disappears as a result of the process in FIG. 26, a device-group relation information record for the device-group relation 164 is deleted from the device-group relation information table 1400.

At Step 2507 in FIG. 25, if set_of_g(A) is not an empty set regarding groups 175, the derivation disappearance event processing section 2500 updates or deletes a device-group relation information record of a combination of each of devices 172 included in set_of_d(K) and each of groups 175 included in set_of_g(A). Specifically, the derivation disappearance event processing section 2500 causes the device-group relation information derivation disappearance instance updating section 2600 to execute a process depicted in FIG. 26. If there is a device-group relation 164 that disappears as a result of the process in FIG. 26, a device-group relation information record for the device-group relation 164 is deleted from the device-group relation information table 1400.

At Step 2508 in FIG. 25, if neither set_of_g(A) nor set_of_g(K) is an empty set regarding groups 175, the derivation disappearance event processing section 2500 updates or deletes an inter-group relation information record of a combination of each of groups 175 included in set_of_g(A) and each of groups 175 included in set_of_g(K). Specifically, the derivation disappearance event processing section 2500 causes the inter-group relation information derivation disappearance instance updating section 2700 to execute a process depicted in FIG. 27. If there is an inter-group relation 165 that disappears as a result of the process in FIG. 27, an inter-group relation information record for the inter-group relation 165 is deleted from the inter-group relation information table 1500.

After Step 2508, the control returns to 2501, and the derivation disappearance event processing section 2500 waits until the next disappearance of a derivation is sensed.

### 4-2-3-8. Process Performed by Device-Group Relation Information Derivation Disappearance Instance Updating Section

FIG. 26 depicts a flowchart of a process performed by the device-group relation information derivation disappearance instance updating section 2600. The following gives explanation in the processing order depicted in FIG. 26. Note that each of processing steps in the flowchart in FIG. 26 may be interpreted as forming a “device-group relation derivation disappearance instance updating step.” Since functions and processes like the ones explained below are realized, it is possible to appropriately determine a change in information regarding a device-group relation 164 accompanying the disappearance of a derivation (having existed until then) and cause the determined change to be reflected in the device-group relation information table 1400. In addition, in a case where a device-group relation 164 disappears accompanying the disappearance of a derivation (having existed until then), it is possible to cause the disappearance to be reflected in the device-group relation information table 1400.

At Step 2601 in FIG. 26, the device-group relation information derivation disappearance instance updating section 2600 determines whether to update or delete a device-group relation information record accompanying the disappearance of a derivation (having existed until then) from a correlation 162. For example, the derivation disappearance event processing section 2500 determines, at Step 2506 in FIG. 25, to update or delete a device-group relation information record of a combination of a device 172 included in set_of_d(A) and a group 175 included in set_of_g(K), and the derivation disappearance event processing section 2500 gives a notification to that effect to the device-group relation information derivation disappearance instance updating section 2600. In addition, for example, the derivation disappearance event processing section 2500 determines, at Step 2507 in FIG. 25, to update or delete a device-group relation information record of a combination of a device 172 included in set_of_d(K) and a group 175 included in set_of_g(A), and the derivation disappearance event processing section 2500 gives a notification to that effect to the device-group relation information derivation disappearance instance updating section 2600. In the following explanation given with reference to FIG. 26, the set of devices 172 described above is written as set_of_d, and the set of groups 175 described above is written as set_of_g.

At Step 2602 in FIG. 26, the device-group relation information derivation disappearance instance updating section 2600 selects one of devices 172 included in set_of_d, and sets the selected device 172 as a device L. In addition, the device-group relation information derivation disappearance instance updating section 2600 selects one of groups 175 included in set_of_g, and sets the selected group 175 as a group M. That is, a combination of the device L and the group M is selected as a candidate (relation settings cancellation candidate) from which a device-group relation 164 is to disappear.

At Step 2603 in FIG. 26, the device-group relation information derivation disappearance instance updating section 2600 determines whether a device-group relation information record for the combination of the device L and the group M selected at the latest Step 2602 exists in the device-group relation information table 1400 in FIG. 14. If the determination result of Step 2603 is YES, the control proceeds to Step 2604. If the determination result of Step 2603 is NO, a device-group relation 164 between the device L and the group M does not exist first of all. Accordingly, Step 2604, Step 2605, Step 2606, and Step 2607 are skipped, and the control proceeds to Step 2608.

At Step 2604 in FIG. 26, the device-group relation information derivation disappearance instance updating section 2600 refers to the device-group relation information table 1400 in FIG. 14, and determines whether the relation fixation flag 1402 in the device-group relation information record for the combination of the device L and the group M is turned on (ON). If the determination result of Step 2604 is YES (the relation fixation flag 1402 is turned on (ON)), it is not permitted to cause the device-group relation 164 between the device L and the group M to disappear. Accordingly, Step 2605, Step 2606, and Step 2607 are skipped, and the control proceeds to Step 2608. If the determination result of Step 2604 is NO (the relation fixation flag 1402 is turned off (OFF)), the control proceeds to Step 2605.

At Step 2605 in FIG. 26, the device-group relation information derivation disappearance instance updating section 2600 updates the derivation-source record number group 1403 in the device-group relation information record for the combination of the device L and the group M selected at the latest Step 2602. Specifically, the device-group relation information derivation disappearance instance updating section 2600 deletes, from the derivation-source record number group 1403, information identifying a correlation 162 whose derivation (having existed until then) has disappeared. That is, the device-group relation information derivation disappearance instance updating section 2600 deletes, from the derivation-source record number group 1403, information representing the combination of the device A and the device K.

If the record number 1201 exists in each of correlation information records in the correlation information table 1200 as depicted in FIG. 12 and FIG. 13, at Step 2605, the device-group relation information derivation disappearance instance updating section 2600 may delete, from the derivation-source record number group 1403, the record number 1201 in the correlation information record for the combination of the device A and the device K (and a record number associated with the record number).

For example, a case where a derivation from the correlation 162 between the camera 3 (cam3) and the wearable terminal 1 (wear1) disappears accompanying the change from the situation depicted in the upper section in FIG. 2 to the situation depicted in the lower section in FIG. 2 is explained. In this case, as represented by changes from the correlation information table 1200 in FIG. 12 to the correlation information table 1300 in FIG. 13, the derivation flag 1203 of the correlation information record for the combination of the camera 3 (cam3) and the wearable terminal 1 (wear1) is turned off (OFF). The record number 1201 in the record is “c2.” From each of device-group relation information records included in the device-group relation information table in FIG. 14, the device-group relation information derivation disappearance instance updating section 2600 deletes the record number “c2” (and a record number associated with the record number “c2”) if the derivation-source record number group 1403 in the record includes the record number “c2.” In the example depicted in FIG. 14, the portion “c2-c5” is deleted from the derivation-source record number group 1403 in the device-group relation information record whose record number 1401 is “r7.” The portion “c1-c2-r5” is deleted from the derivation-source record number group 1403 in the device-group relation information record whose record number 1401 is “r9.” The portion “c2-c1-r2” and the portion “c2-r8” are deleted from the derivation-source record number group 1403 in the device-group relation information record whose record number 1401 is “r10.”

After Step 2605, the control proceeds to Step 2606.

At Step 2606 in FIG. 26, the device-group relation information derivation disappearance instance updating section 2600 determines whether the derivation-source record number group 1403 in the device-group relation information record for the combination of the device L and the group M selected at the latest Step 2602 has become empty. That is, the device-group relation information derivation disappearance instance updating section 2600 determines whether bases of the existence of the device-group relation 164 between the device L and the group M have been completely lost.

For example, a case where a derivation from the correlation 162 between the camera 3 (cam3) and the wearable terminal 1 (wear1) disappears accompanying the change from the situation depicted in the upper section in FIG. 2 to the situation depicted in the lower section in FIG. 2 is explained. In this case, as represented by changes from the correlation information table 1200 in FIG. 12 to the correlation information table 1300 in FIG. 13, the derivation flag 1203 of the correlation information record for the combination of the camera 3 (cam3) and the wearable terminal 1 (wear1) is turned off (OFF). The record number 1201 in the record is “c2.” Accordingly, as a result of Step 2605 mentioned before, the derivation-source record number group 1403 in the device-group relation information record whose record number 1401 is “r10” becomes empty. Accordingly, the determination result of Step 2606 regarding the device-group relation information record whose record number 1401 is “r10” is YES.

In addition, after Step 2605 mentioned before, “c1-r9” remains in the derivation-source record number group 1403 in the device-group relation information record whose record number 1401 is “r7,” and “c1-r7” remains in the derivation-source record number group 1403 in the device-group relation information record whose record number 1401 is “r9.” However, the relation fixation flags 1402 in the device-group relation information records whose record numbers 1401 are “r7” and “r9” are both turned off (OFF), and device-group relations 164 represented by the device-group relation information records are not fixed-type device-group relations 164, but are derivation-type device-group relations 164. That is, derivation-type device-group relations 164 are mutually bases (derivation sources) of the existence of each other. In such a case also, the device-group relation information derivation disappearance instance updating section 2600 determines the determination result of Step 2606 as YES.

If the determination result of Step 2606 is YES, the control proceeds to Step 2607. If the determination result of Step 2608 is NO, one that is effective as a basis of the existence (derivation source) of the device-group relation 164 between the device L and the group M remains. Accordingly, Step 2607 is skipped, and the control proceeds to Step 2608.

At Step 2607 in FIG. 26, the device-group relation information derivation disappearance instance updating section 2600 deletes, from the device-group relation information table 1400 in FIG. 14, the device-group relation record for the combination of the device L and the group M selected at the latest Step 2602. As a result of the deletion, the device-group relation 164 between the device L and the group M is handled as having disappeared.

After Step 2607, the control proceeds to Step 2608.

At Step 2608 in FIG. 26, the device-group relation information derivation disappearance instance updating section 2600 determines whether all possible combinations of a device 172 (device L) included in set_of_d and a group 175 (group M) included in set_of_g have been selected at Step 2602. If the determination result of Step 2608 is YES, the control returns to Step 2601, and the device-group relation information derivation disappearance instance updating section 2600 waits until the next opportunity of updating or deletion of a device-group relation information record. If the determination result of Step 2608 is NO, the control returns to 2602, and a combination of the device L and the group M that has not been selected yet is newly selected.

### 4-2-3-9. Process Performed by Inter-Group Relation Information Derivation Disappearance Instance Updating Section

FIG. 27 depicts a flowchart of a process performed by the inter-group relation information derivation disappearance instance updating section 2700. The following gives explanation in the processing order depicted in FIG. 27. Note that each of processing steps in the flowchart in FIG. 27 may be interpreted as forming an “inter-group relation derivation disappearance instance updating step.”

Since functions and processes like the ones explained below are realized, it is possible to appropriately determine a change in information regarding an inter-group relation 165 accompanying the disappearance of a derivation (having existed until then) and cause the determined change to be reflected in the inter-group relation information table 1500. In addition, in a case where an inter-group relation 165 disappears accompanying the disappearance of a derivation (having existed until then), it is possible to cause the disappearance to be reflected in the inter-group relation information table 1500.

The content of the process executed by the inter-group relation information derivation disappearance instance updating section 2700 and depicted in FIG. 27, and the content of the process executed by the device-group relation information derivation disappearance instance updating section 2600 and depicted in FIG. 26 are the same except for the target objects of the processes. Accordingly, detailed explanation of FIG. 27 is omitted. The following depicts how the explanation of FIG. 26 should be reinterpreted so as to become the explanation of FIG. 27.

Whereas the functional section which is the main processing section in FIG. 26 is the “device-group relation information derivation disappearance instance updating section 2600,” the functional section which is the main processing section in FIG. 27 is the “inter-group relation information derivation disappearance instance updating section 2700.”

The step names “Step 2601,” “Step 2602,” “Step 2603,” “Step 2604,” “Step 2605,” “Step 2606,” “Step 2607,” and “Step 2608” in FIG. 26 should be reinterpreted as the step names “Step 2701,” “Step 2702,” “Step 2703,” “Step 2704,” “Step 2705,” “Step 2706,” “Step 2707,” and “Step 2708” in FIG. 27, respectively.

The “set of devices set_of_d” and the “set of groups set_of_g” which are sets to be handled in FIG. 26 should be reinterpreted as the “first set of groups set set_of_g(1)” and the “second set of groups set_of_g(2)” in FIG. 27.

The “device-group relation information table 1400” and “device-group relation information records” which are an updating-target or deletion-target table and records in FIG. 26 should be reinterpreted as the “inter-group relation information table 1500” and “inter-group relation information records” in FIG. 27.

The “device L included in set_of_d” and the “group M included in set_of_g” which are selected in FIG. 26 should be reinterpreted as a “group P included in set_of_g(1)” and a “group Q included in set_of_g(2)” in FIG. 27.

A case where a derivation from the correlation 162 between the camera 3 (cam3) and the wearable terminal 1 (wear1) disappears accompanying the change from the situation depicted in the upper section in FIG. 2 to the situation depicted in the lower section in FIG. 2 is explained.

According to the inter-group relation information table 1500 in FIG. 15, in the situation depicted in the upper section in FIG. 2, five groups, “r5-r10,” “r5-c2-c1-r2,” “r5-c2-r8,” “r7-c1-r2,” and “r7-r8,” are recorded in the derivation-source record number group 1403 in the inter-group relation record whose record number 1501 is “g3.” As has already been depicted in the explanation given with reference to FIG. 26, if the derivation (having existed until then) from the correlation 162 between the camera 3 (cam3) and the wearable terminal 1 (wear1) disappears, the derivation flag 1203 in the correlation information record whose record number 1201 is “c2” is turned off (OFF), and the device-group relation information records whose record numbers 1401 are “r7,” “r9,” and “r10” are deleted from the device-group relation information table 1400.

Accordingly, all the five groups included in the derivation-source record number group 1403 in the inter-group relation record whose record number 1501 is “g3” are deletion targets at Step 2705.

Specifically, accompanying the derivation flag 1203 of the correlation management record whose record number 1201 is “c2” being turned off (OFF), “r5-c2-c1-r2” and “r5-c2-r8” become deletion targets at Step 2705.

Along with the deletion of the device-group relation information record whose record number 1401 is “r7,” “r7-c1-r2” and “r7-r8” become deletion targets at Step 2705.

Along with the deletion of the device-group relation information record whose record number 1401 is “r10,” “r5-r10” becomes a deletion target at Step 2705.

Taking these into consideration together, all of the five groups, “r5-r10,” “r5-c2-c1-r2,” “r5-c2-r8,” and “r7-c1-r2,” and “r7-r8,” included in the derivation-source record number group 1403 in the inter-group relation record whose record number 1501 is “g3” are deletion targets at Step 2705.

Accordingly, the inter-group relation record whose record number 1501 is “g3” is a deletion target at Step 2707. That is, when the situation depicted in the lower section in FIG. 2 emerges, the inter-group relation 165 between the worker 1 (worker1), which is relatively subordinate, and the process 1 (proc1), which is relatively superior, is handled as having disappeared.

### 4-2-3-10. Process Performed by Fixation Setting Section

The fixation setting section 378, which is a functional section of the correlation analysis system 101, may perform control such that a screen as in FIG. 28 is displayed on a display included in the display/output apparatus 3607 that the correlation analysis system 101 has or on a display that another system has. Alternatively, any of the fixation setting section 388, which is a functional section of the meta information management system 302, the fixation setting section, which is a functional section of the development environment system 303, and the fixation setting section, which is a functional section of the data use system 304, may perform control such that the screen as in FIG. 28 is displayed on a display that any system has.

FIG. 28 depicts a fixed settings screen 2800. An example depicted in FIG. 28 is based on the situation depicted in the upper section in FIG. 2. The fixation setting section 378 performs displaying as in FIG. 28 on the basis of information acquired from the correlation information table 1200, the device-group relation information table 1400, and the inter-group relation information table 1500 (further, the device management information table 800 and the group management information table 900 as necessary).

A person who accesses the fixed settings screen 2800 depicted in FIG. 28 uses a mouse or the like included in the input apparatus 3606 to input information designating derivations/existence that the person desires to fix in the appearance of derivations from correlations 162, the existence of device-group relations 164, and the existence of inter-group relations 165.

In the example depicted in FIG. 28, a derivation-type inter-group relation 165 in which a group 175 which is relatively subordinate is the worker 2 (worker2), and a group 175 which is relatively superior is the process 2 (proc2) is designated by a cursor (an outline arrow in FIG. 28) operated with use of a mouse or the like. Note that, whereas an inter-group relation 165 is depicted as a relation to be fixed in the example depicted in FIG. 28, what is to be fixed may be the appearance of a derivation from a correlation 162 or a device-group relation 164.

In FIG. 28, when the designation by the cursor is performed, a pop-up window with content “Fix Relation of worker2-proc2. ‘Cancel’ ‘Execute’” appears, and a final decision to fix the relation is confirmed. Then, when the icon “Execute” is pressed with the cursor operated by a mouse or the like, the fixation setting section 378 is informed of input information designating a relation whose derivation/existence is desired by the user to fix (the appearance of a derivation from a correlation 162, the existence of a device-group relation 164, the existence of an inter-group relation 165).

After being informed of the input information, the fixation setting section 378 fixes the designated relation (the appearance of a derivation from a correlation 162, the existence of a device-group relation 164, the existence of an inter-group relation 165). Since the derivation-type inter-group relation 165 in which a group 175 which is relatively subordinate is the worker 2 (worker2) and a group 175 which is relatively superior is the process 2 (proc2) is the fixation target in the example depicted in FIG. 28, the fixation setting section 378 turns on (ON) the relation fixation flag 1402 in an inter-group relation information record whose record number 1501 is “g4” in the inter-group relation information table 1500 in FIG. 15. The fixation setting section 378 may further perform control such that the display of the derivation-type inter-group relation 165 in which a group 175 which is relatively subordinate is the worker 2 (worker2) and a group 175 which is relatively superior is the process 2 (proc2) is changed to the display of a fixed-type inter-group relation 165 in the fixed settings screen 2800 in FIG. 28.

Whereas an inter-group relation 165 is fixed in the example described above, the fixation setting section 378 may turn on (ON) the derivation fixation flag 1204 in a predetermined record in the correlation information table 1200 in FIG. 12 or FIG. 13 in a case where the appearance of a derivation from a correlation 162 is to be fixed. Similarly, the fixation setting section 378 may turn on (ON) the relation fixation flag 1402 in a predetermined record in the device-group relation information table 1400 in FIG. 14 in a case where the existence of a device-group relation 164 is to be fixed.

A person who accesses the fixed settings screen 2800 depicted in FIG. 28 may use a mouse or the like included in the input apparatus 3606 to input information designating derivations/existence that the user desires to unfix in the appearance of derivations from correlations 162, the existence of device-group relations 164, and the existence of inter-group relations 165. Operation of a mouse or the like and a process performed by the fixation setting section 378 for unfixing may be similar to those depicted in the description above. It should be noted that a relation fixation flag 1402 and a derivation fixation flag 1204 described above are turned off (OFF) for unfixing.

Since functions and processes like the ones explained above are realized, a user of the correlation analysis system 101, a user of the meta information management system 302 (e.g., the administrator 401), a user of the development environment system 303 (e.g., the developer 393), or a user of the data use system 304 (e.g., the data user 394) can set, as desired, ones that user desires to fix or unfix in the appearance of derivations from correlations 162, the existence of device-group relations 164, and the existence of inter-group relations 165.

In addition, settings of fixation explained above can be used when a device 172 is newly installed. For example, after a device 172 is newly installed, a derivation can appear from some correlation 162 related to the installed device 172, on the basis of device data 182 output from the installed device 172, and device data 182 output from another device 172 having already been installed. Then, some derivation-type device-group relation 164 related to the installed device 172 can appear. In one possible use, a person (e.g., the administrator 401, the developer 393) who has accessed the derivation-type device-group relation 164 that has appeared accompanying the new installation of the device 172 in this manner uses the fixed settings screen 2800 to change the derivation-type device-group relation 164 to a fixed-type device-group relation 164.

### 4-2-3-11. Process Performed by Parameter Setting Section

The parameter setting section 319, which is a functional section of the correlation analysis system 101, may perform control such that a screen as in FIG. 29 is displayed on a display included in the display/output apparatus 3607 that the correlation analysis system 101 has or on a display that another system has. Alternatively, any of the parameter setting section 329, which is a functional section of the meta information management system 302, the parameter setting section, which is a functional section of the development environment system 303, and the parameter setting section, which is a functional section of the data use system 304, may perform control such that the screen as in FIG. 29 is displayed on a display that any system has.

FIG. 29 depicts a parameter settings screen 2900. In the example depicted in FIG. 29, the parameter settings screen 2900 is a screen on which respective parameter values, the “derivation appearance threshold (t1)” used at the high correlation event processing section 2000, the “derivation disappearance threshold (t2)” used at the low correlation event processing section 2400, the “correlation strength increase/reduction amount (t3)” used at the high correlation event processing section 2000 and the low correlation event processing section 2400, and the “correlation event sensing period (k)” used at the correlation event sensing section 1900, can be set. Note that it may be possible to set also parameters other than the parameters depicted in FIG. 29, and it may not be possible to set some or all of the parameters depicted in FIG. 29.

The parameter settings screen 2900 displays an image of a horizontal seek bar for each parameter. By operating the position of the knob of each seek bar by a mouse or the like, the parameter value can be specified. Note that a technique other than the technique of horizontal seek bars depicted in FIG. 29 may be used for inputting parameter values. For example, parameter values may be input as numerical values in text boxes.

When information regarding setting values of parameters is input via the parameter settings screen 2900 or the like, the parameter setting section 319 is informed of the information. The parameter setting section 319 updates the contents of the parameters 399 depicted in FIG. 5 on the basis of the input information.

Since functions and processes like the ones explained above are realized, a user of the correlation analysis system 101, a user of the meta information management system 302 (e.g., the administrator 401), a user of the development environment system 303 (e.g., the developer 393), or a user of the data use system 304 (e.g., the data user 394) can perform adjustment of the sensitivity of sensing of high correlation events and low correlation events, adjustment of the sensitivity of determination of the appearance or disappearance of derivations, and the like.

For example, the adjustment of the sensitivity and the like can be performed while actually acquiring device data 182 from the site, and collecting information for grasping the situation of the site.

### 4-3. Functional Configuration, Processes, and Information Involved in Construction and Revision of Application (FIG. 6)

Correlations 162, device-group relations 164, and inter-group relations 165 that the correlation analysis system 101 detects and manages can be used for various uses related to the handling of devices 172 and groups 175.

The following explains an example of such uses in which correlations 162, device-group relations 164, and inter-group relations 165 are used for constructing or revising an application related to the handling of devices 172 and groups 175. That is, this section explains functional configuration, processes, and information that are involved when the development environment system 303 constructs or revises an application.

The functional configuration, processes, and information explained below allow the developer 393 to promptly and appropriately grasp a device 172 which is an information source that acquires desired information in the construction or development of an application that uses device data 182 acquired from the site, and also to promptly and appropriately generate an application code (or functional blocks) including processes of acquiring the desired information.

FIG. 6 depicts functional configuration 600 (and information to be handled) to be used when an application that uses device data 182 output from each of devices 172 at the site is constructed or revised in the development environment system 303.

First, a correlation/relation information providing section 323, which is a functional section of the meta information management system 302, informs the development environment system 303 of correlation/relation information. The correlation/relation information mentioned here is information regarding each of the appearance of a derivation from a correlation 162 between devices 172, the existence of a device-group relation 164 between a device 172 and a group 175, and the existence of an inter-group relation 165 between groups 175.

In order to form the correlation/relation information to be transmitted, the correlation/relation information providing section 323 acquires information from the correlation information table 1200, the device-group relation information table 1400, and the inter-group relation information table 1500. In addition, depending on such a degree that a user or the like (e.g., the developer 393) of the development environment system 303 refers to information regarding devices 172 and groups 175, the correlation/relation information providing section 323 may acquire information from the device management information table 800 and the group management information table 900 in order to form the correlation/relation information to be transmitted.

After forming the correlation/relation information, the correlation/relation information providing section 323 may inform the development environment system 303 of the correlation/relation information at any timing.

For example, the timing may be when a user or the like (e.g., the developer 393) of the development environment system 303 starts the work of constructing or revising an application on the development environment system 303 in order to construct or revise the application. In this case, according to the timing, an operation performed by a development environment section 330, which is a functional section of the development environment system 303, is started, and the development environment section 330 may instruct a correlation/relation information acquiring section 333, which is a functional section of the development environment system 303, to acquire the correlation/relation information. The correlation/relation information acquiring section 333 having received the instruction instructs the meta information management system 302 to provide the correlation/relation information. Then, the correlation/relation information acquiring section 333 acquires the correlation/relation information transmitted from the correlation/relation information providing section 323. The correlation/relation information acquiring section 333 may store the acquired correlation/relation information in a correlation/relation information buffer 338 retained by the development environment system 303.

Alternatively, regularly or every time there is a change in information of any of the correlation information table 1200, the device-group relation information table 1400, and the inter-group relation information table 1500, the correlation/relation information providing section 323 may form correlation/relation information, and then inform the development environment system 303 of the correlation/relation information. In this case, every time the correlation/relation information acquiring section 333 acquires transmitted correlation/relation information, the correlation/relation information acquiring section 333 may store the correlation/relation information in the correlation/relation information buffer 338.

Using correlation/relation information stored in the correlation/relation information buffer 338, the development environment section 330 may determine whether there is a change in any of the appearance of a derivation from a correlation 162 between devices 172, the existence of a device-group relation 164 between a device 172 and a group 175, and the existence of an inter-group relation 165 between groups 175. Then, on the basis of the change in the correlation/relation information, the development environment section 330 may identify information whose information-source device 172 may need to be changed, in information that is to be acquired at the time of execution of the application which is the code-revision target. On a development environment screen presented to a user or the like (e.g., the developer 393) of the development environment system 303, the development environment section 330 may display a message regarding the information whose information-source device 172 may need to be changed, in the information that is acquired at the time of execution of the application which is the revision target.

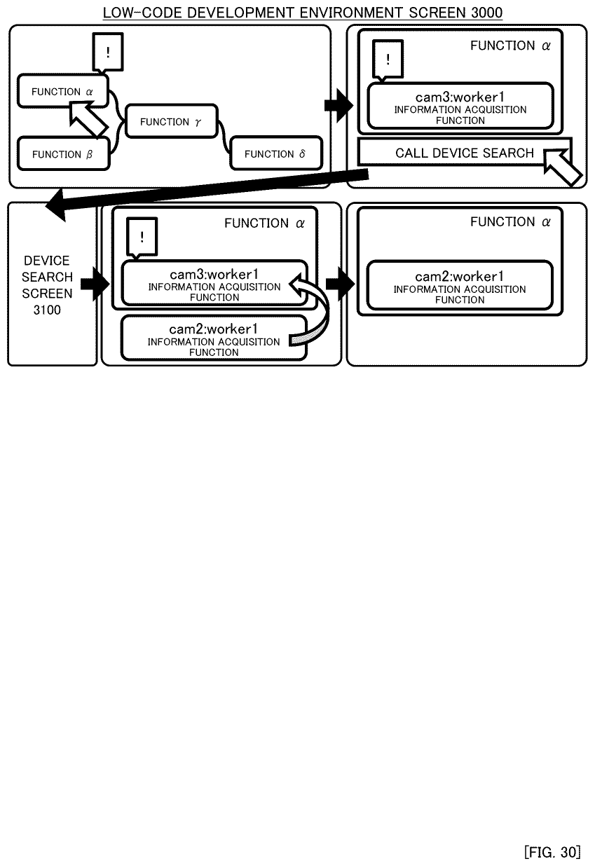

FIG. 30 depicts a low-code development environment screen 3000. When construction or revision of the application is performed, the development environment section 330 performs control such that the low-code development environment screen 3000 depicted in FIG. 30 is displayed on a display that the development environment system 303 has (or a display of some system existing remotely when seen from the development environment system 303).

The development environment section 330 may perform control such that, first, a display represented by a rectangle with rounded corners in an upper left section in FIG. 30 is shown on the display. In the upper left section in FIG. 30, a “function α,” a “function β,” a “function γ,” and a “function σ” which are functions of a construction-target or revision-target application are depicted as small rectangular icons with rounded corners. In addition, the information exchange between the “function α” and the “function γ,” the information exchange between the “function β” and the “function γ,” and the information exchange between the “function γ” and the “function σ” are represented by curves between the icons of the “function α,” the “function β,” the “function γ,” and the “function σ” in the upper left section in FIG. 30.

When revision of an application is performed, a message regarding information whose information-source device 172 may need to be changed in information that is acquired at the time of execution of the application may be displayed on a screen like the one in the upper left section in FIG. 30. For example, in a case where an information-source device 172 of information to be used in a process using the “function α” may need to be changed, the icon “function α” may be accompanied by a balloon with the display of “!” (the display of a correlation/relation change warning) as depicted in the upper left section in FIG. 30.

At the time of construction or revision of an application, a user (e.g., the developer 393) of the development environment system 303 may use an input apparatus such as a mouse to click the icon “function α,” “function β,” “function γ,” “function σ,” or the like on the screen depicted in the upper left section in FIG. 30. (Note that each icon is clickable independently of whether or not there is the display of the correlation/relation change warning mentioned before.) In response to the click, the development environment section 330 may perform control such that a display represented by a rectangle with rounded corners in an upper right section in FIG. 30 is shown. The upper right section in FIG. 30 depicts what is displayed on the display after the icon “function α” is clicked. The upper right section in FIG. 30 has a display on which details of functions performed by the clicked function (here, the “function α”) are editable. In the upper right section in FIG. 30, in particular, an icon “cam3: worker1 Information Acquisition Function” which is a functional block that acquires, from the camera 3 (cam3), image data (moving image data) which is information used in a process using the “function α,” and is obtained by capturing images of the worker 1 (worker1) in such a display is displayed.

At the time of revision of an application, the display of the correlation/relation change warning may accompany as mentioned before. Since there is the balloon with the display of “!” (the display of the correlation/relation change warning) for the “function α” in the upper left section in FIG. 30, a user or the like (e.g., the developer 393) of the development environment system 303 can promptly and appropriately grasp a portion to be revised in an application. In addition, the display in the upper right section in FIG. 30 is shown when the icon “function α” is clicked here, and the icon “cam3: worker1 Information Acquisition Function” may be accompanied by a balloon with the display of “!” (the display of the correlation/relation change warning) in the display in the upper right section in FIG. 30. A user or the like (e.g., the developer 393) of the development environment system 303 who has accessed the display can grasp that the camera 3 (cam3) is no longer appropriate as an information source of image data (moving image data) which is information used in the process using the “function α,” and is obtained by capturing images of the worker 1 (worker1).

A user or the like (e.g., the developer 393) of the development environment system 303 who has accessed the display in the upper right section in FIG. 30 revises a code of a functional block corresponding to the icon “cam3: worker1 Information Acquisition Function.” More specifically, a user or the like (e.g., the developer 393) of the development environment system 303 recreates a functional block that acquires, from an appropriate camera, image data (moving image data) which is information used in the process using the “function α,” and is obtained by capturing images of the worker 1 (worker1). In order to do so, it becomes necessary to identify (a camera in) information-source devices 172 of image data (moving image data) which is information used in the process using the “function α,” and is obtained by capturing images of the worker 1 (worker1).

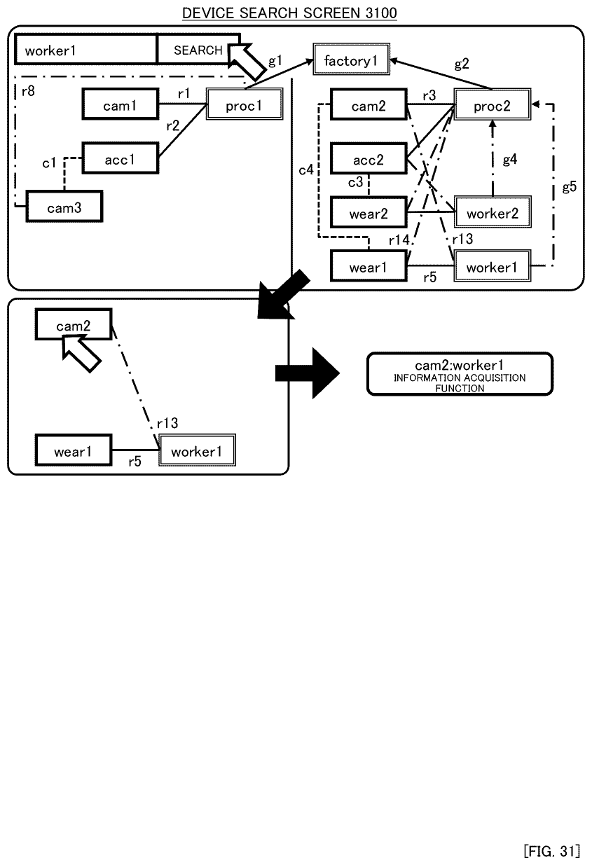

In view of this, a user (e.g., the developer 393) or the like of the development environment system 303 who has accessed the display in the upper right section in FIG. 30 uses an input apparatus such as a mouse to click an icon “Call Device Search” included in the display in the upper right section in FIG. 30. In response to the click, the development environment section 330 calls a device search section 331, which is a functional section of the development environment system 303. The device search section 331 may perform control such that a device search screen 3100 depicted in FIG. 31 is displayed on a display that the development environment system 303 has (or a display of some system existing remotely when seen from the development environment system 303).

FIG. 31 depicts the device search screen 3100.

When the icon “Call Device Search” is clicked in the display depicted in the upper right section in FIG. 30, first, a screen represented by a rectangle with rounded corners depicted in an upper section in FIG. 31 may be displayed. In order to show the display depicted in the upper section in FIG. 31, the device search section 331 reads out correlation/relation information stored in the correlation/relation information buffer 338, and grasps information regarding each of the appearance of a derivation from a correlation 162 between devices 172, the existence of a device-group relation 164 between a device 172 and a group 175, and the existence of an inter-group relation 165 between groups 175. Then, the device search section 331 may perform control such that the grasped information is represented by a graph display or the like, and realize a display like the one in the upper section in FIG. 31. Note that the example depicted in the upper section in FIG. 31 depicts a case where the worker 1 (worker1) in the situation depicted in the upper section in FIG. 2 has moved from the work field of the process 1 (proc1) to the work field of the process 2 (proc2), resulting in the situation depicted in the lower section in FIG. 2.

In the display depicted in the upper section in FIG. 31, in addition to a graph display representing each of the appearance of a derivation from a correlation 162 between devices 172, the existence of a device-group relation 164 between a device 172 and a group 175, and the existence of an inter-group relation 165 between groups 175, and the like, there may be a search window for device searches as depicted in an upper left section in the display in the upper section in FIG. 31. A user (e.g., the developer 393) or the like of the development environment system 303 may input a group ID 901 or a group name 902 of a group 175 to a text input field in the search window, and then click the icon “Search” by a mouse or the like. In the example depicted in the upper section in FIG. 31, the “worker1,” which is the group ID 901 of the worker 1, is text-input, and then the icon “Search” is clicked by a mouse or the like (a cursor operated by the mouse or the like is represented by an outline arrow in FIG. 31).

Alternatively, instead of the technique depicted in the upper section in FIG. 31, a technique in which an icon (e.g., the icon “worker1”) representing a group 175 in a graph display or the like representing each of the appearance of a derivation from a correlation 162 between devices 172, the existence of a device-group relation 164 between a device 172 and a group 175, and the existence of an inter-group relation 165 between groups 175 is clicked by a mouse or the like may be used.

In any case, by the designation of the “worker1” representing the worker 1 as in the upper section in FIG. 31, a device 172 for which a relation (device-group relation 164) with the worker 1 (worker1) exists is searched for.

Using correlation/relation information stored in the correlation/relation information buffer 338, the device search section 331 searches for a device 172 for which a device-group relation 164 with a designated group 175 exists, as depicted in the upper section in FIG. 31. The case depicted in the upper section in FIG. 31 is based on the situation depicted in the lower section in FIG. 2. Accordingly, here, the device search section 331 identifies the wearable terminal 1 (wear1) and the camera 2 (cam2) as devices 172 having device-group relations 164 with the worker 1 (worker1). The device search section 331 may perform control such that a display represented by a rectangle with rounded corners as in the lower left section in FIG. 31 is shown so as to clearly indicate the relations between the identified devices 172 and the group 175 designated as in the upper section in FIG. 31.

In the case depicted in FIG. 30, a user (e.g., the developer 393) or the like of the development environment system 303 who has accessed the display in the lower left section in FIG. 31 may click the icon “cam2” (an icon representing the camera 2) in FIG. 31 in order to recreate a functional block that acquires, from an appropriate camera, image data (moving image data) which is information used in the process using the “function α,” and is obtained by capturing images of the worker 1 (worker1). That is, since the display depicted in the lower left section in FIG. 31 depicts the wearable terminal 1 (wear1) and the camera 2 (cam2) as devices 172 for which device-group relations 164 with the worker 1 (worker1) exist, a user (e.g., the developer 393) or the like of the development environment system 303 may use a mouse or the like (a cursor operated by the mouse or the like is represented by an outline arrow in FIG. 31) to click the icon “cam2” representing the camera 2, which is a camera among them.

In response to the click in the display depicted in the lower left section in FIG. 31, a functional block generating section 332, which is a functional section of the development environment system 303, may generate a code of a functional block for acquiring device data 182 output from the device 172 corresponding to the clicked icon. In the example depicted in the lower left section in FIG. 31, the functional block generating section 332 may generate a functional block for acquiring image data (moving image data) which is device data 182 output by the camera 2 (cam2), and handling the image data (moving image data) as image data (moving image data) obtained by capturing images of the worker 1 (worker1). The functional block generated here corresponds to an icon named “cam2: worker1 Information Acquisition Function” in the lower right section in FIG. 31 (and in FIG. 30).

When the functional block generating section 332 creates a functional block for acquiring device data 182 output from the designated device 172, access settings information for acquiring the device data 182 may be necessary. For example, the access settings information here may be a device data acquisition source URL 804 included in the device management information table 800 in FIG. 8. Alternatively, the access settings information may be another type of information.

In a case where access settings information (e.g., a device data acquisition source URL 804) required for generation of a functional block has already been provided as part of correlation/relation information and is stored in the correlation/relation information buffer 338, the functional block generating section 332 may generate a functional block, using the access settings information (e.g., the device data acquisition source URL 804) stored in the correlation/relation information buffer 338.

In a case where access settings information (e.g., a device data acquisition source URL 804) required for generation of a functional block has not been provided to the development environment system 303 yet, the functional block generating section 332 informs the meta information management system 302 of a request for the access settings information (e.g., the device data acquisition source URL 804).

In response to the request for access settings information, for example, an access settings information providing section 322, which is a functional section of the meta information management system 302, extracts the requested access settings information (e.g., the device data acquisition source URL 804) from the device management information table 800, and informs the development environment system 303 of the extracted access settings information (e.g., the device data acquisition source URL 804).

The access settings information (e.g., the device data acquisition source URL 804) read out from the correlation/relation buffer or transmitted from the access settings information providing section 322 is acquired by the functional block generating section 332. The functional block generating section 332 may generate a functional block using the acquired access settings information (e.g., the device data acquisition source URL 804). The functional block generating section 332 may store a code of the generated functional block in a functional block code buffer 337 retained by the development environment system 303.

A user (e.g., the developer 393) or the like of the development environment system 303 may perform the work of constructing or revising an application by using the functional block generated by the functional block generating section 332. In order to do so, the development environment section 330 may read out the functional block code stored in the functional block code buffer 337, and apply the functional block code to an application 334 under development being handled by the development environment system 303.

The displays depicted at the middle and on the right side in the lower section in FIG. 30 depict that, at the time of revision of the application, instead of the functional block “cam3: worker1 Information Acquisition Function,” the functional block “cam2: worker1 Information Acquisition Function” generated as depicted in FIG. 31 is used for the “function α.”

As depicted in FIG. 30 and FIG. 31, the constructed or revised application may be ported to (installed on) the data use system 304. FIG. 6 depicts that, after the construction or revision of the application 334 under development in the development environment system 303 has been completed, the application after the completion of the construction or the revision is ported to (installed on) the data use system 304 as an application 344.

Note that, in addition to the function to search for a device 172 for which a device-group relation 164 with a designated group 175 exists performed by the device search section 331, the development environment system 303 may perform a function to search for another device 172 associated by a correlation 162 from which a derivation has appeared between the device 172 and a designated device 172, a function to search for a group 175 for which a device-group relation 164 with a designated device 172 exists, and a function to search for a group 175 for which an inter-group relation 165 with a designated group 175 exists.

### 4-4. Functional Configuration, Processes, and Information Involved in Execution of Application (FIG. 7)

FIG. 7 depicts functional configuration 700 (and information to be handled) to be used when an application that uses device data 182 output from each of devices 172 at the site is executed in the data use system 304.

An application executing section 342, which is a functional section of the data use system 304, executes an object code or the like of the application 344 according to input information representing an execution instruction from the data user 394, for example. Then, the application executing section 342 performs control such that information to be provided for use by the data user 394 is displayed or output while the application 344 is being executed.

The application executing section 342 requests a data requesting section 343 to acquire desired information if a functional block or the like included in the application 344 has a code or the like for acquiring the desired information.

The data requesting section 343, which is a functional section of the data use system 304, extracts, from the functional block or the like including the code or the like for acquiring the desired information, access settings information for acquiring the desired information. For example, the access settings information here may be a device data acquisition source URL 804 managed for each device ID 801 (device name 802) in the device management information table 800 in FIG. 8. Alternatively, the access settings information may be in any mode as long as the access information is settings information for acquiring the desired information.

The data requesting section 343 acquires the desired information (device data 182) with use of the access settings information (e.g., a device data acquisition source URL 804) for acquiring device data 182 output from a device 172 which is an information source to be used when the desired information is acquired. The desired information (device data 182) is acquired directly from the information-source device 172 in some cases. In addition, the desired information (device data 182) is indirectly acquired in some cases by the transfer of the desired information (device data 182) that has been accumulated in the collected information database 355 (collected information DB) in the data collection system 305 from the information-source device 172.

The data requesting section 343 may store the acquired desired information (device data 182) in a device data buffer 345 in the data use system 304. Then, the application executing section 342 may continue the execution of the application by use of the desired information (device data 182) stored in the device data buffer 345.

Since functions and processes like the ones explained above are realized, it is possible to appropriately acquire desired information from an information-source device 172 in the execution of an application using device data 182 acquired from the site.

### 5. Others (Modification Examples)

The present disclosure is not limited to the embodiment described above, but includes various modification examples. Some of constituent elements or processes according to the embodiment may be replaced with constituent elements or processes according to another conceivable embodiment. Constituent elements or processes according to another conceivable embodiment may be added to constituent elements or processes according to the embodiment.

For example, in the present disclosure, there can be modification examples of the embodiment like the ones below.

### (Modification Example A) Simplification of Relation Information

In the embodiment depicted in the description above, derivation-source record number groups 1403 that device-group relation information records which are records in the device-group relation information table 1400 in FIG. 14, and inter-group relation information records which are records in the inter-group relation information table 1500 in FIG. 15 have are relatively detailed information. Specifically, as completely as possible, each derivation-source record number group 1403 retains information (the record numbers 1201 of correlation information records) identifying a correlation 162 from which the derivation has appeared, and is a basis on the appearance of a device-group relation 164 or an inter-group relation 165 represented by a record to which the derivation-source record number group 1403 belongs, and information (the record number 1401 of another device-group relation record) identifying another device-group relation 164.

For example, in a case where the situation depicted in the upper section in FIG. 2 changes to the situation depicted in the lower section in FIG. 2, after the situation depicted in the lower section in FIG. 2 emerges, a derivation appears from the correlation 162 between the camera 2 (cam2) and the wearable terminal (wear1), and the device-group relation 164 between the camera 2 (cam2) and the worker 1 (worker1) appears accompanying the appearance of the derivation. In this case, in the embodiment described above, as represented by the record (device-group relation record) whose record number 1401 is “r13” in the device-group relation information table 1400 in FIG. 14, “c4-r5” may be included in the derivation-source record number group 1403. Here, “c4” represents the record number 1201 of the correlation information record representing the correlation 162 between the camera 2 (cam2) and the wearable terminal (wear1) from which a derivation has appeared after the situation depicted in the lower section in FIG. 2 has emerged. In contrast, “r5” represents the record number 1401 of the device-group relation record representing the fixed-type device-group relation 164 between the wearable terminal 1 (wear1) and the worker 1 (worker1).

In the embodiment depicted in the description above, a derivation-source record number group 1403 is used to relatively accurately represent bases of the appearance of device-group relations 164 or inter-group relations 165, and accordingly, changes in the existence or inexistence of device-group relations 164 and inter-group relations 165 according to situational changes at the site can be tracked relatively accurately. On the contrary, there are aspects that the content of the process depicted in each of FIG. 21, FIG. 22, FIG. 23, FIG. 25, FIG. 26, and FIG. 27 becomes relatively complicated.

In view of this, in the modification example A, the inaccuracy increases slightly in terms of the accuracy of tracking of changes in the existence or inexistence of device-group relations 164 and inter-group relations 165 according to situational changes at the site in some cases, but instead, information stored in derivation-source record number groups 1403 in records (device-group relation information records) in the device-group relation information table 1400 and records (inter-group relation information records) in the inter-group relation information table 1500 is simplified. Specifically, in the modification example A, only information (the record number 1201 of a correlation information record) identifying a correlation 162 from which a derivation has appeared, and which has directly triggered the appearance of a device-group relation 164 or an inter-group relation 165 represented by a record to which the derivation-source record number group 1403 belongs can be retained in the derivation-source record number group 1403. (In the modification example A, derivation-source record number groups 1403 may be called “derivation-source record numbers” since merely only one record number can be retained in the derivation-source record number group 1403 of each of device-group relation information records or inter-group relation information records.)

For example, in a case where the situation depicted in the upper section in FIG. 2 changes to the situation depicted in the lower section in FIG. 2, after the situation depicted in the lower section in FIG. 2 emerges, a derivation appears from the correlation 162 between the camera 2 (cam2) and the wearable terminal (wear1), and the device-group relation 164 between the camera 2 (cam2) and the worker 1 (worker1) appears accompanying the appearance of the derivation. In this case, in the modification example A, in the record (device-group relation record) whose record number 1401 is “r13” in the device-group relation information table 1400 in FIG. 14, only “c4” may be included in the derivation-source record number group 1403 (which may be called a “derivation-source record number” in the modification example A). Here, “c4” represents the record number 1201 of the correlation information record representing the correlation 162 between the camera 2 (cam2) and the wearable terminal (wear1) from which a derivation has appeared after the situation depicted in the lower section in FIG. 2 has emerged. In contrast, “r5” is not included in the derivation-source record number group 1403 in the modification example A.

If the simplification of derivation-source record number groups 1403 (which may be called “derivation-source record numbers” in the modification example A) depicted above is performed, it becomes possible to simplify also the content of the process depicted in each of FIG. 21, FIG. 22, FIG. 23, FIG. 25, FIG. 26, and FIG. 27 in the embodiment depicted in the description above.

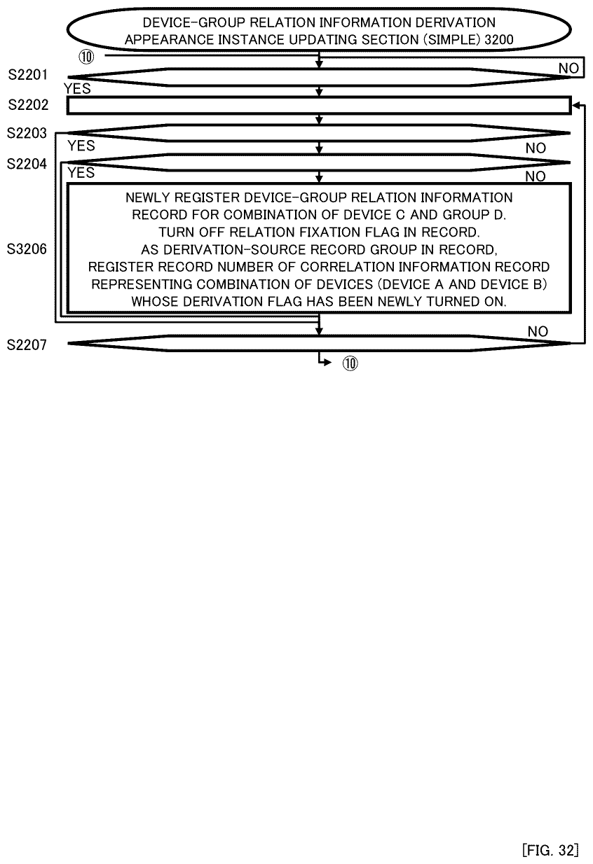

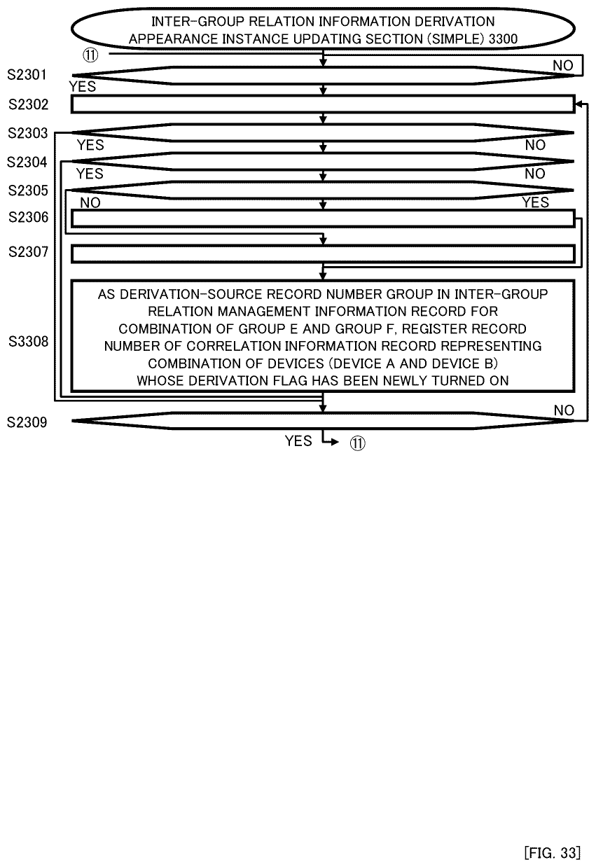

The process depicted in FIG. 21 in the processes depicted in FIG. 21, FIG. 22, and FIG. 23, which are processes to be performed when a derivation has appeared from any of correlations 162 in the embodiment depicted in the description above may remain the same in the modification example A also. Meanwhile, in the modification example A, a process depicted in FIG. 32 mentioned later may be performed instead of the process depicted in FIG. 22. In addition, in the modification example A, a process depicted in FIG. 33 mentioned later may be performed instead of the process depicted in FIG. 23.

FIG. 32 depicts a process performed by a device-group relation information derivation appearance instance updating section (also referred to as a simple device-group relation information derivation appearance instance updating section 3200) in the modification example A. The process depicted in a flowchart in FIG. 32 replaces the process depicted in the flowchart in FIG. 22.

Respective processing steps, Step 2201, Step 2202, Step 2203, Step 2204, and Step 2207, in the processing steps depicted in FIG. 32 are similar to respective processing steps, Step 2201, Step 2202, Step 2203, Step 2204, and Step 2207, in the processing steps depicted in FIG. 22. It should be noted that the transition destination of the control in a case where the determination result at Step 2204 in FIG. 32 is YES is Step 2207.

Step 3206 is executed in a case where the determination result of Step 2204 depicted in FIG. 32 is NO (in a case where a device-group relation record for the combination of the device C and the group D does not exist, and the existence of the device-group relation record is not prohibited).

At Step 3206 in FIG. 32, the simple device-group relation information derivation appearance instance updating section 3200 newly registers, in the device-group relation information table 1400, a device-group relation information record for the combination of the device C and the group D. At the time of registration, the simple device-group relation information derivation appearance instance updating section 3200 registers a device ID identifying the device C in the field of a device ID 801, registers a group ID identifying the group D in the field of a group ID 901, and turns off (OFF) the relation fixation flag 1402, in the newly-registered device-group relation information record.

The simple device-group relation information derivation appearance instance updating section 3200 registers the record number 1201 of a correlation information record representing a correlation 162 that has triggered the appearance of a device-group relation 164, that is, a correlation 162 from which a derivation has newly appeared, in the field of a derivation-source record number group 1403 (which may be called a “derivation-source record number” in the modification example A) in the newly-registered device-group relation information record. Here, the simple device-group relation information derivation appearance instance updating section 3200 registers the record number 1201 of the correlation information record for the combination of the device A and the device B in FIG. 21.

After Step 3206, the control proceeds to Step 2207 in FIG. 32.

FIG. 33 depicts a process performed by an inter-group relation information derivation appearance instance updating section (also referred to as a simple inter-group relation information derivation appearance instance updating section 3300) in the modification example A. The process depicted in a flowchart in FIG. 33 replaces the process depicted in the flowchart in FIG. 23.

Respective processing steps, Step 2301, Step 2302, Step 2303, Step 2304, Step 2305, Step 2306, Step 2307, and Step 2309, in the processing steps depicted in FIG. 33 are similar to respective processing steps, Step 2301, Step 2302, Step 2303, Step 2304, Step 2305, Step 2306, Step 2307, and Step 2309, in the processing steps depicted in FIG. 23. It should be noted that the transition destination of the control in a case where the determination result at Step 2304 in FIG. 33 is YES is Step 2309.

In a case where the determination result of Step 2304 depicted in FIG. 33 is NO (in a case where an inter-group relation record for the combination of the group E and the group F does not exist, and the existence of the inter-group relation record is not prohibited), Step 2305 is executed, thereafter either Step 2306 or Step 2307 is executed, and thereafter, Step 3206 is executed.

At Step 3308 in FIG. 33, the simple inter-group relation information derivation appearance instance updating section 3300 registers the record number 1201 of a correlation information record representing a correlation 162 that has triggered the appearance of an inter-group relation 165, that is, a correlation 162 from which a derivation has newly appeared, in the field of a derivation-source record number group 1403 (which may be called a “derivation-source record number” in the modification example A) in the inter-group relation information record newly registered at Step 2306 or Step 2307. Here, the simple inter-group relation information derivation appearance instance updating section 3300 registers the record number 1201 of the correlation information record for the combination of the device A and the device B in FIG. 21.

After Step 3308, the control proceeds to Step 2309 in FIG. 33.

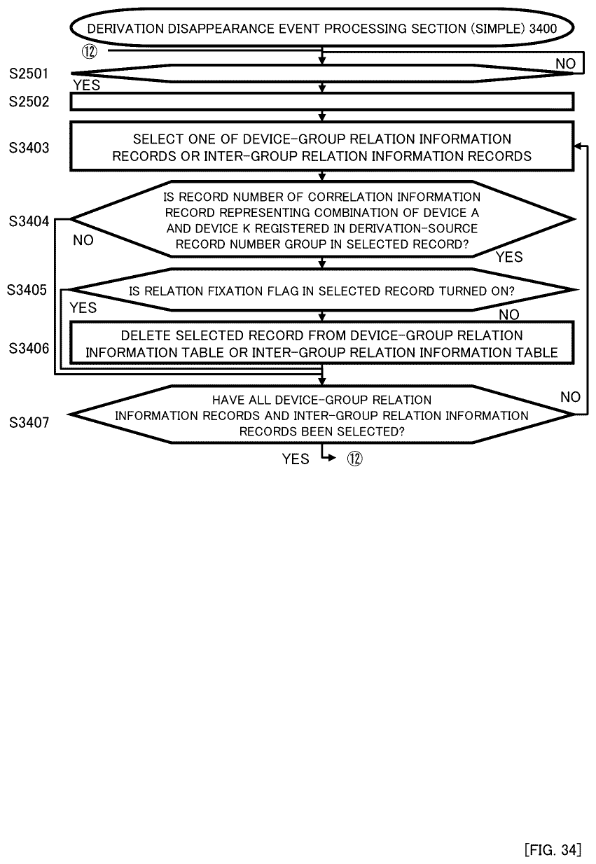

Instead of the processes depicted in FIG. 25, FIG. 26, and FIG. 27, which are processes to be performed when a derivation has disappeared from any of correlations 162 in the embodiment depicted in the description above, a process depicted in FIG. 34 may be performed in the modification example A.

FIG. 34 depicts a process performed by a derivation disappearance event processing section (called a simple derivation disappearance event processing section 3400) in the modification example A. The process depicted in FIG. 34 replaces the processes depicted in the flowcharts in FIG. 25, FIG. 26, and FIG. 27. Instead of the derivation disappearance event processing section 2500, the device-group relation information derivation disappearance instance updating section 2600, and the inter-group relation information derivation disappearance instance updating section 2700 in the embodiment depicted in the description above, the simple derivation disappearance event processing section 3400 is used as a functional section in the modification example A.

Respective processing steps, Step 2501 and Step 2502, in the processing steps depicted in FIG. 34 are similar to respective processing steps, Step 2501 and Step 2502, in the processing steps depicted in FIG. 25. After Step 2502 in FIG. 34, the control proceeds to Step 3403.

At Step 3403 in FIG. 34, the simple derivation disappearance event processing section 3400 selects one of device-group relation information records or inter-group relation information records existing at that time point in the device-group relation information table 1400 or the inter-group relation information table 1500.

At Step 3404 in FIG. 34, the simple derivation disappearance event processing section 3400 checks information registered in the field of the derivation-source record number group 1403 (which may be called a “derivation-source record number” in the modification example A) in the record (device-group relation information record or inter-group relation information record) selected at the latest Step 3403. The simple derivation disappearance event processing section 3400 determines whether the record number 1201 in the correlation information record representing the correlation 162 whose derivation has been determined as having disappeared at Step 2407 in FIG. 24 is registered in the checked field of the derivation-source record number group 1403. Here, the simple derivation disappearance event processing section 3400 determines whether the record number 1201 in the correlation information record for the combination of the device A and the device K in FIG. 24 is registered in the checked field of the derivation-source record number group 1403. If the determination result of Step 3404 is YES, the control proceeds to Step 3405. If the determination result of Step 3404 is NO, Step 3405 and Step 3406 are skipped, and the control proceeds to Step 3407.

At Step 3405 in FIG. 34, the simple derivation disappearance event processing section 3400 determines whether the relation fixation flag 1402 in the record (device-group relation information record or inter-group relation information record) selected at the latest Step 3403 is turned on (ON). If the determination result of Step 3405 is YES, deletion of the record selected at the latest Step 3403 is not permitted (the device-group relation 164 or the inter-group relation 165 represented by the record is not permitted to disappear), accordingly, Step 3406 is skipped, and the control proceeds to Step 3407. If the determination result of Step 3405 is NO, the control proceeds to Step 3406.

At Step 3406 in FIG. 34, the simple derivation disappearance event processing section 3400 deletes, from the table (device-group relation information table 1400 or inter-group relation information table 1500), the record (device-group relation information record or inter-group relation information record) selected at the latest Step 3403. After Step 3406, the control proceeds to Step 3407.

At Step 3407 in FIG. 34, the simple derivation disappearance event processing section 3400 determines whether all of records (device-group relation information records or inter-group relation information records) have been selected at Step 3403. If the determination result of Step 3407 is YES, the control returns to Step 2501 in FIG. 34, and the simple derivation disappearance event processing section 3400 waits until the next opportunity of the disappearance of a derivation. If the determination result of Step 3407 is NO, the control returns to Step 3403, and any of records (device-group relation information records or inter-group relation information records) that have not been selected yet is newly selected.

### (Modification Example B) Remote-Enabled Device Search in Construction or Revision of Application

In the embodiment depicted in the description above, as depicted in FIG. 6 and the upper section in FIG. 31, the meta information management system 302 informs the development environment system 303 of correlation/relation information representing each of the appearance of derivations from correlations 162, the existence of device-group relations 164, and the existence of inter-group relations 165, and then, a search for an information-source device 172 using the correlation/relation information is performed locally in the development environment system 303.

The technique according to the embodiment depicted in the description above makes it possible to present the overall situation of the appearance of derivations from correlations 162, the existence of device-group relations 164, and the existence of inter-group relations 165 to a user or the like (e.g., the developer 393) of the development environment system 303, as depicted in the upper section in FIG. 31. In addition, it becomes possible to locally execute the process of a search for an information-source device 172 at the development environment system 303, and it can be expected that processing speed increases.

In the modification example B, the meta information management system 302 does not inform the development environment system 303 of correlation/relation information itself representing each of the appearance of derivations from correlations 162, the existence of device-group relations 164, and the existence of inter-group relations 165, but instead, informs the development environment system 303 of information representing changed portions in the correlation/relation information, and related information as change information.

FIG. 35 depicts functional configuration and information involved in construction and revision of an application in the modification example B. The functional configuration depicted in FIG. 35 replaces the functional configuration and information depicted in FIG. 6. Specifically, in the modification example B, as functional sections of the development environment system 303, there is a change information acquiring section 3533 in FIG. 35 instead of the correlation/relation information acquiring section 333 in FIG. 6, and there is a device search section 3531 in FIG. 35 instead of the device search section 331 in FIG. 6, and, as a functional section of the meta information management system 302, there is a change information providing section 3523 in FIG. 35 instead of the correlation/relation information providing section 323 in FIG. 6. In addition, in the modification example B, there is a device search result providing section 3521 in FIG. 35 as a functional section of the meta information management system 302. Moreover, in the modification example B, as information to be handled by the development environment system 303, there may not be the correlation/relation information buffer 338 in FIG. 6. Further, in the modification example B, as information to be handled by the development environment system 303, there may be a device search result buffer 3538 in FIG. 35.

The change information providing section 3523 in the modification example B refers to the correlation information table 1200, the device-group relation information table 1400, and the inter-group relation information table 1500, and identifies changed portions in correlation/relation information represented by the tables. That is, the change information providing section 3523 in the modification example B identifies changed portions accompanying the new appearance of a derivation or the disappearance of a derivation (having existed until then), regarding each of the appearance of derivations from correlations 162, the existence of device-group relations 164, and the existence of inter-group relations 165. The change information providing section 3523 puts together information representing the changed portions and related information (e.g., information regarding devices 172 and groups 175 related to the changed portions, and retained in the device management information table 800 or the group management information table 900), and forms change information. The change information providing section 3523 informs the development environment system 303 of the change information.

The change information acquiring section 3533 in the modification example B may acquire the change information transmitted from the change information providing section 3523, and provide the acquired change information to the development environment section 330.

Using the provided change information, the development environment section 330 in the modification example B checks whether it is necessary to change an information-source device 172 of information that is acquired at the time of execution of a revision-target application. Results of display control performed by the development environment section 330 in the modification example B in a case where it is necessary to change an information-source device 172 may be similar to the display of the upper left section in FIG. 30 in the embodiment depicted in the description above.

In addition, the development environment section 330 in the modification example B may perform control such that a display similar to the display in the upper right section in FIG. 30 in the embodiment depicted in the description above is shown.

When an icon “Display Device Search” is clicked by a mouse or the like in the display similar to the display in the upper right section in FIG. 30, the development environment section 330 in the modification example B calls the device search section 3531.

The device search section 3531 in the modification example B may perform control such that only a search window for device searches (the text input field and the icon “Search”) in the display in the upper section in FIG. 31 in the embodiment depicted in the description above is displayed. Alternatively, the device search section 3531 in the modification example B may perform control such that a search window for device searches (the text input field and the icon “Search”), and a graph display or the like corresponding only to changed portions in each of the appearance of derivations from correlations 162, the existence of device-group relations 164, and the existence of inter-group relations 165 represented by the change information in the display in the upper section in FIG. 31 in the embodiment depicted in the description above are displayed.

When the icon “Search” is clicked by a mouse or the like in a state where a group ID 901 or the like is input in the text input field in the search window for device searches or when an icon representing a group 175 in the graph display or the like is clicked by a mouse or the like, this means that the device search section 3531 in the modification example B has accepted a request for a search for a device 172 which is an information source to be used when information regarding groups 175 is acquired.

The device search section 3531 in the modification example B outputs a device search request to the meta information management system 302. The device search request may include information (e.g., a group ID 901) identifying a group 175 input in the search window mentioned before or information identifying a group 175 identified by a click of an icon representing the group 175.

The device search result providing section 3521 in the modification example B refers to the device-group relation information table 1400, and identifies a device 172 for which a device-group relation 164 with the group 175 represented by the group ID 901 included in the device search request received from the device search section 3531 exists. The device search result providing section 3521 in the modification example B informs the development environment system 303 of identification information (e.g., a device ID 801) of the identified device 172 as a device search result.

The device search section 3531 in the modification example B may acquire the device search result (e.g., including the device ID 801) transmitted from the device search result providing section 3521, and store the acquired device search result in the device search result buffer 3538. In addition, the device search section 3531 in the modification example B may perform control such that a display similar to the display in the lower left section in FIG. 31 in the embodiment depicted in the description above is shown on the basis of the acquired device search result (e.g., including the device ID 801).

Functions of the functional block generating section 332 in the modification example B may be similar to the functions of the functional block generating section 332 in the embodiment depicted in the description above. In addition, functions of the development environment section 330 in the modification example B at the time of construction or revision of an application using a functional block code generated by the functional block generating section 332 may be similar to the functions of the development environment section 330 in the embodiment depicted in the description above.

Note that, in the modification example B, in addition to the device ID 801, the device search result transmitted from the meta information management system 302 to the development environment system 303 may also include access settings information (e.g., a device data acquisition source URL 804) for acquiring device data 182 output by the device 172 represented by the device ID 801. In this case, the transmission of access settings information (e.g., the device data acquisition source URL 804) from the access settings information providing section 322 to the functional block generating section 332 becomes unnecessary.

Note that, in the modification example B, in addition to the function to search for a device 172 for which a device-group relation 164 with a designated group 175 exists performed by the device search section 3531 and the device search result providing section 3521, there may be a function to search for another device 172 associated by a correlation 162 from which a derivation has appeared between the device 172 and a designated device 172, a function to search for a group 175 for which a device-group relation 164 with a designated device 172 exists, and a function to search for a group 175 for which an inter-group relation 165 with a designated group 175 exists.

Whereas cases regarding the time of a change in an application in the modification example B have been depicted above, a case regarding the time of construction of an application in the modification example B may generally be the same also. For example, in a case where there is not change information at all, in the modification example B, transmission of change information from the meta information management system 302 to the development environment system 303 is not performed, and the search window for device searches (the text input field and the icon “Search”) may be displayed on a device search screen displayed under the control of the device search section 3531.

According to the modification example B, searches for information-source devices 172 of information to be acquired for execution of an application can be performed on the side of the meta information management system 302. Accordingly, as compared to the embodiment depicted in the description above, the processing load of the development environment system 303 can be lowered, and it can be expected that the amount of information transmitted and received between the meta information management system 302 and the development environment system 303 can also be reduced.

### (Modification Example C) Use of Object Detection in Image Data (Moving Image Data) of Camera

In the embodiment depicted in the description above, the data processing section 316, which is a functional section of the correlation analysis system 101, is configured to determine whether a motion is detected at each time (or in each time period) on the basis of image data (moving image data) which is device data 182 output from cameras (the camera 1 (cam1), the camera 2 (cam2), the camera (cam3)). Then, the data processing section 316 is configured to record a motion/no-motion flag 1003 representing whether or not there is detection of a motion at each time (or in each time period).

In the modification example C, on the basis of image data (moving image data) which is device data 182 output from a camera, the data processing section 316 does not simply determine whether or not there is a motion on a screen, but may detect individual objects displayed on the screen. For example, the data processing section 316 may determine the existence/inexistence of each of the worker 1 (worker1) and the worker 2 (worker2) depicted in FIG. 2 and FIG. 3, and whether or not there is a motion of each of the worker 1 (worker1) and the worker 2 (worker2). For example, in addition to workers, the data processing section 316 may determine the existence/inexistence of each of robots/pieces of equipment/devices, and whether or not there is a motion of each of the robots/pieces of equipment/devices. The data processing section 316 may realize the determination described above by inputting image data (moving image data) to a trained object detection model.

According to the modification example C, it is expected that the correlation analysis system 101 can more appropriately determine whether correlation strength values 1202 are high or low, whether or not there is the appearance of a derivation from each of correlations 162, whether or not there is the existence of each of device-group relations 164, and whether or not there is the existence of an inter-group relation 165.

### (Modification Example D) Interpretation of Motion/No-Motion Flags in Correlation Event Sensing

In the embodiment depicted in the description above, as depicted in Step 1903 and Step 1904 in FIG. 19, when there are “similar changes” within k seconds of the value of a motion/no-motion flag 1003 based on device data 182 output from a certain device 172 and the value of a motion/no-motion flag 1003 based on device data 182 output from a second certain device 172, it is considered that a “high correlation event” is sensed between the certain device 172 and the second certain device 172.

However, for example, there can be a case where, regarding a motion of a conveyor belt for a certain process and a motion of a worker engaged in the certain process, the worker becomes stationary, and waits when the conveyor belt is moving, while the worker moves to perform work for the process when the conveyor belt is stationary.

Accordingly, in the modification example D, a condition for considering that a “high correlation event” is sensed at Step 1903 in FIG. 19 may be “changes in opposite direction” instead of “similar changes” described above, depending on the types of devices 172 included in a combination of devices 172.

For example, when there are a change “from the inexistence of a motion to the existence of a motion” in a motion/no-motion flag 1003 related to a conveyor belt and a change “from the existence of a motion to the inexistence of a motion” in a motion/no-motion flag 1003 related to a wearable terminal that a worker has within k seconds, it may be considered that a “high correlation event” is sensed between the conveyor belt and the wearable terminal. Similarly, when there are a change “from the existence of a motion to the inexistence of a motion” in the motion/no-motion flag 1003 related to the conveyor belt and a change “from the inexistence of a motion to the existence of a motion” in the motion/no-motion flag 1003 related to the wearable terminal that the worker has within k seconds, it may be considered that a “high correlation event” is sensed between the conveyor belt and the wearable terminal.

Alternatively, in the modification example D, a condition for considering that a “high correlation event” is sensed at Step 1903 in FIG. 19 may be “changes in either direction” instead of “similar changes” described above, depending on the types of devices 172 included in a combination of devices 172.

According to the modification example D, conditions for the sensing of a “high correlation event” or a “low correlation event” between devices 172 can be determined according to the type and actual usage of each of the devices 172.

### (Modification Example E) Division of Correlation Analysis System and Meta Information Management System

In the embodiment depicted in the description above, each of the correlation analysis system 101, the meta information management system 302, and the data collection system 305 is depicted as one system.

In the modification example E, one or more of the correlation analysis system 101, the meta information management system 302, and the data collection system 305 may be one including a plurality of divided systems. For example, in a case where the number of devices 172 installed at the site is large, the devices 172 may be grouped into several sets, and a divided system may be allocated to each set of devices.

According to the modification example E, it is possible to allocate processes to respective divided systems even if the number of devices 172 installed at the site is large. Accordingly, it is possible to obtain information for grasping the situation of the site, independently of the number of devices 172 installed at the site.

The technical matters depicted for the embodiment of the present disclosure, and each of the modification examples of the embodiment depicted in the description above can be combined as appropriate unless such combinations do not cause technical contradictions.

What is claimed is:

1. A correlation analysis system comprising:
a correlation event sensing section;
a correlation event processing section; and
a derivation appearance/disappearance event processing section, wherein
the correlation event sensing section is configured to sense a high correlation event which is an event that leads to a presumption that a correlation between devices exists or a low correlation event which is an event that leads to a presumption that the correlation between the devices does not exist, on a basis of each piece of device data obtained from each of the devices,
the correlation event processing section is configured to update correlation information for managing a correlation strength which is a strength of the correlation between the devices on a basis of the sensed high correlation event or low correlation event,
the correlation event processing section is configured to determine appearance or disappearance of a derivation from the correlation between the devices to a relation on a basis of the correlation strength between the devices,
the relation is a device-group relation between each of groups and each of the devices or an inter-group relation between the groups,
the derivation appearance/disappearance event processing section is configured to update device-group relation information for managing whether or not there is the device-group relation, on a basis of the determined appearance or disappearance of a derivation, and
the derivation appearance/disappearance event processing section is configured to update inter-group relation information for managing whether or not there is the inter-group relation, on a basis of the determined appearance or disappearance of a derivation.

2. The correlation analysis system according to claim 1, wherein
the correlation event sensing section is configured to sense the high correlation event or the low correlation event with use of information regarding a period or a time when there is a motion of a target object sensed by each of the devices or information regarding a period or a time when there is not a motion of the target object, each piece of the information being based on each piece of the device data.

3. The correlation analysis system according to claim 1, wherein
the correlation event processing section has a high correlation event processing section and a low correlation event processing section,
the high correlation event processing section is configured to increase the correlation strength between the devices corresponding to the high correlation event, and determine that a derivation from the correlation between the devices corresponding to the correlation strength to the relation has appeared when the correlation strength has become equal to or greater than a derivation appearance threshold or the correlation strength has become greater than the derivation appearance threshold, and
the low correlation event processing section is configured to reduce the correlation strength between the devices corresponding to the low correlation event, and determine that a derivation from the correlation between the devices corresponding to the correlation strength to the relation has disappeared when the correlation strength has become equal to or lower than a derivation disappearance threshold or the correlation strength has become lower than the derivation disappearance threshold.

4. The correlation analysis system according to claim 3, wherein
the correlation analysis system has a parameter setting section, and
the parameter setting section is configured to set at least one of the derivation appearance threshold, the derivation disappearance threshold, an increase amount of the correlation strength to be used when the high correlation event is sensed, and a reduction amount of the correlation strength to be used when the low correlation event is sensed, on a basis of input information input to the correlation analysis system.

5. The correlation analysis system according to claim 1, wherein
the derivation appearance/disappearance event processing section has a derivation appearance event processing section, a device-group relation information derivation appearance instance updating section, an inter-group relation information derivation appearance instance updating section, a derivation disappearance event processing section, a device-group relation information derivation disappearance instance updating section, and an inter-group relation information derivation disappearance instance updating section,
the derivation appearance event processing section is configured to identify relation settings candidates which are candidates of the device-group relation or the inter-group relation that appear accompanying the appearance of a derivation,
the device-group relation information derivation appearance instance updating section is configured to determine whether existence of the device-group relation of each of the relation settings candidates of the device-group relation is permitted or not, and then update the device-group relation information such that the device-group relation exists in a case where the device-group relation information derivation appearance instance updating section determines that the existence of the device-group relation is permitted,
the inter-group relation information derivation appearance instance updating section is configured to determine whether existence of the inter-group relation of each of the relation settings candidates of the inter-group relation is permitted or not, and then update the inter-group relation information such that the inter-group relation exists in a case where the inter-group relation information derivation appearance instance updating section determines that the existence of the inter-group relation is permitted,
the derivation disappearance event processing section is configured to identify relation settings cancellation candidates which are candidates of the device-group relation or the inter-group relation that disappears accompanying the disappearance of a derivation,
the device-group relation information derivation disappearance instance updating section is configured to determine whether inexistence of the device-group relation of each of the relation settings cancellation candidates of the device-group relation is permitted or not, and then update the device-group relation information such that the device-group relation disappears in a case where the device-group relation information derivation disappearance instance updating section determines that the inexistence of the device-group relation is permitted, and
the inter-group relation information derivation disappearance instance updating section is configured to determine whether inexistence of the inter-group relation of each of the relation settings cancellation candidates of the inter-group relation is permitted or not, and then update the inter-group relation information such that the inter-group relation disappears in a case where the inter-group relation information derivation disappearance instance updating section determines that the inexistence of the inter-group relation is permitted.

6. The correlation analysis system according to claim 1, wherein
the derivation appearance/disappearance event processing section has a derivation appearance event processing section, a device-group relation information derivation appearance instance updating section, an inter-group relation information derivation appearance instance updating section, and a derivation disappearance event processing section,
the derivation appearance event processing section is configured to identify relation settings candidates which are candidates of the device-group relation or the inter-group relation that appear accompanying the appearance of a derivation,
the device-group relation information derivation appearance instance updating section is configured to include, in the device-group relation information, information identifying a combination of the devices corresponding to the correlation which is a derivation source of the device-group relation in association with a combination of each of the devices and each of the groups between which existence of the device-group relation is to be set, in the relation settings candidates of the device-group relation,
the inter-group relation information derivation appearance instance updating section is configured to include, in the inter-group relation information, information identifying a combination of the devices corresponding to the correlation which is a derivation source of the inter-group relation in association with a combination of the groups between which existence of the inter-group relation is to be set, in the relation settings candidates of the inter-group relation,
the derivation disappearance event processing section is configured to update the device-group relation information such that, in a case where a device-group relation is associated with information identifying a combination of the devices corresponding to the correlation for which the disappearance of a derivation has been determined in the device-group relations whose existence is represented by the device-group relation information, and the device-group relation is permitted to be inexistent, the device-group relation disappears, and
the derivation disappearance event processing section is configured to update the inter-group relation information such that, in a case where an inter-group relation is associated with information identifying a combination of the devices corresponding to the correlation for which the disappearance of a derivation has been determined in the inter-group relations whose existence is represented by the inter-group relation information, and the inter-group relation is permitted to be inexistent, the inter-group relation disappears.

7. The correlation analysis system according to claim 1, wherein
the correlation event processing section is configured to hinder appearance of a derivation from the correlation of a particular combination of the devices to the relation in a case where derivation prohibition information includes information representing that a derivation from the correlation of the combination to the relation is prohibited,
the derivation appearance/disappearance event processing section is configured to hinder setting of existence of the device-group relation of a particular combination of each of the devices and each of the groups in a case where device-group relation prohibition information includes information representing that the existence of the device-group relation of the combination is prohibited, and
the derivation appearance/disappearance event processing section is configured to hinder setting of existence of the inter-group relation of a particular combination of the groups in a case where inter-group relation prohibition information includes information representing that the existence of the inter-group relation of the combination is prohibited.

8. The correlation analysis system according to claim 1, wherein
the correlation analysis system has a fixation setting section, and
the fixation setting section is configured to, on a basis of input information input to the correlation analysis system,
perform setting, in the correlation information, to fix a derivation from a correlation of a particular combination of the devices to the relation such that appearance of the derivation is forced,
perform setting, in the device-group relation information, to fix the device-group relation such that existence of the device-group relation of a particular combination of each of the devices and each of the groups is forced, or
perform setting, in the inter-group relation information, to fix the inter-group relation such that existence of the inter-group relation of a particular combination of the groups is forced.

9. The correlation analysis system according to claim 1, wherein
the inter-group relation information includes information representing a hierarchical relation between the target groups of the inter-group relation,
a relation change degree is set for each of the groups, and
the derivation appearance/disappearance event processing section is configured to set the hierarchical relation between the groups on a basis of the relation change degree set for each of the target groups of the inter-group relation when existence of the inter-group relation is newly set.

10. An integrated system comprising:
the correlation analysis system according to claim 1; and
a meta information management system, wherein
the meta information management system has a device registration accepting section, a device management information table, a correlation information table for retaining the correlation information, a device-group relation information table for retaining the device-group relation information, and a group relation information table for retaining the inter-group relation information,
the correlation analysis system has a registration notification accepting section and a data requesting section,
the device registration accepting section is configured to accept a device registration request for requesting registration of the device in the device management information table,
the device registration request includes access settings information for acquiring the device data output by the target device of the device registration request,
the device management information table retains the access settings information for each of the devices,
the device registration accepting section is configured to inform the correlation analysis system of a device registration notification,
the device registration notification includes the access settings information for the target device of the device registration notification,
the registration notification accepting section is configured to accept the device registration notification, and
the data requesting section is configured to acquire the device data for the target device of the access settings information with use of the access settings information included in the device registration notification accepted by the device registration accepting section.

11. An integrated system comprising:
the correlation analysis system according to claim 1;
a meta information management system; and
a development environment system, wherein
the meta information management system has a device management information table, a correlation/relation information providing section, an access settings information providing section, a correlation information table for retaining the correlation information, a device-group relation information table for retaining the device-group relation information, and an inter-group relation information table for retaining the inter-group relation information,
the development environment system has a development environment section, a correlation/relation information acquiring section, a device search section, and a functional block generating section,
the device management information table retains access settings information for acquiring the device data output by each of the devices,
the correlation/relation information providing section is configured to provide, to the development environment system and as correlation/relation information, information that one or more of the correlation information table, the device-group relation information table, or the inter-group relation information table have,
the correlation/relation information acquiring section is configured to acquire the correlation/relation information,
the development environment section is configured to identify change information which is information regarding a change in the correlation/relation information on a basis of the correlation/relation information acquired by the correlation/relation information acquiring section, and perform control such that a display representing the change information is shown,
the device search section is configured to perform control such that a display which is for searching for an information-source device of the device data to be used when an application which is a development or revision target of the development environment system is executed, and is for accepting input information regarding the search is shown,
the device search section is configured to identify an information-source device of the device data to be used when an application is executed on a basis of the correlation/relation information acquired by the correlation/relation information acquiring section and the input information,
the functional block generating section is configured to request the access settings information for the device identified by the device search section from the meta information management system,
the access settings information providing section is configured to acquire the access settings information from the device management information table, and provide the access settings information to the development environment system, and
the functional block generating section is configured to include the provided access settings information in the application which is the development or revision target of the development environment system.

12. An integrated system comprising:
the correlation analysis system according to claim 1;
a meta information management system; and
a development environment system, wherein
the meta information management system has a device management information table, a change information providing section, a device search result providing section, an access settings information providing section, a correlation information table for retaining the correlation information, a device-group relation information table for retaining the device-group relation information, and an inter-group relation information table for retaining the inter-group relation information,
the development environment system has a development environment section, a change information acquiring section, a device search section, and a functional block generating section,
the device management information table retains access settings information for acquiring the device data output by each of the devices,
the change information providing section is configured to provide, to the development environment system and as change information, information regarding a change in information that one or more of the correlation information table, the device-group relation information table, or the inter-group relation information table have,
the change information acquiring section is configured to acquire the provided change information,
the development environment section is configured to perform control such that a display representing the change information acquired by the change information acquiring section is shown,
the device search section is configured to perform control such that a display which is for searching for an information-source device of the device data to be used when an application which is a development or revision target of the development environment system is executed, and is for accepting input information regarding the search is shown,
the device search section is configured to issue, to the meta information management system, a device search request which is a request identifying an information-source device of the device data to be used when an application is executed on a basis of the input information input to the development environment system,
the device search result providing section is configured to identify the identification-target device of the device search request with use of information that one or more of the correlation information table, the device-group relation information table, or the inter-group relation information table have, and provide information regarding the identified device as a device search result to the development environment system,
the device search section is configured to acquire the provided device search result,
the functional block generating section is configured to request, from the meta information management system, the access settings information of the device corresponding to information regarding the device included in the device search result acquired by the device search section,
the access settings information providing section is configured to acquire the access settings information from the device management information table, and provide the access settings information to the development environment system, and
the functional block generating section is configured to include the provided access settings information in the application which is the development or revision target of the development environment system.

13. The correlation analysis system according to claim 1, wherein
each of the groups may be any one of processes in a production line or an inspection line for a product or any one of workers who is engaged in the production line or the inspection line, and
each of the devices may be any one of sensors for sensing a state of any one of the processes.

14. A correlation analysis method executed by an information processing system, the correlation analysis method comprising:
a correlation event sensing step;
a correlation event processing step; and
a derivation appearance/disappearance event processing step, wherein,
at the correlation event sensing step, a high correlation event which is an event that leads to a presumption that a correlation between devices exists or a low correlation event which is an event that leads to a presumption that the correlation between the devices does not exist is sensed, on a basis of each piece of device data obtained from each of the devices,
the correlation event processing step includes a correlation strength management step and a derivation appearance/disappearance determination step,
at the correlation strength management step, correlation information for managing a correlation strength which is a strength of the correlation between the devices is updated, on a basis of the sensed high correlation event or low correlation event,
at the derivation appearance/disappearance determination step, appearance or disappearance of a derivation from the correlation between the devices to a relation is determined, on a basis of the correlation strength between the devices,
the relation is a device-group relation between each of groups and each of the devices or an inter-group relation between the groups,
the derivation appearance/disappearance event processing step includes a device-group relation updating step and an inter-group relation updating step,
at the device-group relation updating step, device-group relation information for managing whether or not there is the device-group relation is updated on a basis of the determined appearance or disappearance of a derivation, and
at the inter-group relation updating step, inter-group relation information for managing whether or not there is the inter-group relation is updated on a basis of the determined appearance or disappearance of a derivation.

15. A correlation analysis program for causing an information processing system to execute a correlation event sensing step, a correlation event processing step, and a derivation appearance/disappearance event processing step, wherein,
at the correlation event sensing step, a high correlation event which is an event that can lead to a presumption that a correlation between devices exists or a low correlation event which is an event that can lead to a presumption that the correlation between the devices does not exist is sensed, on a basis of each piece of device data obtained from each of the devices,
the correlation event processing step includes a correlation strength management step and a derivation appearance/disappearance determination step,
at the correlation strength management step, correlation information for managing a correlation strength which is a strength of the correlation between the devices is updated on a basis of the sensed high correlation event or low correlation event,
at the derivation appearance/disappearance determination step, appearance or disappearance of a derivation from the correlation between the devices to a relation is determined on a basis of the correlation strength between the devices,
the relation is a device-group relation between each of groups and each of the devices or an inter-group relation between the groups,
the derivation appearance/disappearance event processing step includes a device-group relation updating step and an inter-group relation updating step,
at the device-group relation updating step, device-group relation information for managing whether or not there is the device-group relation is updated on a basis of the determined appearance or disappearance of a derivation, and
at the inter-group relation updating step, inter-group relation information for managing whether or not there is the inter-group relation is updated on a basis of the determined appearance or disappearance of a derivation.
